(19) United States
(12) Patent Application Publication
(10) Pub. No.: US 2026/0268298 A1
(43) Pub. Date: Sep. 10, 2026

(54) Unified Business Operations and Management Suite

(71) Applicant: Wayne R. Leiser, Sarasota, FL (US)

(72) Inventor: Wayne R. Leiser, Sarasota, FL (US)

(21) Appl. No.: 19/075,473

(22) Filed: Mar. 10, 2025

(51) Int. Cl. G06Q 20/10; G06F 16/215; G06F 16/25; G06Q 10/0631; G06Q 30/0201; G06Q 30/0207; G06Q 30/0282

(52) U.S. Cl. CPC G06Q 20/102; G06F 16/215; G06F 16/258; G06Q 10/06316; G06Q 30/0201; G06Q 30/0224; G06Q 30/0282

(57) ABSTRACT

A system and method for managing business operations through a unified software platform. It features a global customer behavior list with multi-factor searches, automated alerts, and decision-making tools. A collaborative marketing success sharing module collects and distributes anonymized performance data for lead generation and marketing campaigns. The multi-payment invoicing system includes a feature called “Autoset”, an automatic payment scheduler that configures payment plans based on predefined parameters after a set amount of time. The video profit-sharing platform enables collaborative content distribution with engagement-based revenue sharing, content filtering, and automatic subtitle generation. A multi-faceted integration framework connects software components, synchronizing data, detecting errors, and processing transactions. Appointment scheduling integrates geolocation and online calendar synchronization. Sales transaction management links accounting tools, tax calculators, and payment processors. By centralizing data, automating tasks, and optimizing resources, the system enhances operational efficiency across industries, reducing redundancy and improving scalability.

This application is related to commonly filed, co-pending applications Ser. Nos. 19/075,473, 19/075,467, 19/075,459, 19/075,455 and 19/075,444, the contents of which are incorporated by reference.

### BACKGROUND OF THE INVENTION

The present one embodiment relates generally to computer systems and software applications, and more particularly to an integrated software system designed to facilitate various functions within an organizational setting.

In modern business environments, the use of comprehensive software solutions is critical for managing and performing a wide array of tasks and operations. Traditional software systems are often compartmentalized, with different software applications handling specific tasks such as project management, task tracking, and document management. This compartmentalization leads to inefficiencies, such as the need for users to operate and switch between multiple software programs, resulting in increased complexity and a higher likelihood of errors.

Furthermore, the interactions between different software systems may be limited if these systems are not designed to communicate effectively with each other. This results in data silos where information is trapped in one part of the software and is not easily accessed or completely inaccessible by other parts, leading to disjointed processes and an incomplete view of operational data.

### SUMMARY OF THE INVENTION

### Backup Billing System

In one aspect, a method for a multi-tenant automatic backup billing software as a service system includes automatic verification of matching data entered into a form against an external database; retrieving a billing exclusion list from an internal database; retrieving encoded daily backup usage from the external backup provider database for a plurality of user accounts kept in an internal database for a multi-tenant software environment; decoding and converting the retrieved backup usage data into a billing-compatible format; and automatically determining usage fees for each user account not in the billing exclusion list.

Implementations of the multi-tenant automatic backup billing includes items such as: automatic verification of matching data entered into a form against an external database can be done by generating a unique name on user account equipment; identifying data not present in an external database; and filtering user accounts to remove existing accounts associated with an active backup billing account. The generating of a unique name on user account equipment can include filtering and excluding equipment from billing based on the name. The method includes functions such as: generating individual charges for multi-tenant user accounts by removing customer accounts associated with an exclusion list of customers. The method includes functions such as: alerting an end-user when an active backup account is not associated with an active billing account or on the exclusion list. The method includes functions such as: generating the usage fees for a predetermined recurring period. The method includes functions such as: automatic data entry into external systems for accounting or creation of digital files for record keeping and payment processing. Automatically determining usage fees for each user account not in the billing exclusion list includes calculating fees based on the quantity, category of equipment, and incremental usage. The method includes functions such as: generating a list of the filtered data; and displaying the list in an interface for end-user review. The method includes functions such as: consistently verifying and updating the connection with the cloud backup data protection service and refreshing a token at predetermined intervals to maintain consistent communication for cloud availability.

The method includes managing, tracking and reporting customer behavior by performing functions such as: receiving data entered into a form for a prospect as part of an order or scheduling an appointment; determining if the data entered exists in a database based on a multi-factor inexact search for the prospect; and if the prospect is in the database, automatically displaying a message to a user entering the data. The determining if the data entered exists in a database based on a multi-factor inexact search for the prospect includes items such as: company name, personal name, address, city, state, zip code, email, and telephone number(s).

The method includes managing sales transactions by performing functions such as: creating line items for services or products; establishing a connection with an online accounting software, a sales tax calculation software, and an online payment processor; extracting one or more keyword phrases in a file and generating a sales receipt by replacing data in lieu of the keyword phrases in a file; enabling and disabling the recording of transactions into an accounting software for individual payment methods; handling failed transactions; synchronizing sales and accounting data to a plurality of online software systems; selecting specific line items for inclusion in a transaction; collecting initial data from a database to pre-fill necessary information for a sales checkout process; and associating a fixed or dynamic fee based on items such as: individual transaction amount, purchases, totality of processed transactions, and predefined parameters. The method includes establishing a connection with an online accounting software, a sales tax calculation software, and an online payment processor to integrate and calculate state and county sales tax rates using data from a sales tax provider; geolocate address location and apply sales tax rates for addresses without an automatically assigned tax rate; provide a list of regional tax rates for manual selection based on provided address information; performing payment processing with the online credit card processor; recording payments into an online accounting software. The handling of failed transactions includes performing functions such as: capturing failed transactions; notifying users of failed transactions through alert banners; and allowing users to reprocess failed transactions.

### Customer Behavior

In another aspect, a method for managing, tracking and reporting customer behavior in a software as a service system includes receiving data entered into the form for a prospect as part of an order or scheduling an appointment; determining if the data entered exists in a database based on a multi-factor inexact search for the prospect; and if the predetermined multi-factors are matched in the database, automatically displaying a message to a user entering the data.

Implementations of the above may include one or more of the following. A message can be sent to the end user that displays when multiple data points entered into a form are matched against the customer behavior list by reporting the aggregated number of businesses that have added the customer information to the customer behavior list; making available the dates and times the customer was added to the customer behavior list; and allowing the end user to approve or decline proceeding with the entry of the customer. The method includes functions such as: determining if the data entered exists in a database based on a multi-factor inexact search for the prospect including items such as: company name, personal name, address, city, state, zip code, email, and telephone number(s). A user interface for adding a customer to the customer behavior list includes items such as text fields for entering the specified customer data; a checkbox during the checkout process to add customer information to the customer behavior list; a button within the alert system allowing the user to add customer information to the customer behavior list; an input to search the user's customer database and select existing customers; a dropdown menu for selecting predefined reasons for adding the customer to the list; a textbox to receive reasons not included in the predefined list; and receiving end user permission to globally share comments; making available to all users of the software the reason and/or comments in a globally shared database. Removing the customer behavior entry includes functions such as: automatically assign an expiration date to each entry from the date of entry; allow the end user account that submitted the entry to remove the entry; and automatically assign an expiration from the date the end user account that enters the entry ceases to utilize the software. Customer behavior allows items such as: a message can be displayed to users when data points are matched against the customer behavior list where the system verifies items if form inputs align with stored database data, accommodating changes in customer details; a detection system triggers an alert when matching information is detected; ability to dismiss alerts for specific matching information; enables users to independently disable global alerts without impacting other users; if comment sharing is enabled by users adding an entry to the customer behavior list, the alerted user can access the comments; allows users to confirm or cancel proceeding with the entry; and an alert displays generalized, non-identifying information showing how many businesses have added the entry to the customer behavior list since its original entered date. The method includes functions such as: security override methods for the customer behavior entry originator such as a security pin or password override to permit submission after the prevention alert is received; and prevention of the user who submitted the entry to the customer behavior list from entering the data into their form until the entry is removed from the list or an override is applied. The method includes functions such as: a management interface that provides an interface for end users to manage entries they submitted to the customer behavior list; requires a password or security pin for editing or removing entries submitted to the customer behavior list; and ability to include expired information in the alert system.

The method includes performing multi-tenant automatic backup billing by performing functions such as: automatic verification of matching data entered into a form against an external database; retrieving a billing exclusion list from an internal database for one or more electronic devices to skip billing; retrieving encoded daily backup usage from an external backup provider database for a plurality of user accounts kept in an internal database for a multi-tenant software environment; and decoding and converting the retrieved backup usage data into a billing-compatible format; and automatically determining usage fees for each user account not included within the exclusion list.

The method includes scheduling an appointment by performing functions such as: receiving data entered into the form for a prospect as part of an order or scheduling an appointment; determine if the data entered into the form matches a multi-factor inexact search of data within a database for globally lists such as a customer behavior or cancellation list; if a match is found with multiple points of data in either list, display a message to the end user entering the data; receiving data entry for a street address; retrieving a GPS coordinate for the street address; and dynamically determining distance and travel time from a predetermined office location to the street address. The method includes performing functions such as: dynamically verifying data; reading shared comments from the customer behavior list entered by other end users; providing an alert if the matching data exceeds the threshold number of allowed appointment cancellations; and scheduling the appointment and overriding the message. The method includes performing functions such as: allowing end users to select from a variety of online calendar applications; data connection to an online calendar system; sending application programming interface (API) requests to the selected online calendar; tracking time entries within the scheduled appointment; matching data entries against a calendar system for conflicting scheduled appointments; provides alerts if the selected time conflicts with the service providers existing scheduled and personal appointments; providing suggested available times based on the calendar data; and allowing the end user to override the message to double book appointments. The method includes performing functions such as: receiving data entered into the form for a prospect as part of an order or scheduling an appointment with data entry for service or equipment make, model and/or type and storing a plurality of service or equipment details in a database; ability to globally share the data entry for service or equipment make, model and/or type entered within the software or restrict it for private use; and enabling configuration of appointment reminder settings for end users and/or service providers. The method includes performing functions such as: allowing end users to modify the cancellation threshold settings; and enabling association of the scheduled appointment with a service contract. The method provides functions such as: an error verification and handling component for verifying potential errors and inaccuracies from information received from several sources and subsystems; sending alerts with error messages back to the end user or the respective source; determining if it is necessary to update the database; and if there are no errors detected, sending authorized verification back to the end user or respective source.

The method includes managing sales transactions by performing functions such as: creating line items for services or products; establishing a connection with an online accounting software, a sales tax calculation software, and an online payment processor; extracting one or more keyword phrases in a file and generating a sales receipt by replacing data in lieu of the keyword phrases in a file; enabling and disabling the recording of transactions into an accounting software for individual payment methods; handling failed transactions; synchronizing sales and accounting data to a plurality of online software systems; selecting specific line items for inclusion in a transaction; collecting initial data from a database to pre-fill necessary information for a sales checkout process; and associating a fixed or dynamic fee based on items such as: individual transaction amount, purchases, totality of processed transactions, and predefined parameters. The method includes establishing a connection with an online accounting software, a sales tax calculation software, and an online payment processor to integrate and calculate state and county sales tax rates using data from a sales tax provider; geolocate address location and apply sales tax rates for addresses without an automatically assigned tax rate; provide a list of regional tax rates for manual selection based on provided address information; performing payment processing with the online credit card processor; recording payments into an online accounting software. The handling of failed transactions includes performing functions such as: capturing failed transactions; notifying users of failed transactions through alert banners; and allowing users to reprocess failed transactions. The method includes performing functions such as: displaying a banner for unpaid scheduled appointments, after a customizable time threshold, with a clickable hyperlink to access a checkout process for an unpaid appointment; and displaying a checkout reminder notification when creating an appointment for unpaid scheduled appointments.

The method includes functions such as: integrating and managing multiple software components in a unified platform by performing functions such as: connecting a plurality of software components to an integrated communication framework; establishing data synchronization channels between the connected software components; continuously monitoring data exchanges across the connected software components; automatically transferring updated data between relevant software components upon detecting a change in any connected component; verifying data consistency and accuracy across all connected software components; performing automated error checks and corrections on transferred data; and executing automated tasks across multiple software components. The method includes performing functions such as: establishing data synchronization channels between the connected software components by performing functions such as: facilitating transient data communication within the integrated communication framework; managing the flow of temporary data between software components; initiating automated error-checking routines for transient data during synchronization; performing validation of transient data consistency between components; and updating each software component with transient data changes instantaneously upon receipt. The continuously monitoring data exchanges across the connected software components includes performing functions such as: tracking the flow of transient data to identify inconsistencies or errors; logging data transactions between components for audit and verification purposes; detecting changes in data states and triggering automated responses; alerting users or system administrators to potential synchronization issues; and verifying the successful transmission of data packets between components.

### Marketing Success Sharing System

In yet another aspect, a method for managing marketing campaigns for a user in a service business software system includes collecting marketing performance data from a plurality of users such as: segmenting the plurality users into one or more predetermined user groups; matching the user into one of the predetermined groups or subgroups; and retrieving and rendering marketing data from the matched predetermined group.

Implementations of the above may include one or more of the following. The method provides functions such as: a user interface including items such as: an opt-in or opt-out of data sharing for marketing details; allowing end users to select and deselect the alerts they receive; provides an interface for users to search or enter data or select a marketing campaign type; allows users to expand search criteria to include non-industry-specific results; ability to filter one or more items such as: industry, location, other predetermined criteria; and ability to sort and organize search results by a plurality of metrics. The method includes functions such as: collecting data and calculating return on investment (ROI) for each lead source such as: capturing individual marketing campaign data within a multi-tenant software system from a plurality of users; tracking marketing expenses associated with each lead source; calculates gross sales and net profit for each marketing campaign; updates ROI as transactions are processed; calculating customer lifetime value for customers acquired through each lead source including factors such as total transactions, total revenue over time, and/or service integration costs; and determining the ratio of customer lifetime value to marketing expenses. The method includes functions such as: collecting marketing performance data from a plurality of users of the software using methods such as: by storing multi-tenant associated marketing data in a database; sharing anonymized lead source performance data; removing personally identifiable information from the data; aggregating data from a plurality of users within the same industry and geographic area; presenting the data in a format that prevents identification of individual businesses; and automatic disabling of retrieval of shared marketing data after a predetermined amount of time without transactions processed through the system. The retrieving and rendering marketing data from the matched predetermined group includes functions such as: tracking customer acquisitions associated with each lead source; tracking marketing campaign effectiveness based on the data entered; provides detailed metrics to the user who added the marketing campaign; displays visual representations of data showing time, cost, and profit analysis to the end user; and provides other users with basic metrics such as average spending, acquisition, and ROI. An alert system can be used that displays alerts during searches such as when adding a new marketing campaign; when goals were reached for specific marketing campaigns; and when a marketing campaign's profit met predetermined factors. The method includes functions such as: machine learning to predict lead source effectiveness based on historical data and shared performance metrics.

The method includes scheduling an appointment by performing functions such as: receiving data entered into the form for a prospect as part of an order or scheduling an appointment; determine if the data entered into the form matches a multi-factor inexact search of data within a database for globally lists such as a customer behavior or cancellation list; if a match is found with multiple points of data in either list, display a message to the end user entering the data; receiving data entry for a street address; retrieving a GPS coordinate for the street address; and dynamically determining distance and travel time from a predetermined office location to the street address. The method includes performing functions such as: dynamically verifying data; reading shared comments from the customer behavior list entered by other end users; providing an alert if the matching data exceeds the threshold number of allowed appointment cancellations; and scheduling the appointment and overriding the message. The method includes performing functions such as: allowing end users to select from a variety of online calendar applications; data connection to an online calendar system; sending application programming interface (API) requests to the selected online calendar; tracking time entries within the scheduled appointment; matching data entries against a calendar system for conflicting scheduled appointments; provides alerts if the selected time conflicts with the service providers existing scheduled and personal appointments; providing suggested available times based on the calendar data; and allowing the end user to override the message to double book appointments. The method includes performing functions such as: receiving data entered into the form for a prospect as part of an order or scheduling an appointment with data entry for service or equipment make, model and/or type and storing a plurality of service or equipment details in a database; ability to globally share the data entry for service or equipment make, model and/or type entered within the software or restrict it for private use; and enabling configuration of appointment reminder settings for end users and/or service providers. The method includes performing functions such as: allowing end users to modify the cancellation threshold settings; and enabling association of the scheduled appointment with a service contract. The method provides functions such as: an error verification and handling component for verifying potential errors and inaccuracies from information received from several sources and subsystems; sending alerts with error messages back to the end user or the respective source; determining if it is necessary to update the database; and if there are no errors detected, sending authorized verification back to the end user or respective source.

The method includes functions such as: annotating customer data by performing functions such as: capturing repetitive data from a repetitive task generated when a computer data form is submitted; capturing a custom note for an event; adding the custom note to the repetitive data; and summing up all repetitive data and custom notes in sequential order.

The method includes managing sales transactions by performing functions such as: creating line items for services or products; establishing a connection with an online accounting software, a sales tax calculation software, and an online payment processor; extracting one or more keyword phrases in a file and generating a sales receipt by replacing data in lieu of the keyword phrases in a file; enabling and disabling the recording of transactions into an accounting software for individual payment methods; handling failed transactions; synchronizing sales and accounting data to a plurality of online software systems; selecting specific line items for inclusion in a transaction; collecting initial data from a database to pre-fill necessary information for a sales checkout process; and associating a fixed or dynamic fee based on items such as: individual transaction amount, purchases, totality of processed transactions, and predefined parameters. The method includes establishing a connection with an online accounting software, a sales tax calculation software, and an online payment processor to integrate and calculate state and county sales tax rates using data from a sales tax provider; geolocate address location and apply sales tax rates for addresses without an automatically assigned tax rate; provide a list of regional tax rates for manual selection based on provided address information; performing payment processing with the online credit card processor; recording payments into an online accounting software. The handling of failed transactions includes performing functions such as: capturing failed transactions; notifying users of failed transactions through alert banners; and allowing users to reprocess failed transactions. The method includes performing functions such as: displaying a banner for unpaid scheduled appointments, after a customizable time threshold, with a clickable hyperlink to access a checkout process for an unpaid appointment; and displaying a checkout reminder notification when creating an appointment for unpaid scheduled appointments.

The method includes functions such as: integrating and managing multiple software components in a unified platform by performing functions such as: connecting a plurality of software components to an integrated communication framework; establishing data synchronization channels between the connected software components; continuously monitoring data exchanges across the connected software components; automatically transferring updated data between relevant software components upon detecting a change in any connected component; verifying data consistency and accuracy across all connected software components; performing automated error checks and corrections on transferred data; and executing automated tasks across multiple software components. The method includes performing functions such as: establishing data synchronization channels between the connected software components by performing functions such as: facilitating transient data communication within the integrated communication framework; managing the flow of temporary data between software components; initiating automated error-checking routines for transient data during synchronization; performing validation of transient data consistency between components; and updating each software component with transient data changes instantaneously upon receipt. The continuously monitoring data exchanges across the connected software components includes performing functions such as: tracking the flow of transient data to identify inconsistencies or errors; logging data transactions between components for audit and verification purposes; detecting changes in data states and triggering automated responses; alerting users or system administrators to potential synchronization issues; and verifying the successful transmission of data packets between components.

### Appointment Scheduling System

In a further aspect, a method for scheduling an appointment includes receiving data entered into the form for a prospect as part of an order or scheduling an appointment; determine if the data entered into the form matches a multi-factor inexact search of data within a database such as: a globally shared customer behavior list and/or a globally shared cancellation list; and if a match is found with multiple points of data in either list, displays a message to the end user entering the data.

Implementations of the above may include one or more of the following. The method includes functions such as: receiving data entry for a street address; retrieving a global positioning system (GPS) coordinate for the street address; and dynamically determining distance and travel time from a predetermined office location to street address. The dynamically determining distance and travel time from a predetermined office location to street address includes determining a fee based on gps location data and predetermined office location in a multi-tenant software system. The method includes functions such as: dynamically verifies data; ability to read shared comments for the customer behavior list entered by other end users; provides an alert if the matching data exceeds the threshold number of allowed appointment cancellations; and ability to proceed scheduling the appointment and override the message. The method includes functions such as: allowing end user to select from a variety of online calendar applications; data connection to an online calendar system; sending application programming interface (API) requests to selected online calendar; tracking time entries within the scheduled appointment; matching data entries against a calendar system for conflicting scheduled appointments; provides alerts if the selected time conflicts with the service providers existing scheduled and personal appointments; providing suggested available times based on the calendar data; and allowing the end user to override the message to double book appointments. The method includes functions such as: tracking a lead source based on the client information. The receiving data entered into the form for a prospect as part of an order or scheduling an appointment can include data entry for service or equipment make, model and/or type and storing a plurality of service or equipment details in a database; ability to globally share the data entry for service or equipment make, model and/or type entered within the software or restrict it for private use; and enabling configuration of appointment reminder settings for end users and/or service providers. The method includes functions such as: allowing end user to select from a variety of online contact management systems; integrating entries from the software into the selected online contact management system; automatically adds or edits data entered to an online contact list; automatically distinguish personal entries from professional entries for contacts entered using the software by providing a custom name field in the user input form; and separation of current contacts in the users contact management system from software created contacts with a user-provided designator before the contact name, example “client natalie short” instead of “natalie short”. The method includes generating appointment documentation by replacing keyword phrases within templated documents and/or spreadsheets with data entered into a form. The method includes functions such as: allowing end users to modify the cancellation threshold settings; enabling automatic association of the scheduled appointment with a service contract; and providing the ability to override automatic associations.

The method includes functions such as: error verification and handling by performing functions such as: verifying potential errors and inaccuracies from the information received from several sources and subsystems; sending alerts with error messages back to a user or a respective source; determining if it is necessary to update a database; and if there are no errors detected, sending authorized verification back to a user or a respective source. The method includes functions such as: preparing a file responsive to a plurality of file types by performing functions such as: receiving a templated file with one or more keyword phrases and templated content; receiving data expressed in one or more file types and extracting text data from received file types; dynamically generating custom text by replacing keyword phrases with extracted text data and placing custom text within a templated content; and recommending changes.

The method includes functions such as: annotating customer data by performing functions such as: capturing repetitive data from a repetitive task generated when a computer data form is submitted; capturing a custom note for an event; adding the custom note to the repetitive data; and summing up all repetitive data and custom notes in sequential order.

The method includes functions such as: integrating and managing multiple software components in a unified platform by performing functions such as: connecting a plurality of software components to an integrated communication framework; establishing data synchronization channels between the connected software components; continuously monitoring data exchanges across the connected software components; automatically transferring updated data between relevant software components upon detecting a change in any connected component; verifying data consistency and accuracy across all connected software components; performing automated error checks and corrections on transferred data; and executing automated tasks across multiple software components. The method includes performing functions such as: establishing data synchronization channels between the connected software components by performing functions such as: facilitating transient data communication within the integrated communication framework; managing the flow of temporary data between software components; initiating automated error-checking routines for transient data during synchronization; performing validation of transient data consistency between components; and updating each software component with transient data changes instantaneously upon receipt. The continuously monitoring data exchanges across the connected software components includes performing functions such as: tracking the flow of transient data to identify inconsistencies or errors; logging data transactions between components for audit and verification purposes; detecting changes in data states and triggering automated responses; alerting users or system administrators to potential synchronization issues; and verifying the successful transmission of data packets between components.

### Multi-Payment Invoicing System

In yet another aspect, a method for scheduling multiple payments for an invoice with an amount includes providing one of two payment options: 1) full payment, and 2) a selected payment term; if the invoice recipient does not pay in full or select a payment term within a predetermined time, automatically configure and schedule one or more recurring payments over a period of time; automatically selecting a predetermined periodic payment for which the customer qualifies based on periodic payment parameters configured by the end user; and periodically processing a payment in satisfaction of the invoice.

Implementations of the above may include one or more of the following. The providing one of two payment options: 1) full payment, and 2) a selected payment term includes end user interface for configuring invoice settings, email notifications, managing payment terms, managing invoices, minimum down payments, interest rates and/or late fees; allowing user configurable minimal recurring payment amount; ability for end users to upload their own custom templates or use provided templates; and allowing end users to disable multi-payment invoicing and/or the automatic payment scheduling feature for all invoices. The end user interface for configuring invoice settings, email notifications, managing payment terms, managing invoices, minimum down payments, interest rates and/or late fees can have an interface for viewing and editing customer information, receiving or editing invoice data; storing finalized invoice data in the system's database; sending initial emails with one features such as: invoice and payment details, payment hyperlink, automatic payment scheduling details; automatic alerts for users if a customer lacks credit card information on file with a credit card processor, has a history of unpaid invoices, and/or if there are any discrepancies or missing information in invoices; email and notification system for end users and invoice recipients; automatically integrating data from forms into custom templates and converting them to a different file format; sending notifications to invoice recipients for unpaid invoices; sending notifications to end users about predetermined issues requiring immediate attention; and configuring reminder intervals and messaging to ensure timely communication with the invoice recipient. The sending of initial emails contains items such as: invoice and payment details, payment hyperlink, automatic payment scheduling details can include online guest and private end user system; guest checkout can process payments using credit card or digital currency; end user checkout system can process payment options such as: check, cash, credit card and digital currency. The method can process one time payment in full through an online payment processor; ability to add or remove credit cards and set a default card for multiple payments; add a down payment when scheduling multi-payment processing; automatically determine a minimum and maximum down payment amount allowed when scheduling multi-payment processing; automatically adjust the payment term length and amount based on down payment entered; select processing recurring payments on specified dates (ie. 1st or 15th of the month); and select payment term length from qualified payment terms to schedule payments. The interface for viewing and editing customer information, receiving or editing invoice data can provide automated invoice management, including automatically updating invoice status and tracking payment history; and displaying detailed payment schedules and amounts. Automatically selecting a predetermined periodic payment for which the customer qualifies based on periodic payment parameters configured by the end user includes items such as: determining if an invoice recipient qualifies for multi-payment terms based on configured minimum recurring payment parameters and credit card expiration date; calculating amounts due for each payment in the payment schedule; automatically create a payment plan if the invoice recipient does not create a multi-payment schedule by the predetermined date; automatically schedules recurring payments of the lowest payment with the highest interest rate for the longest term length for which the invoice recipient qualifies; generating a multi-payment schedule including the interest charges; and sending a notification to an invoice recipient if the automatic payment scheduler is invoked. The calculating amounts due for each payment in the payment schedule includes allowing end users to adjust their interest rate settings for payment term schedules; receiving invoice data including a total amount and a payment term; applying different interest rates based on the length of the payment term; automatically calculates interest for each installment, from predetermined values, based on the total amount and the payment term; automatically adjusting interest rates for early payments or late payments; and recalculating the payment schedule when a customer makes an early or partial payment. If the invoice recipient does not pay in full or select a payment term within a predetermined time, automatically configure and schedule one or more recurring payments over a period of time includes features such as: automatic processing for each payment installment; implementing automated remittance capture to match incoming payments with corresponding invoices; charging a default credit card on file through an online payment processor; interface displaying the status of multi-payment invoices; handling partial payments and overpayments; handling early payments with the ability to skip the next scheduled payment; automatically generating receipts and sending them to customers upon payment processing; automatically distributing receipts and updating connected systems; and creating a colored alert banner for declined, failed, or missed recurring payments. The automatic distribution of receipts and updating connected systems includes synchronized accounting system integration; seamlessly integrating with online accounting software to synchronize payment data; automating the transfer of financial data to online accounting systems to reduce manual entry and errors; and automatic deposit creation into an online accounting system.

The method includes managing sales transactions by performing functions such as: creating line items for services or products; establishing a connection with an online accounting software, a sales tax calculation software, and an online payment processor; extracting one or more keyword phrases in a file and generating a sales receipt by replacing data in lieu of the keyword phrases in a file; enabling and disabling the recording of transactions into an accounting software for individual payment methods; handling failed transactions; synchronizing sales and accounting data to a plurality of online software systems; selecting specific line items for inclusion in a transaction; collecting initial data from a database to pre-fill necessary information for a sales checkout process; and associating a fixed or dynamic fee based on items such as: individual transaction amount, purchases, totality of processed transactions, and predefined parameters. The method includes establishing a connection with an online accounting software, a sales tax calculation software, and an online payment processor to integrate and calculate state and county sales tax rates using data from a sales tax provider; geolocate address location and apply sales tax rates for addresses without an automatically assigned tax rate; provide a list of regional tax rates for manual selection based on provided address information; performing payment processing with the online credit card processor; recording payments into an online accounting software. The handling of failed transactions includes performing functions such as: capturing failed transactions; notifying users of failed transactions through alert banners; and allowing users to reprocess failed transactions. The method includes performing functions such as: displaying a banner for unpaid scheduled appointments, after a customizable time threshold, with a clickable hyperlink to access a checkout process for an unpaid appointment; and displaying a checkout reminder notification when creating an appointment for unpaid scheduled appointments.

The method includes accounting for a payment associated with a transaction by performing functions such as: processing the payment via a first vendor, wherein the first vendor takes a deduction from an amount sent to a second vendor; identifying the amount sent to the second vendor and aggregating the deposit and the deduction to create a net payment; indicating the net payment as a deposit receipt in an online accounting software; and automatic description note entries relating to the deposit. The processing the payment via a first vendor, wherein the first vendor takes a deduction from an amount sent to a second vendor, wherein the first vendor includes an online payment processor and the second vendor includes a financial institution. The identifying the amount sent to the second vendor and aggregating the deposit and the deduction to create a net payment includes performing functions such as: identifying deposit information from a online payment processor includes items such as: the quantity of transactions, amount per transaction, unique identifiers involved in the transaction and merchant service fees charged per transaction; and corresponding the deposit information to individual sales receipts and performing calculations to create a matching deposit from the second vendor.

The method for dynamically managing transaction fees in a financial processing system by performing functions such as: initializing a default base fee percentage for transactions; processing a plurality of transactions for an end user, wherein each transaction includes applying the current fee percentage to the transaction amount; accumulating fee revenue from the processed transactions over a predetermined time period; calculating total business service costs for the end user over the predetermined time period; comparing the accumulated fee revenue to the total business service costs; adjusting the fee percentage for a subsequent time period based on the comparison, wherein the adjustment is constrained by a predefined ceiling and floor percentage; locking the adjusted fee percentage for the subsequent time period; and applying the locked fee percentage to transactions in the subsequent time period.

The method includes functions such as: integrating and managing multiple software components in a unified platform by performing functions such as: connecting a plurality of software components to an integrated communication framework; establishing data synchronization channels between the connected software components; continuously monitoring data exchanges across the connected software components; automatically transferring updated data between relevant software components upon detecting a change in any connected component; verifying data consistency and accuracy across all connected software components; performing automated error checks and corrections on transferred data; and executing automated tasks across multiple software components. The method includes performing functions such as: establishing data synchronization channels between the connected software components by performing functions such as: facilitating transient data communication within the integrated communication framework; managing the flow of temporary data between software components; initiating automated error-checking routines for transient data during synchronization; performing validation of transient data consistency between components; and updating each software component with transient data changes instantaneously upon receipt. The continuously monitoring data exchanges across the connected software components includes performing functions such as: tracking the flow of transient data to identify inconsistencies or errors; logging data transactions between components for audit and verification purposes; detecting changes in data states and triggering automated responses; alerting users or system administrators to potential synchronization issues; and verifying the successful transmission of data packets between components.

### Profit Sharing Video Platform

In a further aspect, a method for generating content for a plurality of channels on a shared video platform includes for each channel, receiving content from each content provider independently creating content as part of a community for the channel; promoting the community output to get more views than possible with content from each content provider stand-alone on the shared platform; collectively obtaining channel subscribers for each content provider and collectively increasing views for the content; and rewarding a content provider for their combined contributions based on a plurality of engagement metrics for each revenue eligible content within the channels.

Implementations of the above may include one or more of the following. The method includes items such as: providing a registration interface allowing a user to fill out a content provider application and upload or link to a video to apply to become a content provider; providing a voting interface that allows other content providers to vote on the content provider application; and providing a content provider approval interface for final approval or dismissal of the application, wherein the final content provider application approval or dismissal is decided by a moderator. The method includes functions such as: assisted or automatic uploading of digital content to shared video platform channels; providing translation services to extract audio from videos, convert that audio to text, translate the text into different languages, and associate subtitles for video uploads; machine learning content filtering for a plurality of languages of prohibited content, and preventing uploads by placing flagged videos into a review queue. The method includes a contract compliance system utilizing items such as: filters and machine learning models to ensure adherence to contract terms. The method includes creation of items such as: marketing uniform resource locators (URLs) for each user uploaded video and playlist. The marketing URLs use search engine optimization (SEO) compliant tactics to distinguish and segregate traffic, redirecting search engine spiders to one URL and human clicks to a different URL or redirect search engine spiders and human clicks to the same URL. The method includes items such as: providing a content review process wherein uploaded videos are screened for compliance with platform guidelines before being assigned a unique identifier and made available for viewing; allowing users to manage notifications for video uploads while minimizing the daily notification alerts channel subscribers receive with a notification queuing system. The rewarding a content provider for their combined contributions can be based on a plurality of engagement metrics for each revenue eligible content within the channels. The method includes using strategies such as: integrating with video analytics to retrieve data on video performance; storing the retrieved data in a local database; and updating the content provider's dashboard with the metrics at predetermined intervals. A dashboard for content providers may include items such as: displaying and tracking users' pending submission and published videos; and viewing video engagement metrics and earnings. The providing of a user interface includes items such as: a video upload wizard that guides content providers through the process of optimizing their video titles, descriptions, and tags for maximum visibility; machine learning (ML) assistant that may automatically generates the title, description, tags, and complete the submission process for the content provider; an ML assisted thumbnail creation tool that allows creators to generate custom thumbnails; a scheduling feature that enables content providers to plan and automate video releases at optimal times; and a notification queuing system allowing users to schedule notifications for video uploads minimizing the daily notification alerts channel subscribers receive. The rewarding a content provider for their combined contributions can be based on a plurality of engagement metrics for each revenue eligible content within the channels where calculating profit share in consideration of engagement metrics includes items such as: if the video is eligible for revenue, view percentage, watch time in minutes for eligible videos, watch time in minutes for non-valid videos, average view duration percentage, comments, likes, dislikes, shares, subscribers gained, subscribers lost, audience retention percentage, country code, province code and predefined criteria. The method includes items such as: implementing automated checks for a queueing system, alert banners, contract verification, email notifications, video upload frequency, video length, activity monitoring, and notification language conversion. The method includes items such as: a comment moderation system that allows content providers to manage and respond to comments on their videos directly through the software platform; a filter system to automatically flag potentially inappropriate comments for review; and a machine learning-based automated comment response system. The method includes items such as: comprehensive audit logs to track system activity, troubleshoot issues, and analyze feature usage and; implementing a configurable autosave function to prevent data loss. The method includes providing features such as: a collaborative user interface for multiple content providers to upload individual videos to a shared video platform within a single account; automatic creation of default playlists for each user; enabling non-administrator users to create and rename playlists; system for content providers to request video deletions; an automated copyright strike response system; and crediting the calculated profit share to the content provider's account.

The method includes functions such as: integrating and managing multiple software components in a unified platform by performing functions such as: connecting a plurality of software components to an integrated communication framework; establishing data synchronization channels between the connected software components; continuously monitoring data exchanges across the connected software components; automatically transferring updated data between relevant software components upon detecting a change in any connected component; verifying data consistency and accuracy across all connected software components; performing automated error checks and corrections on transferred data; and executing automated tasks across multiple software components. The method includes performing functions such as: establishing data synchronization channels between the connected software components by performing functions such as: facilitating transient data communication within the integrated communication framework; managing the flow of temporary data between software components; initiating automated error-checking routines for transient data during synchronization; performing validation of transient data consistency between components; and updating each software component with transient data changes instantaneously upon receipt. The continuously monitoring data exchanges across the connected software components includes performing functions such as: tracking the flow of transient data to identify inconsistencies or errors; logging data transactions between components for audit and verification purposes; detecting changes in data states and triggering automated responses; alerting users or system administrators to potential synchronization issues; and verifying the successful transmission of data packets between components.

### Dynamic Contract Creation

In a yet another aspect, a method for preparation of a file responsive to a plurality of file types, includes items such as: receiving a templated file with one or more keyword phrases and templated content; receiving data expressed in one or more file types and extracting text data from the received file types; dynamically generating custom text by replacing keyword phrases with the extracted text data and placing the custom text within the templated content; and recommending changes based on the document requirements.

Implementations of the above may include items such as: The dynamically generating of custom text by replacing keyword phrases with the extracted text data and placing the custom text within the templated content includes items such as: automatically configuring one or more keyword phrases into a template; providing the end user with required software compatible keyword phrases to integrate into their business contracts for manual contract template preparation; providing an automated system that reviews, converts, and integrates required software-compatible keyword phrases into user-uploaded files offering recommendations for changes; providing pre-written basic service contract templates for user consumption while using the software; allowing the end user to make independent, non-global shared, edits to their contracts.

The dynamically generating a file by replacing keyword phrases in a data file with data derived from a form submission on the Internet, data within a database or other data sources includes: receiving the selected term and payment type from the user; a fixed-price, non-prorated, single-term length, prepaid contract; and a variable term contract with one or more of: flexible payment terms, variable term lengths, ability to prorate payments, and ability to charge based on working days.

The billing generation includes functions such as: defining a matrix specifying price data per contract term, contract length and category; applying one or more payment parameters to index into the matrix to determine a price; displaying a banner for unpaid scheduled appointments, after a customizable time thresholds, with a clickable hyperlink to access a checkout process for an unpaid appointment; and disabling a checkout reminder notification when creating an appointment or in an alert system for unpaid scheduled appointments. The applying one or more payment parameters to index into the matrix to determine a price includes items such as: calculations includes items such as: convenience fees, sales tax, cost, discounts, prepayments, monthly payments, interest due, working days, business or residential, start date, business size; receiving contract data includes items such as: a contract term, a daily rate, an amount and a fixed rate; calculating a recurring payment based on the contract terms; receiving contract data including a varied plurality of contract terms; determining a number of working days within the contract term; prorated annual service contracts, where the proration is determined by items such as: total days in the month, working days, and user-provided information in a mathematical matrix; calculating a total or a prorated amount based on items such as: a plurality of variables, daily rate, a fixed term length, number of working days and/or the contract terms; and generating a prorated contract amount. The defining a matrix specifying price data per contract term, contract length and category includes items such as: an interface providing the flexibility to create and apply custom pricing based on a complex multi-tiered pricing matrix, prepaid blocks of time, flat rate, or hourly based contracts; a plurality of payment terms based on contract term length through a mathematical matrix handled by the software; ability to bill only for working days for the contract; and implementing a flexible fee structure for late payments. The Applying of a mathematical matrix includes items such as: determining the pricing based on a selection within a form.

The method includes managing, tracking and reporting customer behavior by performing functions such as: receiving data entered into a form for a prospect as part of an order or scheduling an appointment; determining if the data entered exists in a database based on a multi-factor inexact search for the prospect; and if the prospect is in the database, automatically displaying a message to a user entering the data. The determining if the data entered exists in a database based on a multi-factor inexact search for the prospect includes items such as: company name, personal name, address, city, state, zip code, email, and telephone number(s).

The method includes scheduling an appointment by performing functions such as: receiving data entered into the form for a prospect as part of an order or scheduling an appointment; determine if the data entered into the form matches a multi-factor inexact search of data within a database for globally lists such as a customer behavior or cancellation list; if a match is found with multiple points of data in either list, display a message to the end user entering the data; receiving data entry for a street address; retrieving a GPS coordinate for the street address; and dynamically determining distance and travel time from a predetermined office location to the street address. The method includes performing functions such as: dynamically verifying data; reading shared comments from the customer behavior list entered by other end users; providing an alert if the matching data exceeds the threshold number of allowed appointment cancellations; and scheduling the appointment and overriding the message. The method includes performing functions such as: allowing end users to select from a variety of online calendar applications; data connection to an online calendar system; sending application programming interface (API) requests to the selected online calendar; tracking time entries within the scheduled appointment; matching data entries against a calendar system for conflicting scheduled appointments; provides alerts if the selected time conflicts with the service providers existing scheduled and personal appointments; providing suggested available times based on the calendar data; and allowing the end user to override the message to double book appointments. The method includes performing functions such as: receiving data entered into the form for a prospect as part of an order or scheduling an appointment with data entry for service or equipment make, model and/or type and storing a plurality of service or equipment details in a database; ability to globally share the data entry for service or equipment make, model and/or type entered within the software or restrict it for private use; and enabling configuration of appointment reminder settings for end users and/or service providers. The method includes performing functions such as: allowing end users to modify the cancellation threshold settings; and enabling association of the scheduled appointment with a service contract. The method provides functions such as: an error verification and handling component for verifying potential errors and inaccuracies from information received from several sources and subsystems; sending alerts with error messages back to the end user or the respective source; determining if it is necessary to update the database; and if there are no errors detected, sending authorized verification back to the end user or respective source.

The method includes managing sales transactions by performing functions such as: creating line items for services or products; establishing a connection with an online accounting software, a sales tax calculation software, and an online payment processor; extracting one or more keyword phrases in a file and generating a sales receipt by replacing data in lieu of the keyword phrases in a file; enabling and disabling the recording of transactions into an accounting software for individual payment methods; handling failed transactions; synchronizing sales and accounting data to a plurality of online software systems; selecting specific line items for inclusion in a transaction; collecting initial data from a database to pre-fill necessary information for a sales checkout process; and associating a fixed or dynamic fee based on items such as: individual transaction amount, purchases, totality of processed transactions, and predefined parameters. The method includes establishing a connection with an online accounting software, a sales tax calculation software, and an online payment processor to integrate and calculate state and county sales tax rates using data from a sales tax provider; geolocate address location and apply sales tax rates for addresses without an automatically assigned tax rate; provide a list of regional tax rates for manual selection based on provided address information; performing payment processing with the online credit card processor; recording payments into an online accounting software. The handling of failed transactions includes performing functions such as: capturing failed transactions; notifying users of failed transactions through alert banners; and allowing users to reprocess failed transactions. The method includes performing functions such as: displaying a banner for unpaid scheduled appointments, after a customizable time threshold, with a clickable hyperlink to access a checkout process for an unpaid appointment; and displaying a checkout reminder notification when creating an appointment for unpaid scheduled appointments.

The method includes managing online customer reviews by performing functions such as: associating keyword phrases with the product or service, wherein the keyword phrases are stored in an indexed table; generating reviews based on the keyword phrases; requesting a customer review of a product or a service; predetermining a customer review rating; if the rating is less than a specified threshold, send customer to a feedback webpage; if the rating meets or is greater than a specified threshold, send customer to a website review instructional guide; if the customer feedback is below a predetermined rating threshold, automatically placing customer information in banned review list; and managing a list of banned review customers.

The method includes functions such as: annotating customer data by performing functions such as: capturing repetitive data from a repetitive task generated when a computer data form is submitted; capturing a custom note for an event; adding the custom note to the repetitive data; and summing up all repetitive data and custom notes in sequential order.

The method includes functions such as: integrating and managing multiple software components in a unified platform by performing functions such as: connecting a plurality of software components to an integrated communication framework; establishing data synchronization channels between the connected software components; continuously monitoring data exchanges across the connected software components; automatically transferring updated data between relevant software components upon detecting a change in any connected component; verifying data consistency and accuracy across all connected software components; performing automated error checks and corrections on transferred data; and executing automated tasks across multiple software components. The method includes performing functions such as: establishing data synchronization channels between the connected software components by performing functions such as: facilitating transient data communication within the integrated communication framework; managing the flow of temporary data between software components; initiating automated error-checking routines for transient data during synchronization; performing validation of transient data consistency between components; and updating each software component with transient data changes instantaneously upon receipt. The continuously monitoring data exchanges across the connected software components includes performing functions such as: tracking the flow of transient data to identify inconsistencies or errors; logging data transactions between components for audit and verification purposes; detecting changes in data states and triggering automated responses; alerting users or system administrators to potential synchronization issues; and verifying the successful transmission of data packets between components.

### Vendor Store

In yet another aspect, a method for a purchase reward system includes assessing purchase reward eligibility for a product purchase; determining an individual reward amount based on the user's total gross sales transactions processed through a sales system; automatically adjusting the purchase reward over a predetermined period based on accumulated gross sales transactions; and providing feedback on a reward status change.

Implementations of a purchase reward system may include items such as: The initiating of a multitude of timers to automatically spread purchase reward points over a predetermined time. The method includes items such as: visual indicators to highlight information including error messages, payment verification statuses, purchase rewards eligibility. The method includes items such as: performing automatic vendor registration and verification. The method includes items such as: managing vendor relationships by using methods such as: receiving vendor registration information; verifying vendor credentials using external application programming interfaces (API); storing vendor information in a database; managing vendor product listings; processing vendor payments through an integrated payment system; tracking vendor performance metrics; and generating vendor reports. The method includes items such as: assessing purchase reward eligibility for a product purchase includes items such as: setting a purchase reward percentage; tracking the total amount spent by each user on qualifying purchases; calculating the purchase reward amount based on the tracked spending and set percentage; associating the calculated purchase reward amount in a customer account; and providing a user interface for customers to view their accumulated purchase rewards. The method includes items such as: reducing recurring fees collected from end users by the amount set in accordance with global administrator settings based on purchase reward qualifications. The method includes items such as: allowing end users to purchase from the vendor store at any time, with purchases qualifying for purchase rewards only if the user qualifies for the purchase reward system. The automatically adjusting the purchase reward over a predetermined period based on accumulated gross sales transactions processed through the software system includes items such as: considers transaction volume and service usage in determining the user's maximum purchase rewards; and adjusts purchase rewards amounts and eligibility based on the user's financial activity and performance.

The method for dynamically managing transaction fees in a financial processing system by performing functions such as: initializing a default base fee percentage for transactions; processing a plurality of transactions for an end user, wherein each transaction includes applying the current fee percentage to the transaction amount; accumulating fee revenue from the processed transactions over a predetermined time period; calculating total business service costs for the end user over the predetermined time period; comparing the accumulated fee revenue to the total business service costs; adjusting the fee percentage for a subsequent time period based on the comparison, wherein the adjustment is constrained by a predefined ceiling and floor percentage; locking the adjusted fee percentage for the subsequent time period; and applying the locked fee percentage to transactions in the subsequent time period.

The method includes functions such as: integrating and managing multiple software components in a unified platform by performing functions such as: connecting a plurality of software components to an integrated communication framework; establishing data synchronization channels between the connected software components; continuously monitoring data exchanges across the connected software components; automatically transferring updated data between relevant software components upon detecting a change in any connected component; verifying data consistency and accuracy across all connected software components; performing automated error checks and corrections on transferred data; and executing automated tasks across multiple software components. The method includes performing functions such as: establishing data synchronization channels between the connected software components by performing functions such as: facilitating transient data communication within the integrated communication framework; managing the flow of temporary data between software components; initiating automated error-checking routines for transient data during synchronization; performing validation of transient data consistency between components; and updating each software component with transient data changes instantaneously upon receipt. The continuously monitoring data exchanges across the connected software components includes performing functions such as: tracking the flow of transient data to identify inconsistencies or errors; logging data transactions between components for audit and verification purposes; detecting changes in data states and triggering automated responses; alerting users or system administrators to potential synchronization issues; and verifying the successful transmission of data packets between components.

### Online Review Controller System

In yet another aspect, a method for managing online customer reviews, includes items such as: associating keyword phrases with the product or service, wherein the keyword phrases are stored in an indexed table; generating reviews based on the keyword phrases; requesting a customer review upon or after the purchase of a product or a service; predetermining a customer review rating; if the rating is less than a specified threshold, send customer to a feedback webpage; if the rating meets or is greater than a specified threshold, send customer to a website review instructional guide; if the customer feedback is below a predetermined rating threshold, automatically placing customer information in banned review list; and managing a list of banned review customers.

Implementations of the above may include items such as: The associating keyword phrases with the product or service, wherein the keyword phrases are stored in an indexed table includes items such as: associates keyword phrases with products or services during their creation; dynamically retrieves keyword phrases during the checkout process; provides ability for reviews to contain the most desired keyword phrases; and uses indexing strategies enabling rapid keyword retrieval. The prewritten and customizable reviews includes items such as: ability to disable the review process during checkout; allows users to write multiple unique reviews during the checkout process, incorporating keyword phrases associated to the individual checkout items; allow for keyword phrase variance in a multitude of reviews; stores prewritten reviews in a database; and provides user's customers with the ability to approve and edit these prewritten reviews or write their own. The predetermining a customer review rating includes items such as: allow users to customize the review websites available for their customers; enable or disable review websites from a list; allow configuration for uniform resource locators (URLs) for each review website; ability to prioritize review websites; automatically generates and sends rating review emails to end user's customers upon completion of the checkout process; and ability to rate with hyperlinks that direct customers to review or feedback mechanisms based on the rating selected in the email. If the rating meets or is greater than a specified threshold, send customer to a website review instructional guide includes items such as: guides customers through a multi-step process to leave a review; select from a plurality of review websites; selecting or editing a prewritten review, retaining keyword phrases and a minimum required word count; viewing instructional materials on how to leave a review based upon the selected review website with ability to bypass instructional guide; a help button for assistance at each step; and automatically remove selected review websites and selected reviews to help keep posted reviews unique. If the rating is less than a specified threshold, the method performs functions such as: sends customers to a feedback webpage and allows customers to write feedback; allows customers to select a rating; displays other customer reviews; and notify the end user of received feedback. The management of a list of banned review customers includes items such as: allowing users to manage a banned review list; automatically adding customer information to a banned review list based on review ratings; and integrating with the checkout system to hide review requests for banned customers.

The method includes managing sales transactions by performing functions such as: creating line items for services or products; establishing a connection with an online accounting software, a sales tax calculation software, and an online payment processor; extracting one or more keyword phrases in a file and generating a sales receipt by replacing data in lieu of the keyword phrases in a file; enabling and disabling the recording of transactions into an accounting software for individual payment methods; handling failed transactions; synchronizing sales and accounting data to a plurality of online software systems; selecting specific line items for inclusion in a transaction; collecting initial data from a database to pre-fill necessary information for a sales checkout process; and associating a fixed or dynamic fee based on items such as: individual transaction amount, purchases, totality of processed transactions, and predefined parameters. The method includes establishing a connection with an online accounting software, a sales tax calculation software, and an online payment processor to integrate and calculate state and county sales tax rates using data from a sales tax provider; geolocate address location and apply sales tax rates for addresses without an automatically assigned tax rate; provide a list of regional tax rates for manual selection based on provided address information; performing payment processing with the online credit card processor; recording payments into an online accounting software. The handling of failed transactions includes performing functions such as: capturing failed transactions; notifying users of failed transactions through alert banners; and allowing users to reprocess failed transactions. The method includes performing functions such as: displaying a banner for unpaid scheduled appointments, after a customizable time threshold, with a clickable hyperlink to access a checkout process for an unpaid appointment; and displaying a checkout reminder notification when creating an appointment for unpaid scheduled appointments.

The method includes functions such as: integrating and managing multiple software components in a unified platform by performing functions such as: connecting a plurality of software components to an integrated communication framework; establishing data synchronization channels between the connected software components; continuously monitoring data exchanges across the connected software components; automatically transferring updated data between relevant software components upon detecting a change in any connected component; verifying data consistency and accuracy across all connected software components; performing automated error checks and corrections on transferred data; and executing automated tasks across multiple software components. The method includes performing functions such as: establishing data synchronization channels between the connected software components by performing functions such as: facilitating transient data communication within the integrated communication framework; managing the flow of temporary data between software components; initiating automated error-checking routines for transient data during synchronization; performing validation of transient data consistency between components; and updating each software component with transient data changes instantaneously upon receipt. The continuously monitoring data exchanges across the connected software components includes performing functions such as: tracking the flow of transient data to identify inconsistencies or errors; logging data transactions between components for audit and verification purposes; detecting changes in data states and triggering automated responses; alerting users or system administrators to potential synchronization issues; and verifying the successful transmission of data packets between components.

### Sales Processing System

In another aspect, a method for managing sales transactions includes items such as: creating line items for services or products; establishing a connection with an online accounting software, a sales tax calculation software, and an online credit card processor; extracting one or more keyword phrases in a file and generating a sales receipt by replacing data in lieu of the keyword phrases in the file; enabling and disabling the recording of transactions into an accounting software for individual payment methods; and synchronizing sales and accounting data to a plurality of online software systems.

Implementations of the method of managing sales transactions includes items such as: collecting initial data from a database to pre-fill necessary information for a sales checkout process. The creating line items for services or products includes items such as: selecting specific line items for inclusion in the transaction; specifying a sale amount, keyword phrases and associated data for each line item; and allowing users to dynamically create new products and service items directly from the checkout process, synchronizing this data with other online software programs without refreshing the webpage. The method includes items such as: allowing users to adjust the accounting software receipt date; allowing users to adjust the end of warranty date; and associating a fixed or dynamic fee based on items such as: individual transaction amount, purchases, totality of processed transactions, and predefined parameters. The establishing connections includes automatically integrate and calculate state and county sales tax rates using data from a sales tax provider; automatically geolocate address location and apply sales tax rates for addresses without an automatically assigned tax rate; provide a list of regional tax rates for manual selection based on provided address information; performing payment processing with the online credit card processor; automatically recording payments into an online account software made via cash, check; and processing credit card or digital payments through a secure form provided by a payment processor. The method includes items such as: ensuring proper data formatting and handling for integration with the online accounting software. The handling of failed transactions includes items such as: capturing failed transactions automatically; notifying users of failed transactions through alert banners; and allowing users to reprocess failed transactions. The method includes items such as: the ability to chargeback and add the user's customer to a customer behavior list and include notes. The method includes items such as: providing a wrong data correction consisting of moving the transactional data to the correct area, automatically updating all relevant systems without needing to delete and recreate a receipt. The method includes items such as: providing incorrect transaction reversal consisting of reversing the transaction and deleting all associated data.

The method includes items such as: managing marketing lead sources for a user in a service business software system by performing functions such as: collecting marketing performance data from a plurality of users; segmenting the plurality users into one or more predetermined user groups; matching the user into one of the predetermined groups or subgroups; retrieving and rendering marketing data from the matched predetermined group; an opt-in or opt-out of data sharing for marketing details; allowing end users to select and deselect the alerts they receive; provides an interface for users to search or enter data or select a marketing campaign type; allows users to expand search criteria to include non-industry-specific results; ability to filter items such as: industry or location. The method includes performing functions such as: ability to sort and organize search results by a plurality of metrics; capturing individual marketing campaign data within a multi-tenant software system from a plurality of users; tracking marketing expenses associated with each lead source; calculates gross sales and net profit for each marketing campaign; updates ROI as transactions are processed; calculating customer lifetime value for customers acquired through each lead source including factors such as total transactions, total revenue over time, and/or service integration costs; and determining the ratio of customer lifetime value to marketing expenses.

The method includes scheduling an appointment by performing functions such as: receiving data entered into the form for a prospect as part of an order or scheduling an appointment; determine if the data entered into the form matches a multi-factor inexact search of data within a database for globally lists such as a customer behavior or cancellation list; if a match is found with multiple points of data in either list, display a message to the end user entering the data; receiving data entry for a street address; retrieving a GPS coordinate for the street address; and dynamically determining distance and travel time from a predetermined office location to the street address. The method includes performing functions such as: dynamically verifying data; reading shared comments from the customer behavior list entered by other end users; providing an alert if the matching data exceeds the threshold number of allowed appointment cancellations; and scheduling the appointment and overriding the message. The method includes performing functions such as: allowing end users to select from a variety of online calendar applications; data connection to an online calendar system; sending application programming interface (API) requests to the selected online calendar; tracking time entries within the scheduled appointment; matching data entries against a calendar system for conflicting scheduled appointments; provides alerts if the selected time conflicts with the service providers existing scheduled and personal appointments; providing suggested available times based on the calendar data; and allowing the end user to override the message to double book appointments. The method includes performing functions such as: receiving data entered into the form for a prospect as part of an order or scheduling an appointment with data entry for service or equipment make, model and/or type and storing a plurality of service or equipment details in a database; ability to globally share the data entry for service or equipment make, model and/or type entered within the software or restrict it for private use; and enabling configuration of appointment reminder settings for end users and/or service providers. The method includes performing functions such as: allowing end users to modify the cancellation threshold settings; and enabling association of the scheduled appointment with a service contract. The method provides functions such as: an error verification and handling component for verifying potential errors and inaccuracies from information received from several sources and subsystems; sending alerts with error messages back to the end user or the respective source; determining if it is necessary to update the database; and if there are no errors detected, sending authorized verification back to the end user or respective source.

The scheduling multiple payments for an invoice with an amount includes providing one of two payment options: 1) full payment, and 2) a selected payment term; if the invoice recipient does not pay in full or select a payment term within a predetermined time, automatically configure and schedule one or more recurring payments over a period of time; automatically selecting a predetermined periodic payment for which the customer qualifies based on periodic payment parameters configured by the end user; and periodically processing a payment in satisfaction of the invoice. The providing one of two payment options: 1) full payment, and 2) a selected payment term includes items such as: an end user interface for configuring invoice settings, email notifications, managing payment terms, managing invoices, minimum down payments, interest rates and/or late fees; allowing user configurable minimal recurring payment amount; ability for end users to upload their own custom templates or use provided templates; and allowing end users to disable multi-payment invoicing and/or the automatic payment scheduling feature for all invoices. The selecting a predetermined periodic payment for which the customer qualifies based on periodic payment parameters configured by the end user includes items such as: determining if an invoice recipient qualifies for multi-payment terms based on configured minimum recurring payment parameters and credit card expiration date; calculating amounts due for each payment in the payment schedule; automatically create a payment plan if the invoice recipient does not create a multi-payment schedule by the predetermined date; automatically schedules recurring payments of the lowest payment with the highest interest rate for the longest term length for which the invoice recipient qualifies; generating a multi-payment schedule including the interest charges; and sending a notification to an invoice recipient if the automatic payment scheduler is invoked.

The method includes managing online customer reviews by performing functions such as: associating keyword phrases with the product or service, wherein the keyword phrases are stored in an indexed table; generating reviews based on the keyword phrases; requesting a customer review of a product or a service; predetermining a customer review rating; if the rating is less than a specified threshold, send customer to a feedback webpage; if the rating meets or is greater than a specified threshold, send customer to a website review instructional guide; if the customer feedback is below a predetermined rating threshold, automatically placing customer information in banned review list; and managing a list of banned review customers.

The method includes functions such as: integrating and managing multiple software components in a unified platform by performing functions such as: connecting a plurality of software components to an integrated communication framework; establishing data synchronization channels between the connected software components; continuously monitoring data exchanges across the connected software components; automatically transferring updated data between relevant software components upon detecting a change in any connected component; verifying data consistency and accuracy across all connected software components; performing automated error checks and corrections on transferred data; and executing automated tasks across multiple software components. The method includes performing functions such as: establishing data synchronization channels between the connected software components by performing functions such as: facilitating transient data communication within the integrated communication framework; managing the flow of temporary data between software components; initiating automated error-checking routines for transient data during synchronization; performing validation of transient data consistency between components; and updating each software component with transient data changes instantaneously upon receipt. The continuously monitoring data exchanges across the connected software components includes performing functions such as: tracking the flow of transient data to identify inconsistencies or errors; logging data transactions between components for audit and verification purposes; detecting changes in data states and triggering automated responses; alerting users or system administrators to potential synchronization issues; and verifying the successful transmission of data packets between components.

### Online Accounting Automatic Deposit Creator

In another aspect, a method for accounting for a payment associated with a transaction includes processing the payment via a first vendor, wherein the first vendor takes a deduction from an amount sent to a second vendor; identifying the amount sent to the second vendor and aggregating the deposit and the deduction to create a net payment; indicating the net payment as a deposit receipt in an online accounting software; and automatic description note entries relating to the deposit.

Implementations of the above may include one or more of the following. The method includes processing the payment via a first vendor, wherein the first vendor takes a deduction from an amount sent to a second vendor, wherein the first vendor includes an online payment processor and the second vendor includes a financial institution. The identifying the amount sent to the second vendor and aggregating the deposit and the deduction to create a net payment includes identifying deposit information from a payment processor includes one or more of: the quantity of transactions, amount per transaction, unique identifiers involved in the transaction and merchant service fees charged per transaction; and corresponding the deposit information to individual sales receipts and automatically perform calculations to create a matching deposit from the second vendor. The indicating the net payment as a deposit receipt in an online accounting software includes communicating with online accounting software to generate a matching deposit receipt to a modified deposit for the second vendor by automatically deducting the total fees received from the first vendor. The automatic note entries relating to a deposit includes items such as: identifying character limitations within a plurality of online software systems; and facilitating formatted entries in compliance with a plurality of online software systems.

The method includes performing multi-tenant automatic backup billing by performing functions such as: automatic verification of matching data entered into a form against an external database; retrieving a billing exclusion list from an internal database for one or more electronic devices to skip billing; retrieving encoded daily backup usage from an external backup provider database for a plurality of user accounts kept in an internal database for a multi-tenant software environment; and decoding and converting the retrieved backup usage data into a billing-compatible format; and automatically determining usage fees for each user account not included within the exclusion list.

The scheduling multiple payments for an invoice with an amount includes providing one of two payment options: 1) full payment, and 2) a selected payment term; if the invoice recipient does not pay in full or select a payment term within a predetermined time, automatically configure and schedule one or more recurring payments over a period of time; automatically selecting a predetermined periodic payment for which the customer qualifies based on periodic payment parameters configured by the end user; and periodically processing a payment in satisfaction of the invoice. The providing one of two payment options: 1) full payment, and 2) a selected payment term includes items such as: an end user interface for configuring invoice settings, email notifications, managing payment terms, managing invoices, minimum down payments, interest rates and/or late fees; allowing user configurable minimal recurring payment amount; ability for end users to upload their own custom templates or use provided templates; and allowing end users to disable multi-payment invoicing and/or the automatic payment scheduling feature for all invoices. The selecting a predetermined periodic payment for which the customer qualifies based on periodic payment parameters configured by the end user includes items such as: determining if an invoice recipient qualifies for multi-payment terms based on configured minimum recurring payment parameters and credit card expiration date; calculating amounts due for each payment in the payment schedule; automatically create a payment plan if the invoice recipient does not create a multi-payment schedule by the predetermined date; automatically schedules recurring payments of the lowest payment with the highest interest rate for the longest term length for which the invoice recipient qualifies; generating a multi-payment schedule including the interest charges; and sending a notification to an invoice recipient if the automatic payment scheduler is invoked.

The method for dynamically managing transaction fees in a financial processing system by performing functions such as: initializing a default base fee percentage for transactions; processing a plurality of transactions for an end user, wherein each transaction includes applying the current fee percentage to the transaction amount; accumulating fee revenue from the processed transactions over a predetermined time period; calculating total business service costs for the end user over the predetermined time period; comparing the accumulated fee revenue to the total business service costs; adjusting the fee percentage for a subsequent time period based on the comparison, wherein the adjustment is constrained by a predefined ceiling and floor percentage; locking the adjusted fee percentage for the subsequent time period; and applying the locked fee percentage to transactions in the subsequent time period.

The method includes managing sales transactions by performing functions such as: creating line items for services or products; establishing a connection with an online accounting software, a sales tax calculation software, and an online payment processor; extracting one or more keyword phrases in a file and generating a sales receipt by replacing data in lieu of the keyword phrases in a file; enabling and disabling the recording of transactions into an accounting software for individual payment methods; handling failed transactions; synchronizing sales and accounting data to a plurality of online software systems; selecting specific line items for inclusion in a transaction; collecting initial data from a database to pre-fill necessary information for a sales checkout process; and associating a fixed or dynamic fee based on items such as: individual transaction amount, purchases, totality of processed transactions, and predefined parameters. The method includes establishing a connection with an online accounting software, a sales tax calculation software, and an online payment processor to integrate and calculate state and county sales tax rates using data from a sales tax provider; geolocate address location and apply sales tax rates for addresses without an automatically assigned tax rate; provide a list of regional tax rates for manual selection based on provided address information; performing payment processing with the online credit card processor; recording payments into an online accounting software. The handling of failed transactions includes performing functions such as: capturing failed transactions; notifying users of failed transactions through alert banners; and allowing users to reprocess failed transactions. The method includes performing functions such as: displaying a banner for unpaid scheduled appointments, after a customizable time threshold, with a clickable hyperlink to access a checkout process for an unpaid appointment; and displaying a checkout reminder notification when creating an appointment for unpaid scheduled appointments.

The method includes functions such as: integrating and managing multiple software components in a unified platform by performing functions such as: connecting a plurality of software components to an integrated communication framework; establishing data synchronization channels between the connected software components; continuously monitoring data exchanges across the connected software components; automatically transferring updated data between relevant software components upon detecting a change in any connected component; verifying data consistency and accuracy across all connected software components; performing automated error checks and corrections on transferred data; and executing automated tasks across multiple software components. The method includes performing functions such as: establishing data synchronization channels between the connected software components by performing functions such as: facilitating transient data communication within the integrated communication framework; managing the flow of temporary data between software components; initiating automated error-checking routines for transient data during synchronization; performing validation of transient data consistency between components; and updating each software component with transient data changes instantaneously upon receipt. The continuously monitoring data exchanges across the connected software components includes performing functions such as: tracking the flow of transient data to identify inconsistencies or errors; logging data transactions between components for audit and verification purposes; detecting changes in data states and triggering automated responses; alerting users or system administrators to potential synchronization issues; and verifying the successful transmission of data packets between components.

### Smart Fees

In a further aspect, a method for dynamically managing transaction fees in a financial processing system includes items such as: initializing a default base fee percentage for transactions; processing a plurality of transactions for an end user, wherein each transaction includes applying the current fee percentage to the transaction amount; accumulating fee revenue from the processed transactions over a predetermined time period; calculating total business service costs for the end user over the predetermined time period; comparing the accumulated fee revenue to the total business service costs; adjusting the fee percentage for a subsequent time period based on the comparison, wherein the adjustment is constrained by a predefined ceiling and floor percentage; locking the adjusted fee percentage for the subsequent time period; and applying the locked fee percentage to transactions in the subsequent time period.

Implementations of the aspect method include items such as: initializing a default base fee percentage for transactions may be a fixed or adjustable dynamic percentage. The processing a plurality of transactions for an end user, wherein each transaction includes applying the current fee percentage to the transaction amount includes items such as: fee applies to all transactions processed through the system; and the user enables or disables the dynamic management of transaction fees for their customers. The accumulating fee revenue from the processed transactions over a predetermined time period includes items such as: an adjustable time period affecting all users set by software administrators; an adjustable time period for individual users set by software administrators; and an adjustable payment processing day for individual users set by the user. The calculating total business service costs for the end user over the predetermined time period includes items such as: user enables or disables individual access in an array of integrated business services; and calculations based on individual pricing for enabled integrated business services. The comparing the accumulated fee revenue to the total business service costs includes items such as: calculating total fee revenue within a predetermined time period; calculating total service cost of enabled integrated business services within a predetermined time period; and comparing total fee revenue against total service cost and charging the user the difference if total service cost exceeds total fee revenue.

The method includes performing multi-tenant automatic backup billing by performing functions such as: automatic verification of matching data entered into a form against an external database; retrieving a billing exclusion list from an internal database for one or more electronic devices to skip billing; retrieving encoded daily backup usage from an external backup provider database for a plurality of user accounts kept in an internal database for a multi-tenant software environment; and decoding and converting the retrieved backup usage data into a billing-compatible format; and automatically determining usage fees for each user account not included within the exclusion list.

The scheduling multiple payments for an invoice with an amount includes providing one of two payment options: 1) full payment, and 2) a selected payment term; if the invoice recipient does not pay in full or select a payment term within a predetermined time, automatically configure and schedule one or more recurring payments over a period of time; automatically selecting a predetermined periodic payment for which the customer qualifies based on periodic payment parameters configured by the end user; and periodically processing a payment in satisfaction of the invoice. The providing one of two payment options: 1) full payment, and 2) a selected payment term includes items such as: an end user interface for configuring invoice settings, email notifications, managing payment terms, managing invoices, minimum down payments, interest rates and/or late fees; allowing user configurable minimal recurring payment amount; ability for end users to upload their own custom templates or use provided templates; and allowing end users to disable multi-payment invoicing and/or the automatic payment scheduling feature for all invoices. The selecting a predetermined periodic payment for which the customer qualifies based on periodic payment parameters configured by the end user includes items such as: determining if an invoice recipient qualifies for multi-payment terms based on configured minimum recurring payment parameters and credit card expiration date; calculating amounts due for each payment in the payment schedule; automatically create a payment plan if the invoice recipient does not create a multi-payment schedule by the predetermined date; automatically schedules recurring payments of the lowest payment with the highest interest rate for the longest term length for which the invoice recipient qualifies; generating a multi-payment schedule including the interest charges; and sending a notification to an invoice recipient if the automatic payment scheduler is invoked.

The method includes managing sales transactions by performing functions such as: creating line items for services or products; establishing a connection with an online accounting software, a sales tax calculation software, and an online payment processor; extracting one or more keyword phrases in a file and generating a sales receipt by replacing data in lieu of the keyword phrases in a file; enabling and disabling the recording of transactions into an accounting software for individual payment methods; handling failed transactions; synchronizing sales and accounting data to a plurality of online software systems; selecting specific line items for inclusion in a transaction; collecting initial data from a database to pre-fill necessary information for a sales checkout process; and associating a fixed or dynamic fee based on items such as: individual transaction amount, purchases, totality of processed transactions, and predefined parameters. The method includes establishing a connection with an online accounting software, a sales tax calculation software, and an online payment processor to integrate and calculate state and county sales tax rates using data from a sales tax provider; geolocate address location and apply sales tax rates for addresses without an automatically assigned tax rate; provide a list of regional tax rates for manual selection based on provided address information; performing payment processing with the online credit card processor; recording payments into an online accounting software. The handling of failed transactions includes performing functions such as: capturing failed transactions; notifying users of failed transactions through alert banners; and allowing users to reprocess failed transactions. The method includes performing functions such as: displaying a banner for unpaid scheduled appointments, after a customizable time threshold, with a clickable hyperlink to access a checkout process for an unpaid appointment; and displaying a checkout reminder notification when creating an appointment for unpaid scheduled appointments.

The method for dynamically managing transaction fees in a financial processing system by performing functions such as: initializing a default base fee percentage for transactions; processing a plurality of transactions for an end user, wherein each transaction includes applying the current fee percentage to the transaction amount; accumulating fee revenue from the processed transactions over a predetermined time period; calculating total business service costs for the end user over the predetermined time period; comparing the accumulated fee revenue to the total business service costs; adjusting the fee percentage for a subsequent time period based on the comparison, wherein the adjustment is constrained by a predefined ceiling and floor percentage; locking the adjusted fee percentage for the subsequent time period; and applying the locked fee percentage to transactions in the subsequent time period.

### Multi-Faceted System

In another aspect, a method for integrating and managing multiple software components in a unified platform includes connecting a plurality of software components to an integrated communication framework; establishing data synchronization channels between the connected software components; continuously monitoring data exchanges across the connected software components; verifying data consistency and accuracy across all connected software components; performing automated error checks and corrections on transferred data; and executing automated tasks across multiple software components.

Implementations of integrating and managing multiple software components in a unified platform includes items such as: the establishing data synchronization channels between the connected software components includes items such as: facilitating transient data communication within the integrated communication framework; managing the flow of temporary data between software components; initiating automated error-checking routines for transient data during synchronization; performing validation of transient data consistency between components; and updating each software component with transient data changes upon receipt.

The continuously monitoring data exchanges across the connected software components includes items such as: tracking the flow of transient data to identify inconsistencies or errors; logging data transactions between components for audit and verification purposes; detecting changes in data states and triggering automated responses; alerting users or system administrators to potential synchronization issues; and verifying the successful transmission of data packets between components. Verifying data consistency and accuracy across all connected software components includes items such as: performing automated validation checks on data formats and structures; and generating error reports for any inconsistencies detected during verification. The method includes items such as: performing multi-tenant automatic backup billing by performing functions such as: automatic verification of matching data entered into a form against an external database; retrieving a billing exclusion list from the internal database for one or more electronic devices to skip billing; retrieving encoded daily backup usage from the external backup provider database for a plurality of user accounts kept in an internal database for a multi-tenant software environment; decoding and converting the retrieved backup usage data into a billing-compatible format; and automatically determining usage fees for each user account not in the billing exclusion list. The method includes items such as: performing shared customer behavior management in a multi-tenant software as a service software system includes items such as: receiving data entered into the form for a prospect as part of an order or scheduling an appointment; determining if the data entered exists in a database based on a multi-factor inexact search for the prospect; and if the prospect is in the database, automatically displaying a message to a user entering the data. The method includes items such as: managing marketing lead sources for a user in a service business software system by performing functions such as: collecting marketing performance data from a plurality of users; segmenting the plurality users into one or more predetermined user groups; matching the user into one of the predetermined groups or subgroups; retrieving and rendering marketing data from the matched predetermined group; an opt-in or opt-out of data sharing for marketing details; allowing end users to select and deselect the alerts they receive; provides an interface for users to search or enter data or select a marketing campaign type; allows users to expand search criteria to include non-industry-specific results; ability to filter one or more items such as: industry, location, other predetermined criteria; and ability to sort and organize search results by a plurality of metrics. The method includes items such as: scheduling an appointment by performing functions such as: receiving data entered into the form for a prospect as part of an order or scheduling an appointment; determine if the data entered into the form matches a multi-factor inexact search of data within a database for a globally shared customer behavior list and/or a globally shared cancellation list; and if a match is found with multiple points of data in either list, automatically display a message to the end user entering the data; receiving data entry for a street address; retrieving a GPS coordinate for the street address; and dynamically determining distance and travel time from a predetermined office location to street address. The method includes items such as: scheduling multiple payments for an invoice with an amount by performing functions such as: providing one of two payment options: 1) full payment, and 2) a selected payment term; if the invoice recipient does not pay in full or select a payment term within a predetermined time, automatically configure and schedule one or more recurring payments over a period of time; automatically selecting a predetermined periodic payment for which the customer qualifies based on periodic payment parameters configured by the end user; periodically processing a payment in satisfaction of the invoice; end user interface for configuring invoice settings, email notifications, managing payment terms, managing invoices, minimum down payments, interest rates and/or late fees; allowing entry for the minimal recurring payment amount an end user is willing to accept; ability for end users to upload their own custom templates or use provided templates; allowing end users to disable multi-payment invoicing and/or the automatic payment scheduling feature for all invoices; interface for viewing and editing customer information, receiving or editing invoice data; storing finalized invoice data in the system's database; sending initial emails with one of more items such as: invoice and payment details, payment hyperlink, automatic payment scheduling details; automatic alerts for users if a customer lacks payment information on file with an online payment processor, has a history of unpaid invoices, and/or if there are any discrepancies or missing information in invoices; online guest and private end user system; guest checkout can process payments using credit card and/or digital currency; end user checkout system can process payments using check, cash, credit card and/or digital currency; process one time payment in full through an online payment processor; ability to add or remove credit cards and set a default card for multiple payments; add a down payment when scheduling multi-payment processing; automatically determine a minimum and maximum down payment amount allowed when scheduling multi-payment processing; automatically adjust the payment term length and amount based on down payment entered; select processing recurring payments on specified dates (ie. 1st or 15th of the month); and select payment term length from qualified payment terms to schedule payments. The automatically selecting a predetermined periodic payment for which the customer qualifies based on periodic payment parameters configured by the end user includes items such as: determining if an invoice recipient qualifies for multi-payment terms based on configured minimum recurring payment parameters and credit card expiration date; calculating amounts due for each payment in the payment schedule; automatically create a payment plan if the invoice recipient does not create a multi-payment schedule by the predetermined date; automatically schedules recurring payments of the lowest payment with the highest interest rate for the longest term length for which the invoice recipient qualifies; generating a multi-payment schedule including the interest charges; sending a notification to an invoice recipient if the automatic payment scheduler is invoked; allowing end users to adjust their interest rate settings for payment term schedules; receiving invoice data including a total amount and a payment term; applying different interest rates based on the length of the payment term; automatically calculates interest for each installment, from predetermined values, based on the total amount and the payment term; automatically adjusting interest rates for early payments or late payments; and recalculating the payment schedule when a customer makes an early or partial payment. The method includes items such as: generating content for a plurality of channels on a shared video platform by performing functions such as: for each channel, receiving content from each content provider independently creating content as part of a community for the channel; promoting the community output to get more views than possible with content from each content provider stand-alone on the shared platform; collectively obtaining channel subscribers for each content provider and collectively increasing views for the content; rewarding a content provider for their combined contributions based on a plurality of engagement metrics for each revenue eligible content within the channels; providing a registration interface allowing a user to fill out a content provider application and upload or link to a video to apply to become a content provider; providing a voting interface that allows other content providers to vote on the content provider application; and providing a content provider approval interface for final approval or dismissal of the application, wherein the final content provider application approval or dismissal is decided by a moderator. The method includes items such as: preparing and editing a new file responsive to a document requirement by performing functions such as: receiving a templated file with one or more keyword phrases and templated content; receiving data expressed in one or more file types and extracting text data from the received file types; and dynamically generating custom text by replacing keyword phrases with the extracted text data and placing the custom text within the templated content; recommending changes based on the document requirements; dynamically generating the new file by replacing keyword phrases in a data file with data derived from a form submission on the Internet, data within a database or other data source. The method includes items such as: integrating into the global customer behavior list determining if the data entered exists in a database based on a multi-factor inexact search for the prospect includes items such as: company name, personal name, address, city, state, zip code, email, and telephone number(s). The method includes items such as: billing generation by: defining a matrix specifying price data per contract term, contract length and category; applying one or more payment parameters to index into the matrix to determine a price; displaying a banner for unpaid scheduled appointments, after a customizable time threshold, with a clickable hyperlink to access a checkout process for an unpaid appointment; and disabling a checkout reminder notification when creating an appointment or in an alert system for unpaid scheduled appointments. The method includes annotating customer data by performing functions such as: capturing repetitive data from a repetitive task generated when a computer data form is entered; capturing a custom note for an event; adding the custom note to the repetitive data; summing up all repetitive data and custom notes in sequential order. The method includes items such as: providing a purchase reward system by performing functions such as: assessing purchase reward eligibility for a product purchase; determining an individual reward amount based on the user's total gross sales transactions from their customers processed through a sales system; automatically adjusting the purchase reward over a predetermined period based on accumulated gross sales transactions; providing feedback on a reward status change; assessing product reward eligibility; setting a purchase reward percentage; tracking the total amount spent by each user on qualifying purchases; calculating the purchase reward amount based on the tracked spending and set percentage; associating the calculated purchase reward amount in a customer account; and providing a user interface for customers to view their accumulated purchase rewards. The method includes managing online customer reviews by performing functions such as: associating keyword phrases with the product or service, wherein the keyword phrases are stored in an indexed table; generating reviews based on the keyword phrases; requesting a customer review upon or after the purchase of a product or a service; predetermining a customer review rating; if the rating is less than a specified threshold, send customer to a feedback webpage; if the rating meets or is greater than a specified threshold, send customer to a website review instructional guide; if the customer feedback is below a predetermined rating threshold, automatically placing customer information in banned review list; and managing a list of banned review customers. The method includes managing sales transactions by performing functions such as: creating line items for services or products; establishing a connection with an online accounting software, a sales tax calculation software, and an online payment processor; extracting one or more keyword phrases in a file and generating a sales receipt by replacing data in lieu of the keyword phrases in a file; enabling and disabling the recording of transactions into the accounting software for individual payment methods; handling failed transactions; synchronizing sales and accounting data to a plurality of online software systems; selecting specific line items for inclusion in the transaction; collecting initial data from a database to pre-fill necessary information for a sales checkout process; and associating a fixed or dynamic fee based on items such as: individual transaction amount, purchases, totality of processed transactions, and predefined parameters. The associating a fixed or dynamic fee based on items such as: individual transaction amount, purchases, totality of processed transactions, and predefined parameters, further includes items such as: when the dynamic fee is not configured as a fixed fee, the dynamic fee automatically adjusts in response to changes in the specified factors; applying a minimum and maximum threshold to control the dynamic fee range; periodically reviewing accumulated transaction data to update the dynamic fee for future transactions.

In another aspect, a method for dynamically managing transaction fees in a financial processing system by performing functions such as: initializing a default base fee percentage for transactions; processing a plurality of transactions for an end user, wherein each transaction includes applying the current fee percentage to the transaction amount; accumulating fee revenue from the processed transactions over a predetermined time period; calculating total business service costs for the end user over the predetermined time period; comparing the accumulated fee revenue to the total business service costs; adjusting the fee percentage for a subsequent time period based on the comparison, wherein the adjustment is constrained by a predefined ceiling and floor percentage; locking the adjusted fee percentage for the subsequent time period; and applying the locked fee percentage to transactions in the subsequent time period.

In another aspect, an accounting for a payment associated with a transaction includes items such as: processing the payment via a first vendor, wherein the first vendor takes a deduction from an amount sent to a second vendor; identifying the amount sent to the second vendor and aggregating the deposit and the deduction to create a net payment; indicating the net payment as a deposit receipt in an online accounting software; and automatic note entries relating to the deposit.

In yet another aspect, an integrated software system is disclosed with features to streamline business operations. It includes items such as: a robust appointment scheduling module that allows for easy booking, rescheduling, and cancellation of appointments, with a user-friendly interface for both clients and staff. The system offers items such as: comprehensive calendar management, providing a centralized view of all scheduled appointments, staff availability, and resource allocations. It supports items such as: two-way calendar syncing to prevent double bookings and conflicts. items such as: automated notifications and reminders are sent to reduce no-shows and keep clients informed. The software allows for customizable work hours settings and the ability to offer different services for booking. It includes items such as: team scheduling capabilities to automatically assign appointments based on availability. The system is designed with items such as: ability to handle multiple time zones and a customer database that stores comprehensive client information, enhancing personalized service and supporting targeted marketing efforts. The software also incorporates items such as: payment processing capabilities, allowing for transactions within the scheduling system. Additionally, it offers items such as: mobile compatibility for on-the-go management and customization options to align with business branding. The system emphasizes user experience, ensuring ease of use for both administrators and clients. Features such as: Error verification and handling modules are integrated throughout to maintain data accuracy and system reliability.

Advantages of the system may include items such as: Automating the onboarding process for new customers can significantly improve efficiency and user experience. By implementing automated steps throughout the customer journey, businesses can simplify the entire process, generate automated messages, and launch contextual in-app help. This automation can lead to a more consistent experience, improved customer satisfaction through personalized journeys, and reduced costs due to more efficient business processes. Key areas to focus on include simplifying signup, optimizing welcome pages with automated messages, and helping users get started through interactive walkthroughs, automated video guides, or helpful checklists. Data entry automation involves using software to streamline the data entry process, making it faster and more accurate. This can be particularly beneficial for businesses dealing with document-centric processes. Data entry automation can be applied to various tasks such as accounting, invoicing, customer relationship management, and loyalty programs. The process typically involves capturing data from different file types, converting it into a structured format, and validating the extracted information. By automating data entry, businesses can save time, improve data accuracy, and allocate resources more efficiently. Automated data validation is used for ensuring data quality and accuracy. Automated data validation can significantly reduce the time spent on manual checks, increase overall accuracy, and allow for focus on fixing errors rather than finding them. This approach is particularly valuable for organizations managing complex requirements with multiple interconnected providers and systems. Implementing automated data validation can lead to improved efficiency, increased accuracy, and faster error resolution. Further, the data structure and flow of the system provide computer performance improvements. Function consolidation and integration play a role by providing a centralized dashboard that unifies various business operations into a single interface. This consolidation reduces context switching, lowers memory footprint, and enables more efficient use of CPU cache and Input/Output operations. The implementation of a single data source and unified payment processing streamlines data management and transaction handling. This centralization reduces CPU load, optimizes memory usage, and enhances data access and synchronization efficiency. Cross-browser compatibility ensures efficient operation across different operating systems, optimizing resource allocation and minimizing the need for compatibility layers. An integrated Customer Relationship Management (CRM) system consolidates customer data and interactions, reducing CPU load, lowering memory usage, and streamlining data management. Additional performance improvements include automated task scheduling, efficient error handling and monitoring, and optimized resource utilization. Advanced security measures, automated compliance management, and efficient data encryption contribute to performance. These enhancements collectively result in reduced power consumption, improved network efficiency, and an overall more responsive and efficient computing environment.

### BRIEF DESCRIPTION OF DRAWINGS

FIG. 1 shows an exemplary diagram for appointment scheduling.

FIG. 2 shows an exemplary diagram for customer cancellation.

FIG. 3 shows an exemplary diagram to handle exclusion dates.

FIG. 4 shows an exemplary diagram for personal appointment scheduling.

FIG. 5 shows an exemplary diagram of backup billing.

FIG. 6 shows an exemplary diagram of a contract module.

FIG. 7 shows an exemplary diagram of handling term contracts.

FIG. 8 shows an exemplary flow diagram displaying a customer behavior list module.

FIG. 9 shows an exemplary error verification handling module.

FIG. 10 shows an exemplary diagram for contacts integration.

FIG. 11 shows an exemplary system architecture diagram to handle credit cards.

FIG. 12 shows an exemplary diagram for software controller setting.

FIG. 13 shows an exemplary diagram to generate alert banners.

FIG. 14 shows an exemplary diagram of a marketing module.

FIG. 15 shows an exemplary diagram to manage online reviews.

FIG. 16 shows an exemplary diagram of a system to handle email feedback and unsubscribe requests.

FIG. 17 shows an exemplary diagram for leaving product/service reviews on a website.

FIG. 18 shows an exemplary diagram for an on-line review controller.

FIG. 19 shows an exemplary diagram of the online review controller settings.

FIG. 20 shows an exemplary diagram outlining various modules for invoice creation and editing.

FIG. 21 shows an exemplary diagram showing multi-payment scheduling.

FIG. 22 shows an exemplary diagram illustrating various modules to handle failed transactions.

FIG. 23 shows an exemplary diagram for an automatic payment reminder system.

FIG. 24 shows an exemplary diagram for an automatic multi-payment scheduler.

FIG. 25 shows an exemplary diagram illustrating automatic vendor verification.

FIG. 26 shows an exemplary diagram depicting invoice pricing.

FIG. 27 shows an exemplary diagram of a checkout process.

FIG. 28 shows an exemplary diagram showing predictive income and expense reporting.

FIG. 29 shows an exemplary diagram depicting Online Accounting Integration (OAI) failed refund/sales receipts.

FIG. 30 shows an exemplary diagram illustrating OAI.

FIG. 31 shows an exemplary diagram on a vendor store products and purchasing.

FIG. 32 shows an exemplary diagram on sales tax reporting.

FIG. 33 shows an exemplary diagram of a dynamic fee process.

FIG. 34 shows an exemplary diagram of a purchase reward system.

FIG. 35 shows various exemplary software modules in the SoloBoss system.

FIG. 36 shows an exemplary refund, restocking and return shipping protocol.

FIG. 37 shows an exemplary partial refund protocol with discount

FIG. 38 shows an exemplary flow chart for an online accounting automatic deposit creator.

FIG. 39 shows exemplary flow charts for global system software components.

FIG. 40 shows an exemplary diagram of multi-module interactions.

FIG. 41 shows an exemplary diagram for a profit sharing video platform ideology.

FIG. 42 shows an exemplary diagram for creating marketing urls.

FIG. 43 shows an exemplary content provider contracting process.

FIG. 44 shows an exemplary content provider autosave process.

FIG. 45 shows an exemplary content provider video upload viewer notification process.

FIG. 46 shows an exemplary diagram of creating, renaming and deleting playlists.

FIG. 47 shows an exemplary content provider transcription subtitle subsystem.

FIG. 48 shows an exemplary content provider automatic copyright challenge process.

FIG. 49 shows an exemplary content provider banned word process.

FIG. 50 shows an exemplary process for video content provider upload, editing and deletion requests.

### DETAILED DESCRIPTION OF THE INVENTION

In the following paragraphs, the present invention will be described in detail by way of example with reference to the attached drawings. Throughout this description, the preferred embodiment and examples shown should be considered as examples, rather than as limitations on the present invention. As used herein, the “present invention” refers to any one of the embodiments of the invention described herein, and any equivalents. Furthermore, reference to various feature(s) of the “present invention” throughout this document does not mean that all example embodiments or methods must include the referenced feature(s).

In one aspect, a system is provided that provides the following functions integrated as one software supported by a data structure that improves computer performance and supports the following capabilities: Backup Billing System, Customer Behavior, Marketing Success Sharing System, Appointment Scheduling System, Multi-Payment Invoicing System, Profit Sharing Video Platform, Dynamic Contract Creation, Vendor Store, Global Components and Modules, Online Review Controller System, Sales Processing System, Online Accounting Automatic Deposit Creator, Smart Fees, and Multi-Faceted System. The database structure in the system significantly improves computer performance for the eight functions by leveraging modularity, efficient data management, and parallel processing. For Task Automation, the database structure is divided into distinct modules (e.g., Error Verification and Handling Module, Management Interface, Database Handler), allowing for efficient task automation by isolating and managing specific tasks independently. This design enables parallel processing. The Database Handler ensures quick storage and retrieval of data, reducing the time required for automated tasks.

For Customer Relationship Management (CRM), the CRM Module interacts with the Database Handler to store and retrieve customer data efficiently, enabling quick access to customer information and behavior tracking. The Data Assembly ensures that customer data is updated instantly, improving the accuracy and timeliness of CRM activities.

For Recurring Billing and Invoicing, the use of a dedicated template storage system allows for efficient management and reuse of billing and invoicing templates, reducing the need for repetitive data entry. The Database Handler facilitates integration with billing and accounting software, ensuring accurate and timely invoicing.

The modular database structure allows for easy customization and scaling of the system. New modules can be added or existing ones modified without affecting the overall system performance. Different modules can operate simultaneously, leveraging parallel processing to handle multiple tasks efficiently.

For Automatic Note-taking, the Data Assembly module ensures that notes are updated and stored instantly, improving the efficiency of note-taking. The Error Verification and Handling Module ensures that any issues with note-taking are promptly addressed, maintaining data integrity.

The Error Verification and Handling Module is responsible for managing errors, ensuring that they are handled efficiently without affecting other system functions. The database structure supports detailed logging of user actions and errors, facilitating quick diagnosis and resolution of issues.

For Sales Tax Management, the system's database structure and the Database Handler ensures integration with sales tax software, enabling accurate and timely tax reporting.

For Income and Expense Forecasting, the database structure supports the use of predictive algorithms to analyze historical data and forecast future earnings and expenses. The modular design allows for efficient processing of data, improving the accuracy and speed of forecasting.

The Database Structure improves performance with efficient Data Organization and Access: Clear separation of concerns optimizes data storage, retrieval, and processing. The modular design allows for easy maintenance, updates, and scaling of individual components without affecting the entire system. The architecture facilitates parallel execution of tasks across different modules, leveraging available computing resources more efficiently. The structured approach simplifies system management and enhances maintainability. By organizing the system into distinct modules and interfaces, the database structure of the system ensures efficient data management, quick access to information, and the ability to handle multiple tasks near simultaneously, thereby significantly improving overall computer performance.

### Appointment Scheduling System

The Appointment Scheduling System is a comprehensive solution for scheduling, managing, and tracking appointments. Integrating various features such as appointment types, technician availability, customer data management, automated reminders, and online calendar integrations provides an efficient system for managing customer interactions.

### Data Entry and Tracking

Integrates with a global customer behavior list to prevent scheduling appointments with problematic customers.

Utilizes geocoding to automatically calculate travel fees and estimated travel times based on location data.

Autofills form fields with customer data from the database to streamline the scheduling process.

### Service Provider Availability and Management

Automatically checks availability, alerts of double bookings, and allows overrides for scheduling conflicts.

Enables dynamic addition for service equipment details for each appointment to ensure accurate tracking and management of required tools and resources.

Provides exclusion dates for holidays or other days when a business may be closed, ensuring accurate availability management.

### Calendar Integration and Reminders

Integrates with internal and online calendars such as Google, Microsoft Exchange or iCloud for scheduling.

Can send multiple appointment reminders to parties such as the user, service provider and the customer.

Automatically enters calendar events with preset reminders to ensure timely notifications for upcoming appointments.

### Document and Contact Management

Convert edited document and spreadsheet templates into various file formats such as PDF.

Enables automated management of contacts, including addition, setup, editing, and deletion, with distinctions between personal and professional contacts through custom names and designators.

Enables automated note entries for customer relationship management (CRM) integration, automatically adding notes to the CRM.

### Error Handling

Includes error verification and handling, displaying user-friendly error messages and tracking user interactions to assist in troubleshooting and support.

Utilizes data assembly to dynamically generate additional input fields without refreshing the webpage.

### Global and Local Integration

Integrates with a global customer behavior list and a global canceled appointment list, allowing users to make informed decisions about potential customers.

Offers a cancellation module that tracks repetitive appointment cancellations, providing alerts based on configurable thresholds.

Supports integration with multiple calendar and contact management solutions, offering flexibility and ease of use for various user preferences.

The Appointment Scheduling System includes a Customer Behavior Module that prevents the end user's business from scheduling an appointment or creating contracts for any customer for which they added to the customer behavior list. When adding a customer to the customer behavior list, a comment is required and there is an option to make that comment globally available to other businesses. The user adding that customer to the customer behavior list must select yes to make their comments globally available and agree to share their comments and they understand their business may become identifiable when they share that comment. The user may elect to set the default sharing option to yes. When a customer is added to the customer behavior list, if another user attempts to schedule an appointment or create a contract for that same customer, they receive an alert that another business has added that customer to the customer behavior list. The alert lists a count of how many businesses have added that customer to the customer behavior list. If businesses that added that customer to the customer behavior list elected to make their comments globally available then the user will be able to see other user's comments. The alert is not an automatic block, but asks the question to the business whether they want to continue.

The Appointment Scheduling System includes a Canceled Appointment module. The canceled appointments list is a global design. This works similar to the customer behavior list but it's on a threshold of appointment cancellations. The canceled appointments list is not intended to notify all end user's or other businesses using the software if a customer cancels one appointment. Each end user can modify their own settings as to when they want to receive alerts when a customer cancels scheduled appointments repetitively. Accumulatively, the global functionality automatically reviews canceled appointments for all users of the software. Settings within the global administrator settings, not accessible to the end user, dictate how many canceled appointments the customers must have from all businesses together before businesses will start seeing an alert message specifically about that customer. End users can disable the alert message about canceled appointments for each individual customer or choose to not receive any alert messages at all related to canceled appointments. Disabling alert messages will only disable for that end user without affecting other users.

The Appointment Scheduling System includes Contacts Integration which adds the end user's form entries directly into their selected contact list. The contacts integration works directly with a plurality of external contact lists. The contacts may be preceded with a title, for example, “Client”, to distinguish them away from the end user's personal contacts, unless a custom name is assigned. The software allows for a custom name to be assigned to all contacts added through the system. Assigning a custom name allows the software to distinguish between a personal contact and a business contact when using the same device. By default, both non-custom named and custom named contacts go to the same location. For example, the end user can elect to send custom named contacts to their personal Google, iCloud or Microsoft Exchange contact list and all non-custom named contacts would go to their business Google, iCloud, Microsoft Exchange or provided PBX contact list.

FIG. 1 depicts an exemplary integrated software system with appointment scheduling capability. At the core is a Database Handler [062], which interacts with multiple modules, including User Input [098], Error Verification and Handling Module [072], and Contacts Integration System [010], among others. Various functionalities are managed through interconnected modules such as the Management Interface [078], CRM Module [012], Availability Module [002], Calendar and Reminder Subsystem [006], and Marketing Module [104]. The system also supports specialized functions like the Template Edit Process [092], PDF Conversion Module [086], and Editing Module [080]. Additional components include the Timer System [096], Alert System [102], Customer Behavior Module [046], and Geolocation Module [016]. The overarching framework integrates Data Assembly [174] and multiple operational subsystems to enhance efficiency and adaptability in business operations.

In FIG. 1, the User Input [098] captures user data for scheduling personal appointments. It directly feeds data into the system, reducing latency. The Management Interface [078] streamlines user interactions and reduces the complexity of managing appointments, leading to faster response times. The Error Verification and Handling Module [072] ensures data accuracy and reduces the need for manual error correction, improving overall system reliability and performance. The Calendar and Reminder Subsystem [006] automates the scheduling and reminder process, reducing the need for manual tracking and improving user adherence to schedules. The Database Handler [062] centralizes data storage and retrieval for all modules, and optimizes data access and reduces redundancy, ensuring quick and efficient data retrieval across the system. The Availability Module [002] ensures that appointments are scheduled only when slots are available, reducing conflicts and improving scheduling efficiency. The Contacts Integration System [010] streamlines the process of adding and managing contacts, reducing the need for manual data entry and improving data consistency.

The Database Handler [062] serves as the core interface between the software application and its underlying database infrastructure. It is designed to facilitate communication with one or more databases that store the necessary data for efficient resource management and appointment scheduling. The Database Handler [062] handles Data Management: Handling the creation of new records, such as user profiles, appointments, contacts, invoices, and payment details. It ensures that data entries are correctly formatted and stored within the appropriate tables or collections in the database. It performs complex queries to retrieve data based on specific criteria, which could include filtering appointments by date range, searching for customer information, or generating reports on resource utilization. It also manages database transactions to ensure that operations such as booking an appointment or processing a payment are completed automatically and reliably, maintaining data consistency even in the event of system failures.

The Database Handler [062] coordinates various modules improving overall computer performance. The database handler interacts with multiple modules to enhance system efficiency. The Error Verification and Handling Module [072] verifies data integrity and handles errors during the scheduling process, with the database handler logging errors and retrieving relevant data for resolution, ensuring data accuracy and reducing the need for manual corrections. The Calendar and Reminder Subsystem [006] manages calendar entries and sends reminders, with the database handler storing and retrieving calendar data for notifications, automating the scheduling and reminder process. The Availability Module [002] checks and manages availability for scheduling appointments, with the database handler storing availability data and retrieving it to check for conflicts, ensuring efficient scheduling.

The Contacts Integration System [010] integrates contact information into the scheduling system, with the Database Handler [062] managing contact data to ensure it is up-to-date and accessible, streamlining the process of adding and managing contacts. Additional modules include the CRM Module [012], which manages customer relationship data, and the Marketing Module [104], which handles marketing activities related to appointments. The Template Edit Process [092] allows editing of appointment templates, and the PDF Conversion Module [086] converts appointment details into PDF format, both supported by the database handler for efficient data management.

The Editing Module [080] provides tools for editing content, and the Timer System [096] manages timing-related tasks, both relying on the Database Handler [062] for data storage and retrieval. The Alert System [102] issues alerts for various conditions, and the Customer Behavior Module [046] manages the customer behavior list, with the database handler ensuring data integrity and security. The Geolocation Module [016] manages location-based data for appointments, and the Data Assembly [174] processes data, both supported by the database handler for quick access to up-to-date information.

Overall, the Database Handler [062] optimizes data storage and retrieval, reduces latency, and ensures quick access to information, enabling parallel processing and improving system reliability. The modular design allows for easy maintenance, updates, and scaling enhancing computer performance in the system. The database handler is the communication central gateway between the database and all other system modules. The database handler sends data to the Error Verification and Handling Module to ensure that the data is not only properly formatted, but also legitimate. Once it receives confirmation of legitimacy, it sends the request to the database and if necessary sends a response back to the respective module.

### Availability Module

The availability module automatically determines if an individual(s) being assigned to service work is available for that job at the desired time. An alert message will appear if the end user attempts to assign someone, including themselves that is already booked, has personal appointments, is on vacation or is otherwise not available at the time being assigned. It allows the user to override the message to double book appointments.

### Customer Behavior Module

The Customer Behavior Module [046] is globally designed to prevent users of the software doing business with less than reputable customers. This is a unique design because it allows for a global connection between all users of the software. This is an alert to other users about customers for which they may not want to do business before they confirm the appointment. When a user of the software types in someone's information that matches information inside the global list, they will be met with an alert that this person has been put on the customer behavior list displaying information such as the number of companies and they will be asked if they want to continue.

For Example

JD Enterprise LLC

John Doe

123 Main St.

Sarasota FL

34236

jon.doe293049302@gmail.com

Home: (941) 456-4567

Mobile: (941) 123-1234

John is put on the customer behavior list by company A with the globally shared reason of non-payment for service. Company B has also put John on the customer behavior list for reason of non-payment for service.

John contacts company C. Company C enters John's information into the form. An inexact multi-factor search is performed against the internal database.

Multiple points are matched against the customer behavior list.

Company C is presented with a modal window or message asking for confirmation to proceed with the data entry or stop entering data.

### Calendar and Reminder Subsystem

The Calendar and Reminder Subsystem [006] is not just another internal calendar system, but is unique in that it will allow not only an integrated calendar in the software but can also integrate into a user's current calendar system. Google calendar, for example, can be chosen for the user's data to be selected. The calendar and reminder system is utilized to keep track of all service appointments. It's designed to automatically put a window for arrival time or appointment time based on the user's input. The system automatically alerts the user when they attempt to schedule an added technician for a time that's already scheduled, whether it be a personal appointment, they are on leave or otherwise unavailable. The system automatically separates technicians' times so there isn't a conflict with scheduling two technicians at the same time. There's a dual reminder system that sends out emails and text messages reminding the user and the technician of the upcoming appointment. The time frames which these reminders go out prior to the upcoming appointments can be configured by the end user but have default settings built in.

### Personal Appointments

a. Creating personal appointments allows for the user to input personal appointments.
b. Personal appointments are different from exclusion dates and are designed for short spans of time. A doctor's visit or an extended luncheon are examples of personal appointments.
c. The personal appointments are added through the software and automatically added to the selected end users calendar. If an appointment is attempted to be made while there is already a personal appointment there, an alert message will appear stating there is already an appointment in that time slot.

### Exclusion Dates

a. Creating exclusion dates allows for the end user to easily input time off, holidays and other repetitive days the business may be closed, for themselves and any technicians that work for them.

FIG. 3 handles exclusion dates as part of a Time Slot Management. The module provides an interface to define, edit, and delete available time slots. It considers business hours, public holidays, and other non-working periods to prevent scheduling during these times. FIG. 3 provides an availability module [002] which functions as the central hub for managing and coordinating available time slots, resource allocation, and appointment setting across an organization. This hub improves computer performance by integrating with other modules such as the management interface [078] and the availability module [002], which helps in assigning resources such as personnel to specific time slots based on their availability. As appointments are made or canceled via the cancellation module [008], the availability module [002] dynamically updates the available slots to reflect the changes. Working closely with the calendar and reminder subsystem [006], it ensures that all scheduled appointments are accurately reflected in the relevant calendars, and appropriate reminders are set up. Customization features allow users to set preferences for appointment lengths, buffer times between appointments, and preferred times for breaks or specific types of work.

Exclusion dates are unique to the scheduling platform within the software and are different from personal dates. Exclusion dates are designed for extended periods of absence from the business and can include more than one consecutive day for automatically including time off for the technicians or end user, repetitive holidays where the business is closed, and typical working days where the business may be closed into the integrated calendar. [CANCELED APPOINTMENTS]

The system determines if an end user's potential customer is the same individual or business that another end user of the software has placed on the canceled appointment list, we provide a global alert message system to all end users of the software based on a threshold of appointment cancellations set within the global administrator settings. These settings are not configurable by the end user but only by the software administrator. For example, the system will not put up an alert about a customer that has only canceled one appointment. The settings may be set so that the customer has to cancel more than 10 appointments accumulated by three different users of the software before end users will start seeing an alert message on the customer. The end user can modify the cancellation settings for how many canceled appointments it takes for a customer before they start receiving alert messages about scheduling appointments for a customer. The end user can choose to not show alert messages about that customer after the first message appears. This system allows the end user to make an informed decision before making the mistake of accepting a customer that consistently cancels appointments.

Even if the individual or business has changed address information or the customer has the same name as another customer, the system will determine if it's the same potential customer.

By tracking which clients consistently cancel and posting an alert message prior to scheduling it allows the end user to make an educated decision on whether to assign that time slot for the technician, implement a cancellation fee policy or refuse service to the potential customer.

### Contacts Integration System

The contacts integration system allows the user to automatically add their customers information to their phone or a PBX system. If the user chooses to use their mobile phone instead of a PBX system, the business contacts will be separated from their personal contacts by preceding the name with a user provided designator before the contact name. A default designator will be provided. For example, when the user adds a customer's information to the software, the system will automatically add it to their phone as Client John Doe. The contacts integration system allows for a custom name when the end user wants to add a personal contact into the software. For example, when using a custom name, the end user enters the person's information into the software and enters the custom name as Mom and the software will add this entry into their contacts as a personal contact instead of a business contact.

### CRM Module

The customer relationship management, CRM Module [012], controls the interaction between the end user's customer data, the user interface and the database. This is the first layer of security to ensure the connection requests to the database are accurate and have not been compromised.

### Geolocation Module

The geolocation module is designed for the software end users to figure out onsite fees and mileage to a client's location from the main office. The data returned is used to compare it against a list of user entered onsite fees based on mileage or time away from the office address entered into the software. The result of which is automatically calculated into the overall charge for the user's client on an individual basis.

### Maintenance Entries

This section allows the end user to distribute their time and assign days for maintenance services to their clients. This will be automatically assigned when the contract is created based on the entries within this section. This will automatically assign relative information to the calendar.

### Technicians

The technician section allows for adding and assigning additional people for the end user's clientele. For example, if the end user hires a contractor to take care of one of their clients, they can enter the information here in this section and it will dynamically appear in the create appointment section so they may assign that technician to that service job.

The Database Handler [062] plays a crucial role in coordinating various modules and significantly improving overall computer performance. The architecture depicted in FIG. 1, which focuses on scheduled appointments, demonstrates how the database handler interacts with multiple modules to enhance system efficiency. The key modules include User Input [098], which captures user data for scheduling appointments and feeds it directly into the system, reducing latency. The Management Interface [078] provides a user-friendly interface for managing appointments, supported by the database handler for quick access to appointment data and user settings, streamlining user interactions and reducing complexity. The Error Verification and Handling Module [072] verifies data integrity and handles errors during the scheduling process, with the database handler logging errors and retrieving relevant data for resolution, ensuring data accuracy and reducing the need for manual corrections. The Calendar and Reminder Subsystem [006] manages calendar entries and sends reminders, with the database handler storing and retrieving calendar data for notifications, automating the scheduling and reminder process. The Availability Module [002] checks and manages availability for scheduling appointments, with the database handler storing availability data and retrieving it to check for conflicts, ensuring efficient scheduling. The Contacts Integration System [010] integrates contact information into the scheduling system, with the database handler managing contact data to ensure it is up-to-date and accessible, streamlining the process of adding and managing contacts. Additional modules include the CRM Module [012], which manages customer relationship data, and the Marketing Module [104], which handles marketing activities related to appointments. The Template Edit Process [092] allows editing of appointment templates, and the PDF Conversion Module [086] converts appointment details into PDF format, both supported by the database handler for efficient data management. The Editing Module provides tools for editing content, and the Timer System [096] manages timing-related tasks, both relying on the database handler for data storage and retrieval. The Alert System [102] issues alerts and the Customer Behavior Module [046] manages the customer behavior list, with the database handler ensuring data integrity and security. The Geolocation Module [016] manages location-based data for appointments, and the Data Assembly [174] processes data, both supported by the database handler for quick access to up-to-date information. Overall, the database handler optimizes data storage and retrieval, reduces latency, and ensures quick access to information, enabling parallel processing and improving system reliability. The modular design allows for easy maintenance, updates, and scaling enhancing computer performance in the system.

These features collectively make the Appointment Scheduling System a novel and comprehensive solution for managing customer appointments, ensuring better resource allocation, and enhancing overall operational efficiency. The appointment scheduling system incorporates a novel combination of optimizations that work synergistically to enhance efficiency and performance. By employing asynchronous processing, software can ensure non-blocking operations and improved responsiveness during peak times. In-memory caching tailored for frequently accessed data such as appointment slots and user details, can drastically reduce the load on the database and accelerate data retrieval times. Advanced data synchronization mechanisms can use transaction logs and incremental updates to maintain consistency across multiple systems with minimal data transfer. This combination of targeted caching and efficient synchronization techniques can result in a scheduling system that is not only highly responsive but also remarkably efficient in data handling, offering a significant improvement over conventional methods.

### Backup Billing System

This automates the billing from the user to the user's customers on a multi-tenant backup billing service. The automated backup billing system introduces a novel method for automating the billing process for data backup services. This system is characterized by several capabilities:

### Automated Data Retrieval and Processing

Retrieves daily backup usage data from an external data storage device.

Decodes any encoded retrieved data into a billing-compatible format.

### Comprehensive Account Verification

Verifies backup accounts by comparing data from the data backup service against local records.

Identifies and excludes accounts from billing services.

### Dynamic Billing Calculation

Calculates billing amounts based on retrieved usage data.

Applies filters to exclude specific customer accounts from billing.

Converts usage data to billing data.

### Automated Payment Processing

Sends calculated billing charges to the payment processing module for transaction handling.

Automatically generates and sends receipts.

Records all sales transactions in a centralized database for easy access and reporting.

Provide alerts and notifications for backup account verification and payment processing issues.

Using a caching system and automatic queries at specified times, results are stored for an extended predetermined time to lessen the queries to the external data storage device. This ensures faster data retrieval by querying locally instead of making several individual external data storage device calls every time data is required.

The Backup Billing System includes a Backup Billing function with a plurality of backup billing modules including:

Account Verification System: A communication module between data backup service company servers and the system verifies there is a backup account on the data backup service company servers that doesn't have a backup billing account associated with it. If there is an account within the data backup service company system that does not have an automatic billing account associated with it within the software, the system alerts the end user about it. When the end user is configuring the automatic backup billing, this system displays a list of computers to the end user that do not have an automatic backup billing account associated with the data backup service company's backup account.

Automatic Aggregate Data Updater: This module works with the Timer System module, retrieves data from the data backup service company API and works directly with the Account Verification System and the Data Conversion System. The usage data received from the data backup service company servers is encoded in a non-usable format for billing purposes. This data must be decoded and converted to a usable numbered format for billing purposes. The account data needs to be verified against a list of active and excluded backup billing accounts. The Automatic Aggregate Data Updater retrieves the data from the data backup service company servers, separates the data and sends the data to the proper system for the conversion and verification process.

Data Conversion System: The data conversion system is essential due to the encoded, non-usable format of data received from the data backup service company API. Specifically, data usage numbers are not provided in a byte format suitable for billing conversion. The data backup service company bills customers based on cumulative daily data usage in megabytes, which makes this conversion process a critical component of the backup billing automation. The system transforms the encoded information into a decoded billing-compatible format.

Filter System: The filter system is a distinctive and crucial component. This system is in charge of comparing a list of current customers who already have a backup solution and are actively being charged in the billing system with those on the exclusion list who are not to be charged through the billing system. The filter system relies on special permissions to access the computers within the data backup service company servers, making it indispensable for accurate billing. Without this system, a billing exclusion list would not be possible.

Listing Module: The listing module processes the filtered data to generate a dynamic HTML table and sends it to the Management Interface for display to the end user.

The Communication and Verification Subsystem: This subsystem is in charge of ensuring consistent communication with the data backup service company API by refreshing the token at given intervals required by the data backup service company. Without this system, the data backup service company API would always appear to be unavailable.

Exclusion Controller: The exclusion controller is to exclude specific customer accounts from being automatically charged by the system. The controller works directly with the Filter System and the database to identify and exclude these accounts. This controller removes the excluded accounts from the list before passing it to the Communication and Verification Subsystem. Excluding certain accounts is essential to prevent automatic charges to specific backup clients while ensuring accurate billing calculations for the business owner. These excluded accounts are not charged, but the data stored is still included in the overall billing calculations for the business owner.

User Management Subsystem: The user management subsystem is the direct link between the communication of the end user and the backup billing system. While the end user is filling out the form, this subsystem dynamically processes input from end users, matching it against the local database. Post submission, the system verifies and sorts the data submitted and then stores the backup and customer information in the local database. This information is then transmitted to the Calculation Algorithm Process for further processing.

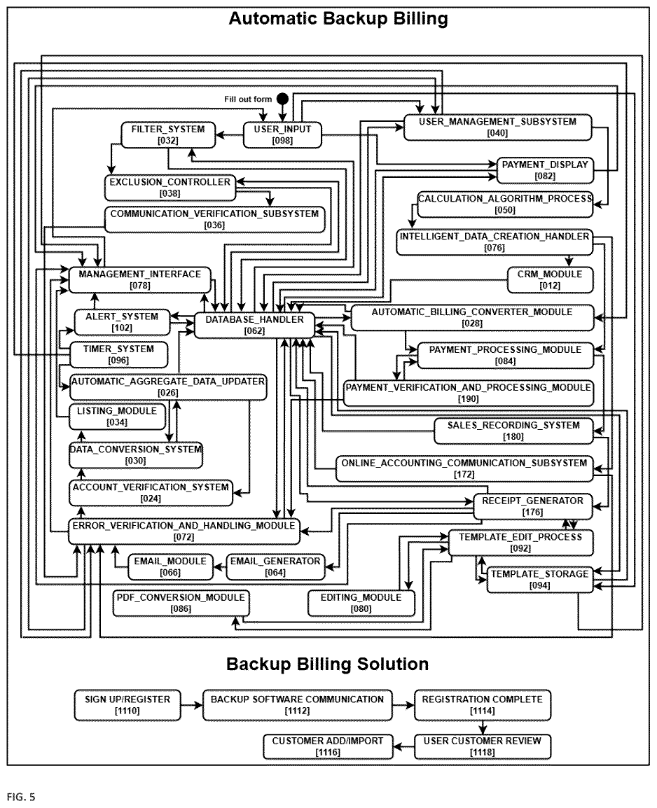

FIG. 5 outlines the components and modules of the integrated software system with automatic backup billing. Elements include the user input and management systems, database handling and processing systems, notification mechanisms, external communications, and error handling modules. Specific functionalities such as payment processing, CRM, template storage and editing, and automatic billing are depicted, highlighting the system's capabilities in project management, task tracking, document management, and comprehensive appointment scheduling. The Database Handler [062] coordinates data processing to maximize computer performance The architecture depicted in FIG. 5, demonstrates the complexity of how the system interacts with multiple modules to enhance system efficiency.

An explanation for the BACKUP BILLING SYSTEM is next:

### Prerequisites

Create a user account in a data backup service company.

Configure the backup in that data backup service company.

Run the backup process in that data backup service company.

Verify there is information in the data backup service company databases for the billing system to automatically process payments properly.

### Account Verification System

The Account Verification System [024] retrieves a total list of computers and associated information in the data backup service company services using the data backup service company API.

Receives data from the Communication And Verification Subsystem [036] and compares the two. If the information provided in the data received from the Communication And Verification Subsystem and the API call match, the matched information is removed from the data list.

The Account Verification System [024] is used for consistently updating a list of computer names that are not located within the excluded computers list and not already associated with an active backup billing account.

An excluded computers list is defined as a list of computer systems for which the user does not wish to charge a fee.

### Automatic Aggregate Data Updater

The Automatic Aggregate Data Updater [026] retrieves encoded data daily then sends the data through a conversion process prior to storing the daily backup usage data for the backup account. The Account Verification System [024] receives the usage data to analyze and verify account validity.

### Automatic Billing Converter Module

The Automatic Billing Converter Module [028] reviews all data stored in the database then converts the usage data into proper billing charges and passes the charges to the Payment Processing Module [084].

### Data Conversion System

The Data Conversion System [030] is required for the encoded data received.

For example, the numbers for data usage that are not in any type of format which would be useful for billing purposes. An example number may be an encoded number such as 02988503039 that is received and this must be converted to a byte format.

### Filter System

This Filter System [032] is a key portion to the Backup Billing System receives data from User Input [098], retrieves a list of active accounts from the Database Handler [062], and compares the list prior to sending the list to the Exclusion Controller [038].

### Listing Module

The Listing Module [034] accepts the data that has been filtered and is not associated with a backup billing account or in an exclusion list and transfers this data to the Management Interface [078].

### Communication and Verification Subsystem

The Communication and Verification Subsystem [036] communicates and verifies all information sent to and received from an Application Programmers Interface (API). It checks if the data backup service company API is available and verifies and renews the API communication token. This subsystem is required for consistent, reliable, stable and secure communication to the data backup service.

### Exclusion Controller

The Exclusion Controller [038] excludes customer accounts from being automatically charged, plays a critical role and is a key portion in the backup billing system. It receives data from both the Filter System [032] and the database for the backup accounts that are excluded from being charged. This controller removes the excluded accounts from that list before passing the list to the Communication and Verification Subsystem [036].

### User Management Subsystem

The User Management Subsystem [040] dynamically receives input from the end user and matches it to the local database. Post submission, it verifies matching data, sorts and stores the data and adds information into the local database prior to sending the data to the Calculation Algorithm Process [050].

These features collectively make the backup billing software solution a comprehensive and innovative approach to managing data backup billing processes, ensuring accuracy and efficiency.

### Dynamic Contract Creation

Next the Dynamic Contract Creation module is detailed. The contract pricing system offers a personalized and flexible approach, allowing end users to select their contract type and enter specific pricing details. The system accommodates various contract types and precise calculations. The process supports the creation of hourly, prepaid blocks of time, and other variable price and term contracts based on end-user requirements.

The Dynamic Contract Creation system introduces an advanced method for preparing, creating, billing, and maintaining business contracts within a service business software system. This system is characterized by various capabilities:

### Contract Preparation

Providing users with required keyword phrases to integrate into their business contracts. An interface for uploading various file types and converting them to the required format. The system reviews the file content to ensure all required keyword phrases are accurately placed within the file. Offering pre-written basic service contracts for user consumption. An interface providing flexibility to create and apply custom pricing based on various pricing models, such as multi-tiered pricing matrices, prepaid blocks of time, flat rate, or hourly.

### Dynamic Contract Creation

An interface for users to input data for contract creation. The entered data replaces the keyword phrases in contract templates, resulting in a completed and customized contract. A system for automatic form filling, using data to populate fields. Automatic customer profile creation in integrated software systems, segregating business and residential customers. Allowing users to provide discounts, promotional prices, or credits during contract creation. Integration with a global customer behavior list, alerting users about potentially problematic customers. Interface for industry-specific equipment make and model selections, with options for adding and sharing entries globally. Calendar integration for selecting any maintenance days and times, including automatic contract expiration date reminders. Integration of contract data with the customer relationship management (CRM) system.

### Contract Billing and Payments

Automatic configuration of recurring billing based on contract term length. Prepayment discounted pricing. Complex billing options. Interface displaying failed recurring billing transactions, allowing users to update payment information and reprocess payments, with automated customer notifications. An alert system for unpaid additional appointments. Ability to disable payment reminders for specific appointments. Immediate checkout process for additional appointments scheduled under contract. An interface for creating multi-payment invoices with automated interest calculation, enabling customers to select their preferred payment terms. It integrates with the Autoset feature to automatically schedule payments for multi-payment plans not configured by the customer.

### Contract Maintenance

Interface displaying all active contracts with sorting options. Quick filter function for results without database calls. Advanced search function with database queries. Visual representation of monthly payments with color-coded status indicators. Advanced functionality for creating file formats of contracts, receipts, and invoices such as PDF. Interface for modifying, emailing, and inactivating contracts. List of inactive contracts with restoration options. Interface for viewing and adding notes to contracts. Interface for scheduling appointments. Configurable service maintenance notifications. Interface displaying expired contracts with renewal options. Configurable grace period for contract expiration, with notifications. Options for manual and automatic contract renewal. The Dynamic Contract Creation system optimizes and streamlines document management processes. It supports multiple file types such as .docx, .pdf, .rtf, and .html, dynamically loading templates based on user input and context. The system analyzes user input to predict and preload relevant templates, significantly reducing wait times. The system configures keyword phrases within templates and replaces them with data from the database or form entries, automating the data binding process with precision. Prorated Pricing: Uses a mathematical matrix system to allow for prorated pricing based on the selected contract type. Flexible Billing Options: Includes provisions for billing only for workdays if desired. This system ensures accurate, tailored contract pricing for each user, enhancing financial management and operational efficiency. This is done using Calculation Algorithm Process features uniquely coded calculations that distinguish this software from any others. It supports: multi-payment invoices with automatic interest calculations, automatic multi-payment scheduling, monthly recurring contracts, prorated contracts by working day, fixed contracts, discounts, complex point of sale calculations, full refunds, partial refunds, percentage-based refunds, custom refunds, dynamic or smart fees, and various other calculations.

The software distinguishes equipment make and is unique in that it can be configured globally among end users within the same categorical business model or individually, allowing entries to be shared with other users. If an end user utilizes global entries, they must also share their own entries, facilitating the speed of continued maintenance and the addition of new items. This collaborative approach minimizes effort for all users. Users can delete or disable entries in their software, affecting what they see when scheduling an appointment or creating a contract, without impacting other users on the platform.

The software distinguishes equipment type and is unique in that it can be configured globally among end users within the same categorical business model or individually, allowing entries to be shared with other users. If an end user utilizes global entries, they must also share their own entries, facilitating the speed of continued maintenance and the addition of new items. This collaborative approach minimizes effort for all users. Users can delete or disable entries in their software, affecting what they see when scheduling an appointment or creating a contract, without impacting other users on the platform.

An Intelligent Data Creation Handler [076] automatically configures and stores data across various locations, including other servers and internal subsystems. These external servers may include QuickBooks Online or other Online Accounting Software Systems, Square, Microsoft Exchange, Google Contacts, iCloud Contacts, PBX systems, IT support systems, and other servers integrated into the software.

Each connected external server has unique policies and constraints on data entry. Manually entering data into these systems and understanding their limitations is time-consuming and requires expertise with each piece of software. The Intelligent Data Creation Handler [076] is designed and programmed to recognize each connected software and accurately place data within the constraint limitations of each system, significantly enhancing the efficiency and accuracy of data entry across all integrated systems.

A Pricing Controller allows the end user to disable the Dynamic or Smart Fee charged to their clients. If the dynamic fee is disabled, it is calculated and charged to the end user, but it is no longer passed on to the end user's clients or displayed on any of their transactional receipts.

A Template Edit Process is used for obtaining the correct template file from template storage and sending it to the editing module, along with the data to replace the keyword phrases within the file. This process retrieves the edited file and forwards it to the PDF Conversion Module. The PDF Conversion Module then returns the PDF file back to this process, which in turn sends it to the receipt generation system.

An Alert System uses uniquely colored banners prominently displayed at the top of the software to serve as a crucial reminder system. These banners feature messages with hyperlinks, enabling the user to easily track and complete necessary tasks. Without the critical feature of the Alert System, the end user would face the insurmountable task of manually tracking all responsibilities, such as overdue invoices, failed recurring transactions, sales tax deadlines, and numerous other duties. These banners relieve the user from the burden of remembering all these details, allowing them to focus more on customer interactions. This helps ensure that nothing is overlooked, and all essential actions are promptly addressed.

An expired contracts module allows the end user to review and renew any contracts for which they hold that have expired. If they are outside their renewal date and do not have an auto renew option then they can be renewed within this section without having to retype all the information required for the contracts.

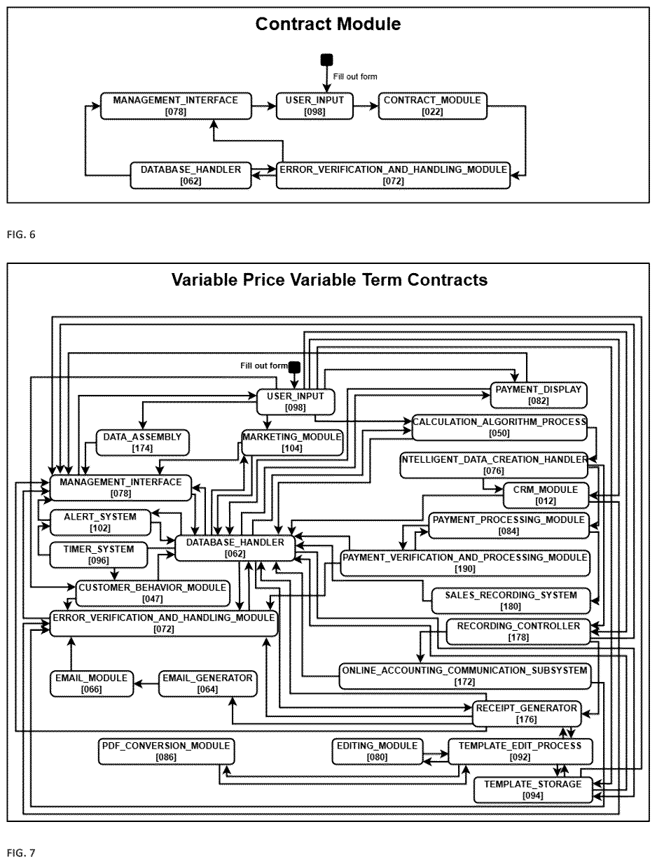

FIG. 6 depicts a system for an integrated software application focused on resource management and contract creation. At the core, there's a fill-out form, connected to several modules and subsystems. These include a Management Interface [078], User Input [098], Contract Module [022], Database Handler [062], and Error Verification and Handling Module [072]. Each component is linked, showing the flow and interaction within the system.

An explanation for contract creation is detailed next:

Contract creation works with a variety of contract types including fixed and variable price, prorated and non-prorated, prepaid and mult-payment, hourly, prepaid blocks of time, business or calendar days and fixed or variable term.

### Contract Pricing

Contract pricing is an individualized system where end users can select their contract type and enter their contract pricing. Contract creation uses user entered pricing inside a mathematical matrix system to allow for variable pricing based on the selected contract type.

### Variable Price Variable Term Contracts

FIG. 7 depicts an integrated software system for variable price variable term contracts and the process and data flow.

These features collectively make the Dynamic Contract Creation system a novel and comprehensive solution for managing business contracts, ensuring accuracy, flexibility, and efficiency in contract handling and billing processes.

### Marketing Success Sharing System

The Marketing Success Sharing System is an automated global communication system that allows users to input marketing campaign details and automatically calculate expected return on investment (ROI) based on the same business industry statistics. This data is derived from users of the software utilizing the marketing campaign features, aggregating this data and calculating expected return on investment for the geographic locality of that individual business.

The system leverages a global database shared among all users to assess the return on investment (ROI) of specific marketing ventures. It provides anonymous ROI data from businesses in the same industry, enabling users to evaluate the effectiveness of a marketing agency or campaign prior to committing any resources.

The Marketing Success Sharing System offers a solution for managing and analyzing marketing lead sources and campaigns within a service business software platform, empowering businesses to make data-driven decisions and optimize their marketing strategies. This system is characterized by several capabilities:

Detailed Input of Marketing Campaign Information: Users can input comprehensive details about their marketing campaigns, such as agency name, advertising platform, target demographics, costs (graphic design, advertising, distribution), and campaign duration.

Linking Customer Acquisitions to Marketing Campaigns: Users are required to link new customers acquisitions to specific marketing campaigns during appointment scheduling, enabling precise tracking of campaign effectiveness.

Automated Tracking of Marketing Metrics: Tracks key metrics such as total spending, gross sales, and net profit, without manual input.

ROI Calculation: The system calculates ROI as transactions occur, providing up-to-date performance metrics for each marketing campaign.

Comprehensive ROI Metrics: Tracks both gross sales and net profit, as well as customer lifetime value, to provide a thorough analysis of marketing campaign effectiveness.

Predictive Analysis Using Historical Data: Predicts the effectiveness of lead sources based information such as historical data, industry trends, and performance metrics.

Anonymized Sharing of Performance Data: Shares performance data anonymously to users in the same industry and geographic area, allowing for industry-wide insights without compromising user privacy.

Opt-In/Opt-Out Data Sharing: Users can choose to participate in data sharing or opt-out.

Advanced Search Capabilities: Users can search for marketing performance with a plurality of query options such as searching by industry, geographic area, and specific marketing campaigns, with options to expand search criteria as needed.

Filtering and Sorting Options: Provides filtering and sorting options, allowing users to organize search results by various metrics such as spending, ROI, and customer acquisition.

Comprehensive Metrics Display: Displays detailed metrics including data such as total spending, gross and net ROI, and customer acquisition numbers.

Visual Representations: Shows visual representations of data.

Customizable Alerts: Generates alerts for campaigns showing profit below or above a predetermined amount of costs, as well as when set marketing goals are reached.

User-Selected Alerts: Users can customize which alerts they receive, tailoring the system to specific parameters.

Data Anonymization: Ensures all shared data is stripped of personally identifiable information, protecting user privacy while providing valuable insights.

Data Aggregation: Aggregates data from multiple users within the same industry and geographic area, presenting it in a format that prevents identification of individual businesses.

Pre-ROI Calculations: Allows users to search available campaigns to see ROI for other businesses in their industry near their location for a selected or specified marketing agency or campaign.

Detailed ROI Calculations: Immediate and comprehensive analysis of marketing campaign effectiveness based on historical shared data.

Automated ROI Calculation: End users can enter campaign details, and the system calculates ROI using localized industry statistics.

Algorithmic Analysis: Reviews, analyzes, and determines the most effective marketing techniques for ROI. For example, an end user can verify examples from marketing agencies, such as Angi, by accessing accurate, anonymous data on what other businesses in their industry and area have spent and earned through Angi. The system expands searches if local data is insufficient and provides alerts if no relevant data is found.

The marketing system is a multi-purpose system inclusive of working with marketing campaigns and online reviews. The lead source global collective system allows users to input or choose marketing companies from other user's marketing campaigns.

The Marketing Module [104] allows the end user to enter and share marketing campaign details to other users. For example, the campaign cost, term length, return on investment (ROI) and location would be marketing campaign details that are shared.

The software calculates the return on investment (ROI) based on other localized business industry statistics. This information is shared anonymously with other users.

The Marketing Module [104] reviews, analyzes and determines which marketing techniques can bring a return on investment for the end user. This module is responsible for providing non-identifiable statistics on the various marketing techniques for business industries.

For example, when a marketing company representative contacts the end user and says that other businesses in the same business industry in their area are making $2,000 a month through the their services, the business owner can go into the software and search marketing company and see anonymous, but accurate, data of what other business owners return on investment from campaigns with that marketing company.

FIG. 14 illustrates a Marketing Module [104] and the interaction within the integrated system, showcasing how various modules are interconnected. The central components include the User Input [098], Database Handler [062], and Management Interface [078], all of which interact with peripheral modules such as the Appointment Scheduler [001], Sales Recording System [180], marketing module, and additional functional subsystems. This configuration highlights the streamlined communication and integrated operation of the overall software system.

These features collectively make the Marketing Success Sharing System a novel and comprehensive solution for managing marketing lead sources, tracking performance, and sharing valuable insights within the service business software system. By utilizing a database topology design inspired by a star topology in networking and incorporating advanced features such as composite indexing, vertical partitioning, query caching, and connection pooling, the system achieves significantly enhanced performance and efficiency. This design ensures faster and more efficient data retrieval by centralizing data access while reducing the need for multiple individual database queries. Additionally, it minimizes the computational overhead associated with repeatedly establishing and closing database connections, resulting in optimized resource utilization and improved system responsiveness.

### Online Review Controller System

The Online Review Controller introduces an innovative method for businesses to manage, optimize, and control customer reviews across multiple platforms through an integrated and efficient system. This system is characterized by several capabilities:

### Keyword Phrase Association and Retrieval

Associates keyword phrases with products or services during their creation.

Dynamically retrieves these phrases during the checkout process.

Uses a specialized indexing strategy to enable rapid keyword retrieval.

### Prewritten and Customizable Reviews

Allows users to write multiple unique reviews during the checkout process, incorporating relevant keyword phrases.

Stores prewritten reviews in a database for future use and consistency.

Provides customers with the option to approve and edit these prewritten reviews or write their own.

Ensures that reviews are detailed and optimized for review websites.

### Automated Review Request Emails

Automatically generates and sends review request emails to customers upon completion of the checkout process.

Includes customizable 5-star rating options with hyperlinks that direct customers to different review or feedback mechanisms based on the rating selected in the email.

### Feedback Page for Lower Ratings

Directs customers who click lower ratings to an internal feedback page.

Allows customers to write their own review and displays other customer selected reviews for reference.

Automatically adds customers who submit a review with less than the user-approved rating to a banned review customers list, preventing future review requests to the customer.

Provides users with insights into areas needing improvement.

### Online Review Instructions Page

Directs customers who click on the user-configured star rating in the email to a guided tutorial.

Guides customers through a three-step process to leave a review:

Choosing a review website.

Selecting or editing a prewritten review while retaining keyword phrases.

Viewing instructional materials on how to leave a review on the selected review website.

Ensures higher quality and consistency in reviews through this structured and guided process.

Automatically removes selected review websites and selected reviews to prevent duplicated use.

### Banned Review Customer Management

Integrates with the checkout system to hide review options for banned review customers.

### Pop-up Reminder for Multiple Reviews

Triggers a pop-up reminder if a user tries to leave the website before submitting reviews.

Encourages users to complete multiple reviews, thereby enhancing the businesses online presence across several platforms.

The review controller offers control over online reviews with:

Keyword Optimization: Ensures reviews contain relevant keywords.

Review Filtering: Directs less-than-five-star reviews to an internal feedback page, filtering out less than optimal or negative reviews.

Training and Guidance: Provides printable instructions and videos for customers on how to leave reviews on selected websites.

Unique Reviews: Ensures each review is unique to avoid duplicated reviews across different platforms.

### Review Process

Select Review Website: Customers choose from a list of displayed review websites.

Modify Review: Customers can edit pre-written reviews with necessary keywords.

Training: Customers receive training on how to leave a review on the chosen website.

### Additional Features

Automatic reminder emails for incomplete reviews.

Review mail history tracking.

Customizable request settings for review websites.

The system enhances the review process, ensuring positive, keyword-rich reviews while filtering out negative feedback, thus maintaining the businesses online reputation.

The online review controller allows the end user to configure terms such as required keyword phrases contained within the review, minimal number of words, and desired review websites, create and filter out less than desired online reviews before the reviews are posted to the online review website.

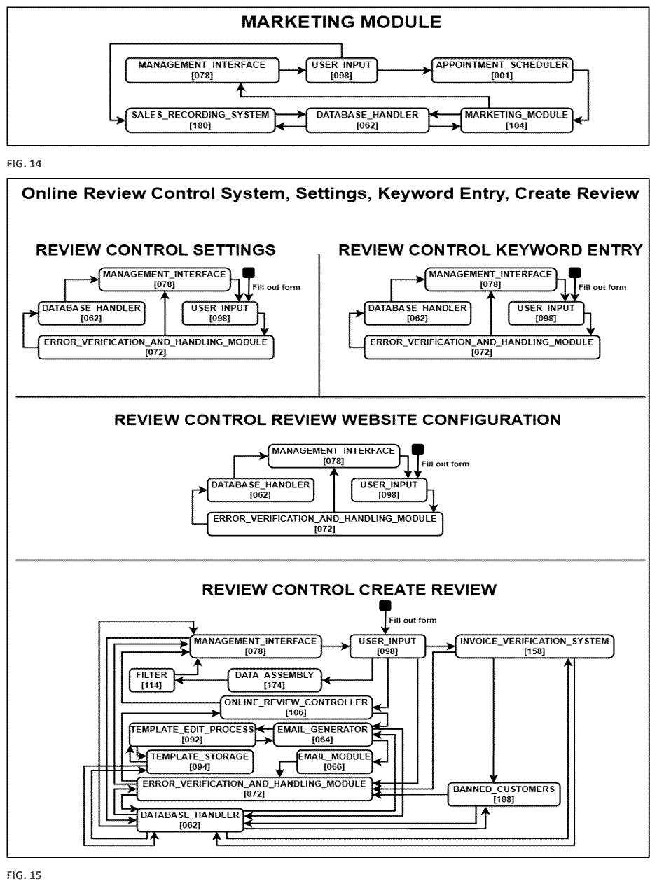

FIG. 15 presents the four sections to the Online Review Control System. Settings, Keyword Entry, Review Website Configuration and Create Review. The settings, keyword entry and review website configuration incorporate a Management Interface [078], Database Handler [062], User Input [098], and an Error Verification and Handling Module [072]. The create review also incorporates components such as the Invoice Verification System [158], Filter [114], Data Assembly [174], Online Review Controller [106], Template Edit Process [092], Email Generator [064], Email Module [066], Template Storage [094], and Banned Customers [108], working together to facilitate comprehensive online review filter and control system.

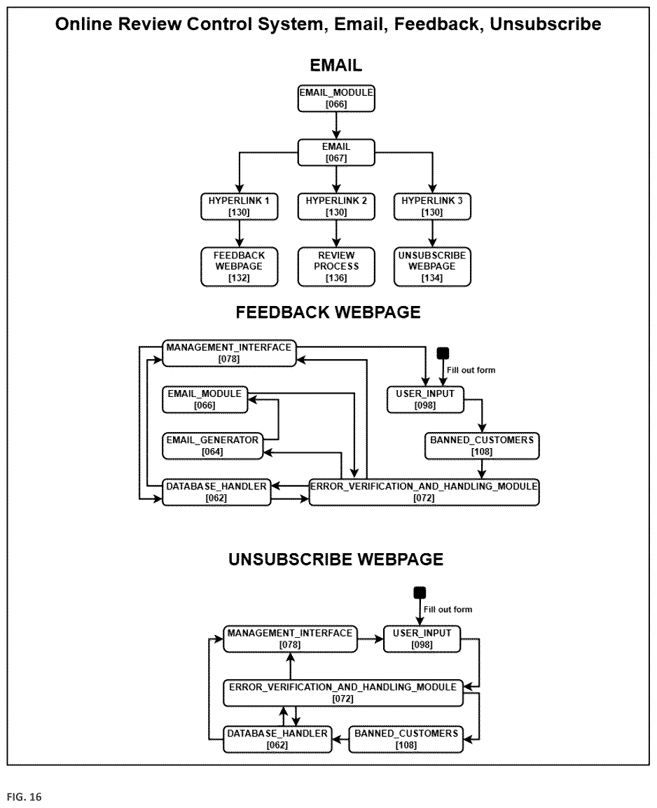

FIG. 16 outlines a hierarchical flowchart for the Online Review Control System the Email, Feedback and Unsubscribe sections. The email section contains the Email Module [066] which sends the Email [130] containing three hyperlinks leading to webpages for Feedback [132], Review [136], and Unsubscribe [134]. These three functions work in tandem to create a seamless review filtering system. For example, if there are 5 stars in the email, the hyperlinks for stars 1, 2, 3, and 4 can be configured to direct a user to a feedback only page while the hyperlink for the 5th star can be configured to direct a user to an online review assistant website page.

The feedback website page data flow shows the interaction between the Management Interface [078], User Input [098], Banned Customers [108], Error Verification and Handling Module [072], Database Handler [062], Email Generator [064], and Email Module[066].

The unsubscribe website page displays the data flow between the Management Interface [078], User Input [098], Error Verification and Handling Module [072], Banned Customers [108], and the Database Handler [062].

FIG. 17 illustrates interaction between the components for leaving a review through the online review control system. The modules include the Management Interface [078], Error Verification and Handling Module [072], Database Handler [062], File Handler [112], Alert System [102], User Input [098], Transition State Module [116], Template Edit Process [092], and email-related functionalities such as the Email Generator [064] and Email Module [066]. This diagram emphasizes the data flow for users leaving an online review and shows how the data is processed through several interacting modules, including email, the error handling system and database handling. These components acting together allow for a cohesive online review filter and control system.

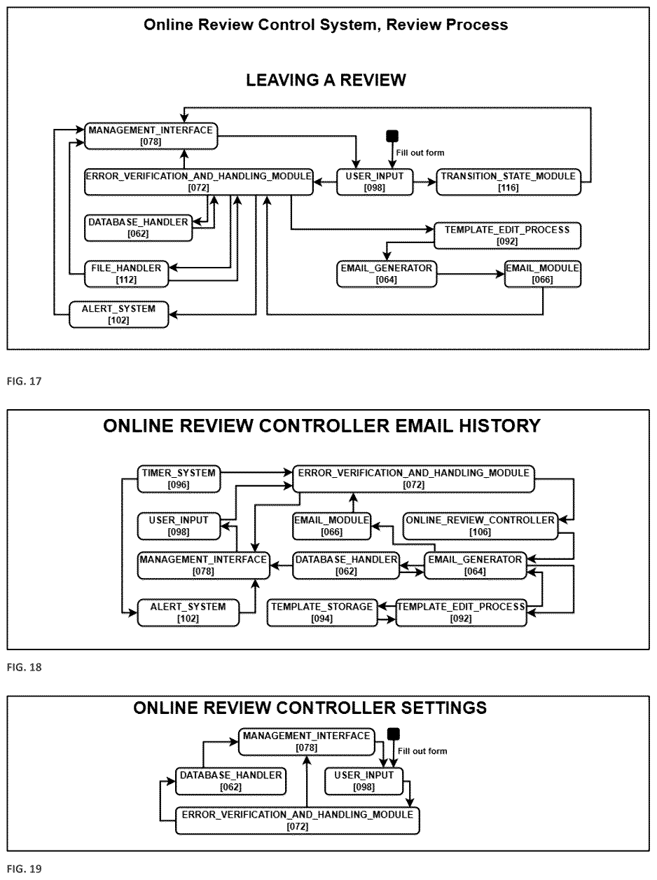

FIG. 18 depicts an online email history process allowing a user to manage and control review options for their customers. For example, enabling or disabling review websites, viewing the review, resending emails and stopping the automatic review request emails. These components include a Timer System [096], Error Verification and Handling Module [072], User Input [098], Email Module [066], Online Review Controller [106], Management Interface [078], Database Handler [062], Email Generator [064], Alert System [102], Template Storage [094], and Template Edit Process [092].

ONLINE REVIEW CONTROLLER explanation is detailed next:

The online review controller allows the user near full control of online reviews.

Keyword phrases used within the review are an essential component for effective online reviews. For example, when a user posts a 5 star review that states only “Mike was great”, this does very little for the business because potential customers will not search for “Mike was great” but instead will search for “ice cream services near me” or “computer repair services in my area”.

Knowing what keyword phrases people use to locate businesses is extremely difficult for the average business owner. The most common method is to ask the customer how they found the business and what keyword phrases were used within the search.

Another issue for online reviews is ensuring the client will leave a keyword rich review. Online review websites are not created equally and can be a daunting and very time consuming task to navigate just to locate the web page and leave the review. For example, once the web page is located on the Better Business Bureau website for a business, the form must be filled out and an email is then sent off where a link must be clicked on for the review to appear while Google covers up their 5 stars with a message containing a hyperlink that if clicked takes the user away from the review and to a different web page causing confusion and resulting in an non-completed review.

Additional compounding issues are that some review websites require a minimal word count to leave the review.

Review websites watch other review websites to ensure each review left on their website is unique and not copied.

Review websites detect the Internet Protocol (IP) address and equipment type leaving the review. Each review website must detect these as unique and non-repetitive.

Business owners that are not technically savvy enough to navigate or walk their clients through leaving a review miss valuable opportunities for marketing their business. While the business owner may ask how the client heard of them, most commonly this is where it ends because the business owner does not know what to do next.

Filtering out undesired ratings is an important aspect to controlling online reviews. Less than 5 star reviews that are unfounded hurt a business. A personal experience for an example was a client encountered for a simple delivery of a product that requested 3 additional hours of service work during the delivery. After leaving and driving away for 20 minutes, the client called and asked if I could turn around, come back, pick him up and take him to a bar to meet his friends to which I obliged. This was an easy 5 star review. I sent the request and he left 4 stars quoting “It would have been 5 stars, but the shipping took a day longer than it was supposed to”. Filtering out these types of reviews are extremely important.

Preventing review requests to customers which have previously left less than 5 star reviews is important to ensure they do not leave another less than 5 star review.

Easily overcoming these various problems and simplifying this process for online reviews requires multiple integrated components in a single software solution. Ensuring positive reviews requires controlling keywords and phrases, uniquely written reviews, wording and word count, client filtering, review request prevention, ratings controller, selecting a review website, training tutorials and a walk-through for review websites.

Keywords and phrases happen because of the integration when creating checkout items. Users add keywords or phrases to each item. These words are stored in a global database accessible by similar businesses within the same industry. By creating a global integrated keyword list, this allows business owners that are less technical savvy to choose what keyword phrases to choose when creating example reviews during the checkout process.

Ensuring a uniquely written review, with selected keyword phrases, wording and word count is completed during the checkout process. Up to 3 reviews can be written for the user's customer during the checkout process. Indicators determine when minimal word count and keyword phrases are used within the review. This process ensures the minimal word count is met, the desired keyword phrases and acceptable wording are used within the review.

Client filtering happens via email. An email is sent to the user's client. This email contains several hyperlinks leading to different websites. For example, there can be 5 stars to choose from and stars 1 thru 4 lead to a feedback webpage, whereas the 5th star leads to the walk-through for leaving a review. Based on configuration settings, when the user clicks 1 thru 4 stars, they are brought to a feedback webpage where they can write their feedback for the business. Upon submission of the form, this feedback is emailed to the user and the client is added to the online review Banned Customers [108] list preventing the user from requesting a review and creating a warning to other users that this person has left less than 5 star feedback for other businesses. Upon clicking the 5th star, the user is brought to the review training and walk-through where they can select where they want to leave a review, review and edit the prewritten reviews to suit their desired wording and watch video tutorials on how to leave the review on their selected review website. They are then transported to the review website to follow the instructions provided.

Review request prevention happens through a Banned Customer [108] list. Users can add customers to the banned customer list or they are added automatically by submitting less than desired review ratings.

Ratings control happens during the Email [130] process where the user's client selects the star rating within the email. Based on the selection, they will be brought to the feedback web page or the review tutorial page.

Selecting a review website happens during the review tutorial process and after the user has selected the desired star rating in the Email [130]. Based on the user configuration settings, the user's client has several review websites from which to choose. The user selects the review website prior to editing and selecting the review.

Review and editing of the review happens during the second step of the review tutorial process. The user's client reads the prewritten review and is allowed to edit the review while indicators ensure the word count and keyword phrases are kept within the review. Once the editing process is completed, the desired review is selected and copied to the equipment software clipboard.

Training tutorials are provided prior to transporting the user to the selected review website form to paste the review and submit the form.

Automatic reminder emails are sent out to the user's client if they fail to start or finish the review process.

If they fail to click on any links in the email, a predetermined number of reminder emails are automatically sent out to the client within a specified time frame.

Once the user has been transitioned to the review website of their choice, they will receive an email containing a copy of their selected review, the selected review website link and a training tutorial file of how to leave the review on their selected review website.

### File Handler

The File Handler [112] in FIG. 17 is responsible for providing the management interface with the downloadable training guides and video files for which are displayed to the user in the review process.

### Filter

The Filter [114] in FIG. 15 has two functions. The first function is to ensure the selected review websites and selected pre-written reviews are unique and are removed from the walk-through process after they have been transitioned to the selected review website. The secondary function is to filter out any derogatory terms, words or phrases within the edited review.

### Transition State Module

The Transition State Module [116] in FIG. 17 is responsible for transitioning the user to the next or previous steps in the review process and transporting the user to the selected review web page.

### Unsubscribe Webpage

The unsubscribe page allows the end user's customer to request to be removed from either that specific review or all future reviews. When the user requests to be removed from all future reviews, they are automatically added to the global Banned Customers [108].

FIG. 15 ONLINE REVIEW CONTROLLER [106]: Allows a user to enable or disable the Online Review Control System during the checkout process.

### Online Review Controller Email History

The review mail history section allows the end user to see what emails have been emailed to specific clientele, which review websites and pre-written reviews have been selected by the client. The end user can send another request to their client.

### Review Request General Settings

The request general settings section allows the end user to edit the uniform resource locators (URLs) known as website addresses for specific review websites, change the order of importance and disable any review websites.

Only the software system administrators have the ability to change the name, review website icon, video link, required maximum reviews per day, borders, marketing email status, the training document file or the ability to delete any of the review websites that are currently in place for end users.

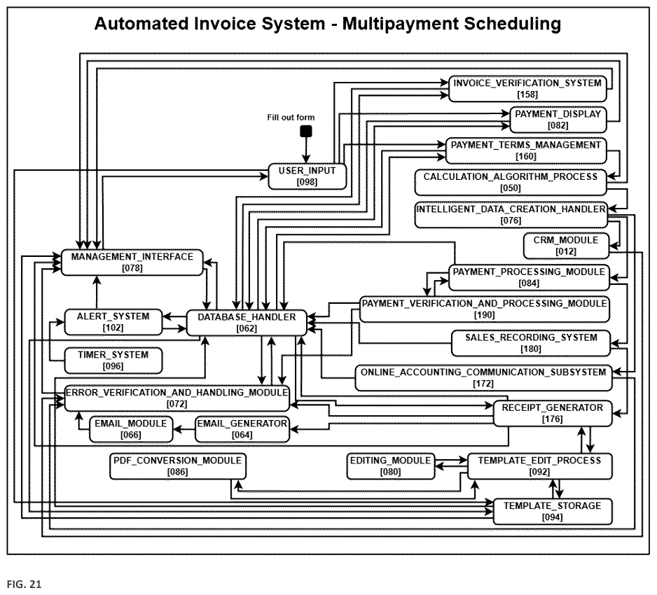

FIG. 19 illustrates an exemplary online review request general settings process. The “Fill out form” is connected to User Input [098] which sends data to the Error Verification and Handling Module [072]. The error verification and handling module verifies data validity and sends errors to the Management Interface [078] or requests to the Database Handler [062]. The database handler sends results to the management interface.

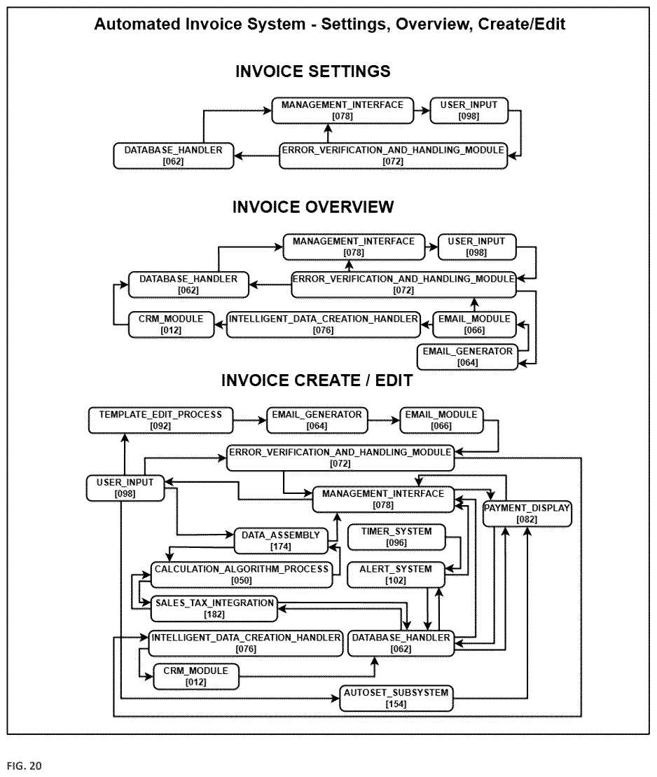

FIG. 20 illustrates the interconnected components of an integrated software system designed for efficient resource management and appointment scheduling. Key modules depicted include the Management Interface [078], User Input [098], Database Handler [062], CRM module [012], Intelligent Data Creation Handler [076], Email Module [066], Email Generator [064], Error Verification and Handling Module [072], Payment Display [082], Timer System [096], Calculation Algorithm Process [050], Data Assembly [174], Alert System [045], Sales Tax Integration [182], and Autoset Subsystem [154]. These components work together to enhance functionality, streamline operations, and ensure effective communication and data management within the system.

These features collectively make the Online Review Controller a novel and comprehensive solution for managing customer reviews, ensuring accuracy, efficiency, and a superior user experience in the review management process across various platforms. Keyword phrases associated with products or services are stored in a dedicated, indexed table, which supports rapid insertion and retrieval of keywords, ensuring the database can handle a high volume of keyword lookups efficiently. By maintaining a focused and optimized table for keyword phrases, the system reduces overall query complexity and enhances performance. Compressing data transmitted between the application and the database reduces the amount of data transferred, speeds up communication, and reduces bandwidth usage. This optimized data transmission ensures that large volumes of data can be handled quickly and efficiently.

### Multi-Payment Invoicing System

The Multi-Payment Invoicing System is designed to revolutionize the process of collecting payments after creating, managing, and processing invoices for businesses. This system integrates several features and capabilities that enhance operational efficiency, ensure integration with other systems, and provide a comprehensive solution for managing customer payments across multiple payment methods and schedules. Features of the Multi-Payment Invoicing System include:

### Autoset Subsystem

The unique Autoset feature automatically determines and schedules the lowest monthly payment for the longest term based on user-configured parameters. This ensures that customers are offered manageable payment plans, reducing the risk of missed payments.

Notifications are sent to clients if Autoset is invoked.

Users can disable the Autoset feature for individual invoices to prevent automatic payment scheduling.

The unique Autoset feature is a novel and comprehensive automatic payment scheduler that is designed to allow users to more efficiently collect and process payments.

The AutoSet subsystem is a unique automatic multi-payment scheduler for end users who send invoices to their clients. It automatically schedules payments when a customer fails to pay in full or set up their own multi-payment terms. The AutoSet subsystem selects the lowest monthly payment for the longest term the end user's client qualifies for, based on the end user's minimum monthly payment parameters configured in their settings. Combined with a custom automatic email system, the AutoSet subsystem sends out reminder emails to the end user's client according to the time configured in the global administrator settings. AutoSet automatically checks if unpaid invoices exceed the timeframe set in the global administrator settings. If they do, the AutoSet subsystem reviews the invoice, determines the lowest monthly payment for the longest term with the highest interest rate the end user's client qualifies for, and creates a payment schedule automatically, using the default credit card on file with the payment processor. It then charges the card and sends automatic receipts to the client. This system helps prevent the end user from chasing after their clients for payment. AutoSet cannot be enabled on an invoice without a credit card on file. The end user can disable the AutoSet feature in their settings.

### Automated Invoice Management

The system allows users to create and manage invoices, providing an intuitive interface for entering client information, configuring payment terms, and sending initial emails with invoice details.

Users can enable or disable the Autoset feature, which automatically schedules payment terms if the customer does not configure them within a predetermined time frame.

### Flexible Payment Processing

The system supports multiple payment methods such as cash, check, credit card and digital currencies.

A guest checkout feature allows the user's customers to pay invoices online.

The system can handle recurring payments, early payments, and replacement payments, providing flexibility and accommodating various payment scenarios.

### Advanced Error Verification and Handling

The system incorporates error verification and handling mechanisms to ensure data accuracy and integrity. This includes verifying data input, performing server-side checks, and handling failed transactions.

Users are notified of discrepancies or missing information, and error messages are provided to help resolve issues promptly.

### Comprehensive Email and Notification System

Customizable email templates allow users to create professional and branded communications with their clients. The system automatically integrates data from forms into these templates and converts them to other file formats such as PDF.

Automated reminder emails for unpaid invoices and confirmation emails for payment setups, including Autoset configurations, help ensure timely payments.

### Integration with Accounting Software

The system integrates with online accounting software, automating the transfer of financial data reducing the need for manual entry.

Detailed payment schedules and amounts are displayed, helping users track payment history and manage invoices effectively.

### Enhanced Payment Security

All payment transactions are processed through an online payment processor with encrypted connections, ensuring the security and confidentiality of data during transmission.

The system uses tokenization, where the payment processor stores payment information and provides a unique id code for future transactions. This minimizes the exposure of sensitive information.

Only limited information, such as the name, last four numbers, expiration date, and zip code of a credit card, is stored in the system, adding an extra layer of security.

### Invoice Multi-Payment Scheduling

Multi-payment invoicing is configured with two methods; internally or guest pay.

Internal invoices can be paid using all predetermined payment methods.

Guest pay invoices are paid by predetermined digital payment methods. Invoices that qualify for payment terms can be scheduled for automatic monthly payments on a preconfigured payment date.

FIG. 21 illustrates the integrated structure of the modules within the multi-payment scheduling system as follows:

The User Input [098] sends data to the Management Interface [078] displays information to the user.

The Alert System [102] generates alerts based on specific triggers and conditions.

The Database Handler [062] manages data storage and retrieval within the system's database.

The Timer System [096] manages and tracks timing-related functionalities.

The Error Verification and Handling Module [072] ensures data integrity by verifying data and processing errors.

The Email Module [066] and Email Generator [064] are responsible for email communication and the generation of emails based on events or actions.

The PDF Conversion Module [086] converts documents into PDF format The Editing Module [080] allows edits to files within the system. The editing module is critically important to the editing of .docx and .xlsx files from a website hosted on a Linux based server computer.

Windows-based server computers natively support the opening and editing of those types of files via a programming language. Linux based servers do not know how to open those types of files for editing. It is possible to locate Linux based websites that can use a programming language to upload those types of files to their server, extract the data from those files, then convert the data to a different file type, but these websites hosted on a Linux based server do not natively support changing the composition within the file and then saving these files as the same file type. Those websites hosted on a Linux based server using only native server controls only allow converting the exact file to another file type.

The Editing Module [080] allows for the opening, composition change or editing of those files and saving as the same file type prior to converting that file type to a different file type on a Linux based server.

The Invoice Verification System [158] verifies invoice details and ensures their accuracy.

The Payment Display [082] shows payment-related information to users.

The Payment Terms Management [160] manages the terms and conditions related to payments.

The Calculation Algorithm Process [050] conducts calculations necessary for system operations.

The Intelligence Data Creation Handler [076] automatically configures and stores data in the required locations in accordance with the limitations those locations have for data storage. In most cases, the character limitations for connected areas within an integrated or connected software are not documented.

The Intelligence Data Creation Handler [076] automatically and properly communicates with the software and API's, stores all of the data within the character limitation and proper formatting of each section in all the connected or integrated software, and ensures that all areas contain the proper information in a readable format.

For example, one credit card processor allows 50 characters in their notes section while another allows 75 characters. The formatting of one credit card processor's requirements may not be the same as another.

Other examples are the CRM Module [012] needs to distinguish between a business customer, an employee of that business and the business owner so it knows where to automatically and properly put the notes and transactions. The Intelligence Data Creation Handler [076] automatically deciphers and sorts the transaction logs, notes, titles, and details then it posts the data to the correct place for the CRM module.

Online accounting software has several places within its software for which to store notes, titles, sales items, service items, sales tax, and more. Each area within an online accounting software system has its own limitation to how many characters are allowed within that specified area.

The CRM Module [012] manages customer relationship management tasks.

The Payment Processing Module [084] processes communicates with payment processors ensuring secure and efficient financial operations.

The Payment Verification and Processing Module [190] is specific to credit card transactions, verifying and processing those payments. The module is programmed to work with several sales. It handles sending the payment details to the payment processor and is in charge of creating new customers in the payment processor's software and associating that new customer to the local software.

The Sales Recording System [180] gathers information during a checkout process and stores that information in the local database. Data is stored into the local database regardless if the Recording Controller [178] has a payment type disabled. In cases of recurring monthly payments, the sales recording system sends a request to the email generator to send out emails.

The Online Accounting Communications Subsystem [172] integrates with online accounting software for financial data synchronization, ensuring accurate and up-to-date financial records.

The Receipt Generator [176] generates receipts for transactions, providing proof of purchase and transaction details. The receipt generator is responsible for ensuring receipt numbers are in sequential order. It communicates with a plurality of processes ensuring correct templates for the receipt are selected, all calculated numbers are transposed in the proper location.

The Template Edit Process [092] and Template Storage [094] allow for the editing and storage of document templates, ensuring consistency and efficiency in document management.

FIG. 23 illustrates an Automatic Payment Reminder System. It highlights key modules and their interconnected relationships as part of the system's architecture. The depicted modules include the Timer System [096], Template Edit Process [092], Email Generator [064], Database Handler [062], Email Module [066], and Error Verification and Handling Module [072]. These components interact together to streamline payment reminders. If Autoset functionality is enabled on the invoice, the payment reminder email includes automatic payment scheduling.

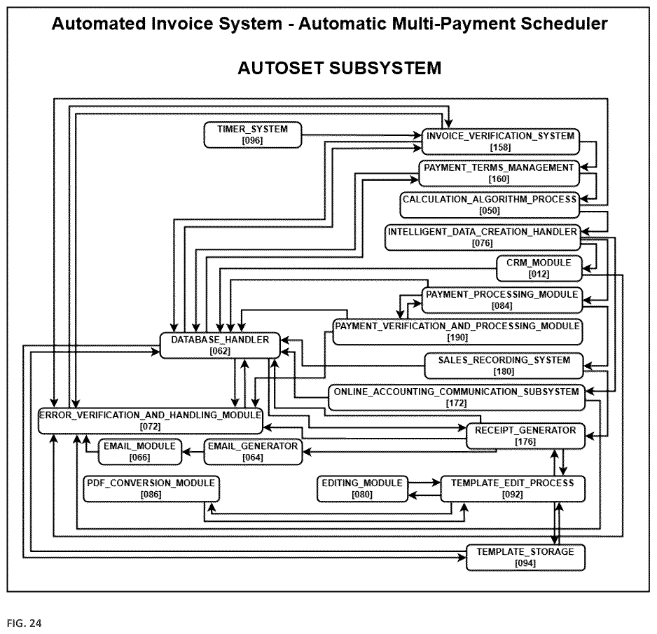

FIG. 24 shows the architecture of an Automatic Multi-Payment Scheduler. It includes a Timer System [096] at the core, which is connected to modules responsible for Invoice Verification [158], Payment Terms Management [160], Calculation Algorithm Process [050], Intelligent Data Creation Handler [076], CRM Module [012], Payment Processing Module [084], Payment Verification and Processing Module [190], Sales Recording System [180], and the Online Accounting Communication Subsystem [172]. Additionally, there is a connection to a Receipt Generator [176], Template Edit Process and Template Storage [094]. This structure further supports a Database Handler [062], Error Verification and Handling Module [072], Email Generator [064] and Email Module [066], PDF Conversion Module [086], and Editing Module [080].

The Autoset Subsystem [154] is a unique automatic multi-payment scheduler within the invoicing system that will automatically schedule payments when a customer fails to schedule their payment terms. The system will automatically select the lowest monthly payment for the longest payment term for which the customer qualifies based on the monthly payment parameters configured in the software by the end user. The autoset subsystem was designed to prevent the business owner from chasing after their customers for payment.

The Autoset Subsystem [154] will wait a predetermined period of time before automatically qualifying the end user's client for either a payment in full or a multi-payment term.

The Autoset Subsystem [154] uses either the default or user specified parameters when making payment scheduling decisions. The Timer System [096] makes calls to the invoicing system. The invoicing system invokes the autoset subsystem on invoices not paid within a predetermined amount of time. The autoset subsystem reviews the invoice and determines the lowest monthly payment amount for the longest payment term with the highest interest rate for which the invoice qualifies. Once determined, the system will automatically schedule monthly payments for the end user's client and start charging the client's default digital payment method. Autoset is not allowed to be enabled on an invoice without a digital payment on file.

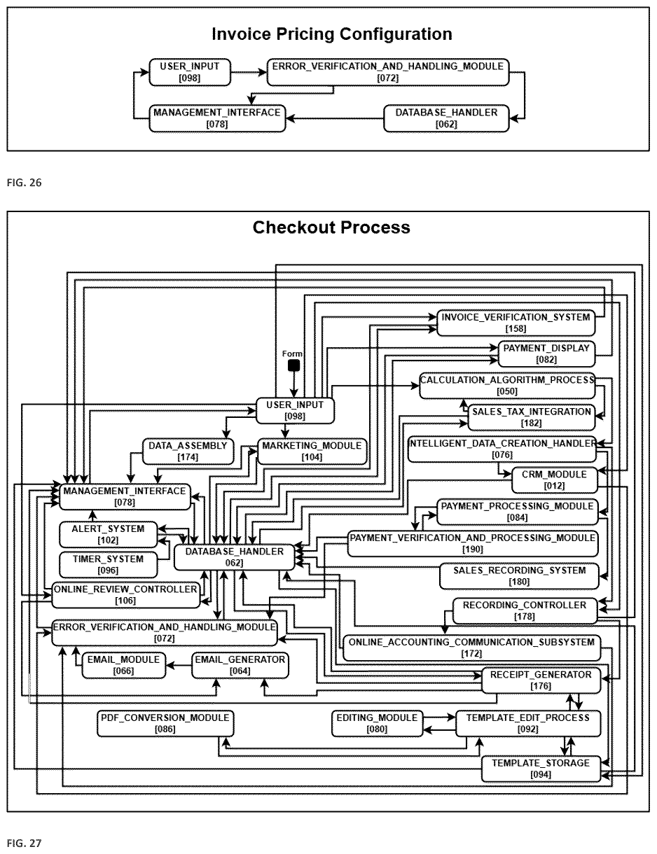

FIG. 26 illustrates Invoice Pricing. User Input [098] is processed by the Management Interface [078], which coordinates with multiple other modules to handle various tasks. The Error Verification and Handling Module [072] is responsible for detecting and handling errors, while the Database Handler [062] manages data storage and retrieval operations. The invoice pricing allows the end user to control the settings within the invoicing system. The end user can enable or disable late fees and enter the percentage rate of the late fee and adjust the amount of interest charged to their clients for a predetermined payment interval.

Payment Terms Management is unique to the invoicing system and is an automated multi-payment invoice defining system. Using a predetermined interval payment amount threshold, this system automatically determines and qualifies the payment term length for which the end user's customer qualifies to pay an invoice over a predetermined period of time.

This ensures risk-proportionate payment standards are met based on input in the user settings. For example, the system can be configured to not allow a $100 invoice to be paid over 12 months.

The Multi-payment invoicing system coupled with the Timer System [096], the Autoset Subsystem [154], the Email Module [066], and the Payment Processing Module [084] allows the software to automatically qualify, inform the customer, schedule and begin processing payments. In addition, the rest of the modules allow for automatic note and sales receipt distribution to other connected internal or external software systems.

### Invoice and Recurring Failed Transactions

Failed Transactions happen both automatically and by manual transactions. Transactions that fail by an automatic means of processing payments happen for several reasons. These transactions require an interface to allow the user to reprocess these transactions, if necessary.

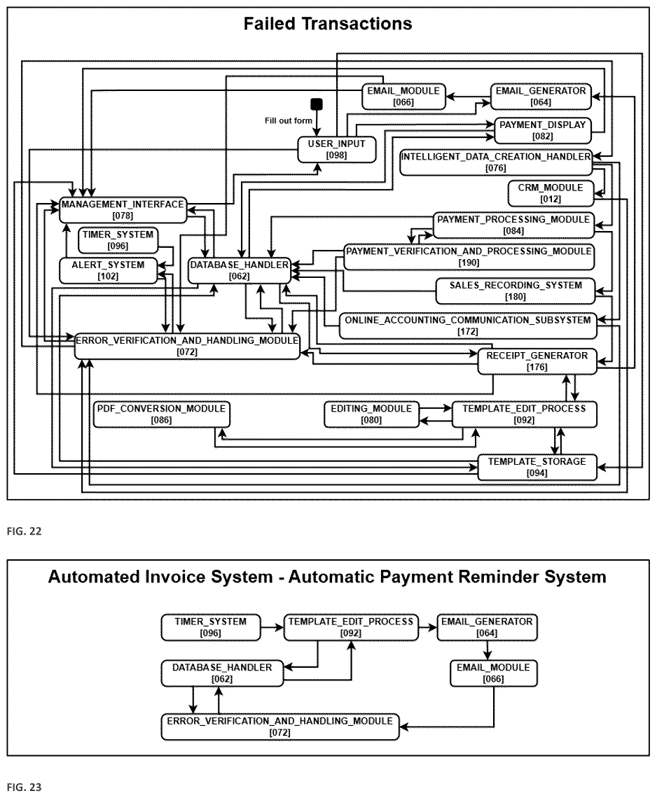

FIG. 22 illustrates the interaction to handle failed transactions. The process begins with Fill Out Form and includes connections among key components such as the Management Interface [078], Database Handler [062], User Input [098], Email Module [066] and Email Generator [064]. The system also incorporates specialized functionalities like Intelligence Data Creation Handler [076], CRM Module [012], Payment Processing [084], Sales Recording [180], Error Verification and Handling Module [072], and Template Edit Process [92] and Template Storage [094], Payment Display [082], Payment Verification and Processing Module [190], Online Accounting Communication Subsystem [192], Receipt Generator [176], Editing Module [080], PDF Conversion Module [086], Alert System [102], Timer System [096].

By utilizing a partitioned database schema, the Multi-payment Invoicing System can efficiently manage data by distributing it across multiple partitions based on invoice characteristics, ensuring quick access to relevant data segments without the need for extensive database scans. Implementing composite indexing on frequently queried columns, along with full-text indexing for specific areas such as invoice descriptions and notes, can significantly accelerate search operations, enabling rapid and efficient text searches.

These features collectively make the Multi-Payment Invoicing System a novel and comprehensive solution for managing invoices, processing payments, and ensuring secure transactions within the business software ecosystem.

### Sales Processing System

The Sales Processing System introduces an advanced method for businesses to manage sales transactions efficiently and effectively through an integrated and dynamic platform. This system stands out due to several capabilities:

### Sales Transaction Management

Enables users to create line items for services or products such as the sale amount, keyword phrases, and descriptions.

Prepares a sale for payment processing by integrating all necessary transactional data.

Allows users to select specific line items for services or products for inclusion in the transaction.

Synchronizes line items with an online accounting software.

Processes and records payments.

Generates a sales receipt from an uploaded document file, editing and replacing data within the file, converting it to a predetermined file type, and emailing the sales receipt.

Dynamic Item Management Product and Service Creation: Allows users to dynamically create new products and service items directly from the checkout process, integrating this data.

### Error Handling and Verification

Verifies potential errors and inaccuracies in data received from a plurality of modules and processes.

Sends error states and messages to relevant interfaces or processes if errors are detected.

Displays error messages to the user through an alert system.

### Integration with External Systems

Ensures proper data formatting and handling for data such as user's customer's information, sales receipt, refund receipt, invoice, expense, vendor, other income, and sales tax data for integration with online accounting software.

Facilitates payments through an online payment processor by verifying data such as customer identity, credit card presence and validity, and creating new customer profiles as needed.

Ensures communication with external software platforms for a plurality of integrations and data exchange processes.

### Data Processing and Dynamic Interaction

Generates additional service items and products based on user input without refreshing the webpage.

Modifies user input dynamically based on data interactions.

Builds receipts by replacing transaction data within templated files and converting them to a plurality of file formats.

### Handling Failed Transactions

Automatically captures and handles failed transactions.

Uses alert system to notify users of failed transactions.

Allows users to reprocess failed transactions.

### Initial Data Handling

Data Collection: Collects initial data from the database to pre-fill necessary information for the sales process.

The predictive income and expense feature stands out due to its unique predictive reporting feature, which not only covers active income and current expenses but also forecasts future expenses and income for specified periods. The system uses a plurality of dynamic factors to make these predictions. Having insights into expected income and expenses for upcoming periods allows for better business planning and efficient management of time off. This approach ensures that the business can anticipate financial needs and opportunities, facilitating more strategic decision-making.

The Data Assembly is a global system that enables interactive access for building queries and receiving responses within the software. It facilitates data entry without requiring page submissions, enhancing the software's automation capabilities. For example, during customer appointment scheduling, the end user can add a technician without navigating away from the current screen. Similarly, new equipment can be added directly within the appointment scheduling section, eliminating the need to switch screens. In the checkout process, the end user can add new products or services interactively without needing to access a specific submission screen. The Data Assembly system handles the requests and provides immediate responses, ensuring that data entries are permanent and not just session-specific. When new products are added, the system automatically communicates and synchronizes with other modules, such as the online accounting communications subsystem, ensuring data is accurately updated across the platform and other server systems.

A Recording Controller [178] is a unique feature that allows the end user to disable the automatic recording of sales data for any payment type into an online accounting software. There are several scenarios where recording a sale or payment type into the online accounting software might not be desirable by the end user. For example, during testing and learning phases, sales by any payment type should not be recorded into the online accounting system. Additionally, when multiple accounting systems are involved, the end user may prefer not to automatically record sales for a specific payment type into the online accounting software. If a payment type is disabled, the recording controller offers options during the checkout process to re-enable that payment type for a singular checkout, providing flexibility and control over the recording of sales transactions.

A Sales Tax Integration module controls the communication links between multiple APIs to determine the appropriate sales tax without the use of 3rd party addons. It interacts with the database to send calculated data to the tax service selected within the software. The integration retrieves the correct sales tax information and forwards it to the Calculation Algorithm Process for integration. The Sales Tax Integration supports integrations with online sales tax software, and it outputs a custom sales tax report for verification against these systems. This ensures accurate and efficient tax calculations and compliance across different platforms.

A dynamic fee module, called Smart Fee, is unique in that it controls the percentage based fee charged to the end user's clients on a per-transaction basis. The global administrator settings configure whether the Smart Fee will be dynamic or a static percentage. If the fee is set to dynamic, the Smart Fee algorithm in this module evaluates several factors and works directly with the Calculation Algorithm Process to determine if the fee should be automatically increased or decreased. At the end of each month, the system reviews the transactional data processed through the software. Based on this review, the parameters configured in the global administrator settings, and several other factors, the system dynamically determines the end user's percentage fee for the next month. This fee is locked in for one month. The fee cannot fall below the minimum percentage or exceed the maximum percentage set in the global administrator settings.

A Smart Fee system is uniquely designed to ensure end users can cover all necessary business services costs without reducing their gross revenue. This Smart Fee system adds a percentage fee to all the end user's customer transactions. These fees are used to cover costs such as online accounting, sales tax integration software, PBX and phone systems, IT support maintenance contracts, and other integrated expenses. End users have the option to disable the Smart Fee system, halting charges to their customers while still incurring the system smart fee charges. The system calculates the appropriate fee percentage through two processes:

### Default Base Setting

Configured in the global administration settings and not changeable by end users, this sets the initial fee percentage. For example, a 4% fee might be added to all transactions before tax and convenience fees.

### Algorithmic Adjustment

The system reviews various factors to adjust the fee percentage as needed. This ensures the fee remains within a set ceiling and floor (e.g., 5% ceiling and 2% floor), configurable by the highest-level system administrator.

At the end of each month, the system reviews the transactional data and adjusts the next month's fee based on the review and configured parameters. This fee is locked for one month.

### Example 1

Monthly retail integration services cost: $450

Transactions: 100 transactions at $100 each ($10,000 total)

Smart Fee: 4% ($400 total)

Weekly charge to credit card: $100

Monthly assessment: Additional $50 charged

Smart Fees collected were insufficient

Algorithm adjustment: Smart Fee Module automatically increased the fee to 4.50%

### Example 2

Monthly retail integration services cost: $450

Transactions: 250 transactions at $150 each ($37,500 total)

Initial fee: 4% ($1,500 total)

Weekly charge to credit card: $375

Monthly assessment: The system may lower the Smart Fee

Dynamic Smart Fees can be disabled in the global administrator settings, resulting in a static fee percentage.

The Smart Fee approach provides a flexible and automated method for managing the percentage fee associated with processing transactions through this software and ensures all business costs are covered without manual intervention from the end user.

### Checkout Process

The Checkout Process integrates with the Invoicing System, Credit Card Processing, Accounting Software, CRM, Email, and The Online Review System.

FIG. 27 illustrates a Checkout Process. The system includes numerous modules beginning with User Input [098], Marketing Module [104], Data Assembly [174], Management Interface [078], Alert System [102], PDF Conversion Module [086], Editing Module [080], and Error Verification and Handling Module [072]. The apparatus supports Invoice Verification System [158, a robust component within the integrated software system designed to ensure invoice accuracy and authenticity, Calculation Algorithm Process [050], Sales Tax Integration [182], and an Intelligent Data Creation Handler [076]. Template Edit Process [092], Template Storage [094], Email Module [066] and Email Generator [064], Online Review Controller [106], CRM Module [012], Payment Display [082], and Payment Processing Module [084] enhance communication and customer management. Database Handler [062] and Timer System [096] ensure operations, while Payment Verification and Processing Module [190], Online Accounting Communication Subsystem [172], Receipt Generator [176], Sales Recording System [180], and Recording Controller [178] further optimize business processes.

FIG. 28 illustrates a predictive income and expense report system. User Input [098] interacts with the Error Verification and Handling Module [072]. Valid input data flows to the Calculation Algorithm Process [050] or if errors or invalid data is discovered data flows to the Management Interface [078]. Data is processed from the calculation algorithm process by Database Handler [062] for storage and retrieval. The database handler will send data to the management interface.

### Online Accounting Integrations (OAI)

The accounting integrations allow for seamless data synchronization across multi-platforms. Item name and category, tax, sales and deposits are synced to multi-platform databases.

Point of Sale Items can be globally shared to other users of the software.

When creating deposits in online accounting software, multiple scenarios require a unique approach for that specific deposit to ensure proper reconciliation with banking records.

Two such examples are:

Single Transactions and Recurring Billing: An end user's customer has a single transaction and this results in a single payment. If it is in the form of a credit card then this is a single stored payment for that day. Depending on how many credit card transactions happen that day will depend on how many transactions are included in the deposit.

Recurring billing happens with several of the end user's customers in the same sales processing session typically involving several credit cards charged sequentially.

Non-Sales Deposits: This feature allows users to create deposits unrelated to sales transactions. These funds can be deposited into the end user's bank account, ensuring that accounting records are properly aligned with bank records.

### OAI Failed Receipts

Online accounting failed sales and refund receipts can happen for a plurality of reasons. The failed receipt section is designed to automatically capture those failed receipts and allow the end user to recreate those receipts from a single interface without having to open the online accounting software. End users are notified of failed receipts such as an alert banner.

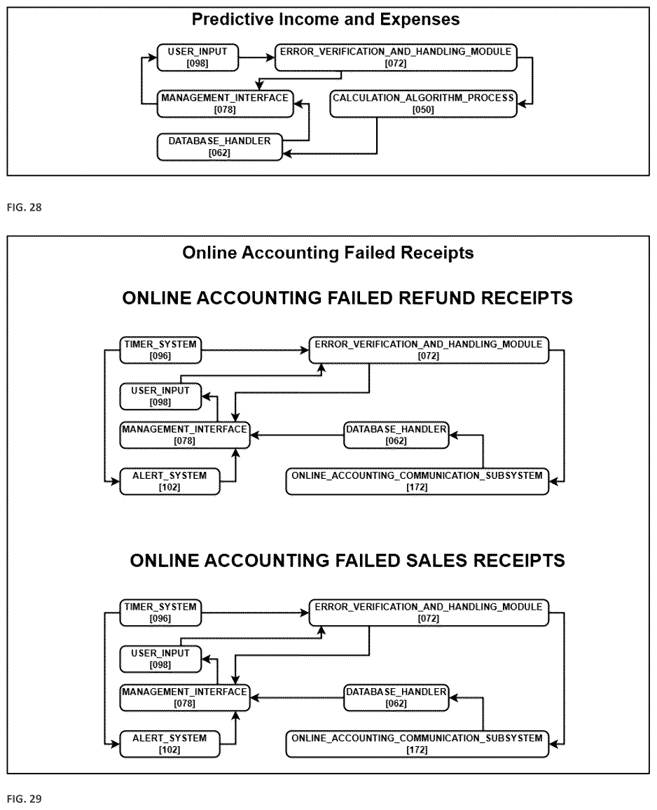

FIG. 29 shows a module to handle Online Accounting Failed Receipts for refunds and sales. Positioned centrally in the flow are key components such as the Timer System [096], User Input [098], Management Interface [078], Alert System [102], Database Handler [062], Online Accounting Communications Subsystem [172] and Error Verification and Handling Module [072]. The upper and lower sections of the diagram reflect redundancy and symmetry in the architecture for robust operational performance.

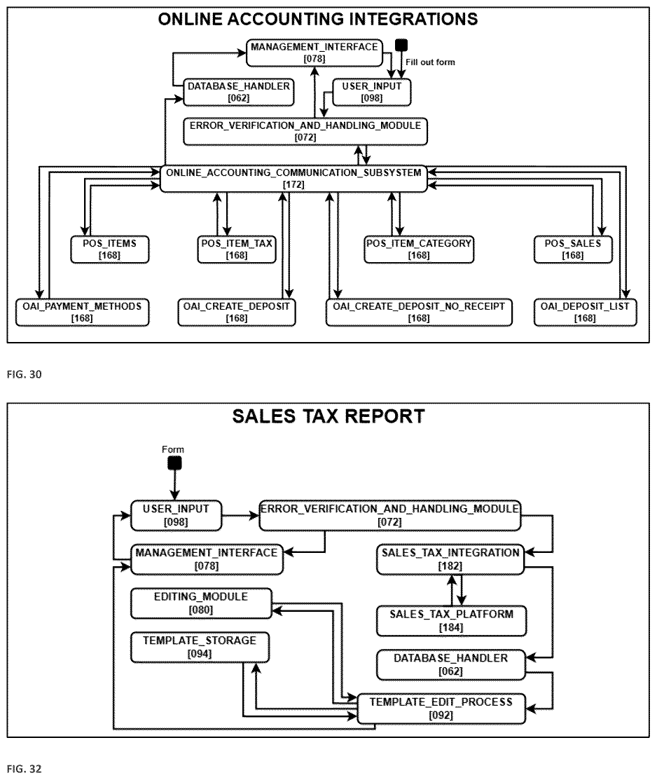

FIG. 30 presents an organized hierarchical diagram showcasing an integration with an online accounting software. Beginning with and User Input [098] sending data to Management Interface [078] at the top of the hierarchy, which receives data from the Database Handler [062] and Error Verification and Handling Module [072], which, in turn, interfaces with the Online Accounting Communication Subsystem [172]. The online accounting communications subsystem distributes various point of sale (POS) data to external software platforms all labeled as 168 to denote external software integration, such as POS Items [168], POS Item Tax [168], POS Item Category [168], and POS Sales [168]. The online accounting communication subsystem further connects multiple OAI-related processes such as OAI Payment Methods [168], OAI Create Deposit [168], OAI Create Deposit No Receipt [168], and OAI Deposit List [168]. All paths are clearly labeled with reference numerals to denote their functionalities within the system.

These features collectively make the Sales Processing System a novel and comprehensive solution for managing sales transactions, ensuring accuracy, flexibility, and efficiency in payment processing, customer management, and integration with external systems within the business environment. The Sales Processing System leverages advanced techniques to optimize performance and ensure efficient data handling. Data access patterns minimize database joins, and the system can reduce computational complexity of operations, leading to faster data retrieval and improved efficiency. Utilizing multithreading techniques, the system can process multiple payment transactions simultaneously, significantly increasing throughput and reducing processing time. Data synchronization can maintain consistency across distributed systems through the use of transaction logs and incremental updates, minimizing data transfer and ensuring up-to-date information without imposing excessive load on server resources. These optimizations collectively can enhance the system's performance, reliability, and scalability.

### Vendor Store

The Vendor Store introduces an innovative method for vendors to register, verify, and sell their products to a broad customer base through an integrated and secure platform. This system is characterized by several capabilities:

### Advanced User Interface and Experience

Provides a clean, intuitive dashboard for managing products and purchases, with notifications and progress tracking for vendor registration and verification.

Features interactive elements like forms with validation and error highlighting, and visual indicators for pending, verified, or rejected vendor applications.

### Comprehensive Store Products and Purchasing Management

Displays a product list provided by registered and certified vendors, with detailed product information on a purchasing page.

Manages store checkout procedures allowing end users to purchase goods, verifying payment information, and handling errors.

Ensures accurate transactions and rewards by processing data through a system that manages product list data, product details, and store checkout transactions.

### Advanced User Interface and Experience for Purchasing Goods

Provides a clean, intuitive interface for browsing and purchasing products, presenting key information such as transaction history and available purchase rewards in a user-friendly manner.

Displays detailed product information provided by registered and certified vendors on a purchasing page, ensuring users have all necessary information to make informed decisions.

Includes a sophisticated purchase rewards system where users earn vendor store purchase rewards based on their total customer transactions processed through the software. Increased platform usage for transaction processing results in the accumulation of more purchase rewards.

Allows users to utilize accumulated purchase rewards over a predetermined amount of time, thereby reducing their smart fees over time and providing a tangible benefit for their ongoing engagement with the platform.

Utilizes visual indicators to highlight critical information, including error messages, payment verification statuses, and purchase rewards eligibility.

Recommends products that are highly relevant to the user's industry, enhancing the shopping experience by offering targeted suggestions instead of random listings. This ensures users find products that best meet their specific business needs.

### Sophisticated Purchase Rewards System

Initiates a timer countdown to automatically manage purchase reward period completion.

Assesses product eligibility for the purchase reward system.

Determines purchase rewards product eligibility.

Determines individual reward amounts that consider the user's transaction volume with the user's customers.

Review and adjustment of purchase rewards recurring at a predetermined amount of time based on the user's accumulated gross sales transactions, providing feedback on changes in reward status.

### Security Measures and Settings

Enforces secure data transmission, with mandatory multi-factor authentication (MFA) for all users.

### Error Verification and Handling

Identifies various types of errors, including data validation, authentication, transaction, and system errors.

Logs these errors for analysis, providing feedback to necessary parties.

The Vendor Store utilizes a dynamic Purchase Reward Program designed to enhance end-user satisfaction and loyalty. Vendors list their products on the platform, and end users make purchases, with the system automatically handling payments and vendor fees. The Purchase Reward Program offers up to a maximum qualified reward amount for each product purchased, reducing the collected smart fee until the total reward is fulfilled. The system determines the maximum reward based on the end user's rolling 12-month profit and their ability to cover integrated service fees. Users need to generate sufficient transactions to cover their service fees and qualify for rewards. Purchases are verified through secure payment methods. This program aims to ensure that end users benefit from reduced costs over time, promoting sustained engagement and financial efficiency.

For example, estimating an average transaction of $90, an end user needs to achieve $11,250 in transactions per month, equating to 125 transactions or six transactions per working day, to cover the cost of integrated services through smart fees. End users must generate 30% above the retail cost of their selected integrated services to qualify for rewards. For instance, if an end user makes $15,000 in annual profit, they won't receive rewards. An end user with $25,000 in gross sales, translating to a $15,000 profit, and incurring $450 monthly in integrated service fees, will not see rewards if their smart fees fall short.

In a scenario with $14,625 in monthly gross transactions, 163 transactions per month, and $585 in transaction fees, the user would have $135 surplus after covering service costs. This surplus would total $1,620 annually. The global settings can configure a default of 10% rewards, allowing up to $162 in deductions over 52 weeks. If the user leaves before the full deduction, they forfeit the remaining rewards. If an end user makes $2,000,000 in annual gross sales with an average transaction amount of $10,000, the scenario would look as follows:

Example 2 extrapolates the amount above from a service worker with an average sale of $90.00 to be an end user with a much higher transaction amount, such as an attorney.

### Monthly Transactions

Monthly gross transactions: $166,667

Average transaction amount: $10,000

Number of transactions per month: 16.67 (rounded to 17 for practicality)

Number of transactions per working day (assuming 22 working days): ~0.77 (rounded to 1)

### Integrated Service Fees

Assuming the integrated service fees remain at $450 per month.

### Smart Fee Calculation

Monthly transactions: $166,667

Smart fee percentage: 4%

Monthly smart fees collected: $166,667*4%=$6,667

### Surplus Calculation

Monthly service fees: $450

Monthly surplus after service fees:

$6,667−$450=$6,217

Annual surplus: $6,217*12=$74,604

### Rewards Calculation

Default rewards percentage: 10%

Maximum annual rewards:

$ 74,604*10%=$7,460.40

Weekly rewards: $7,460.40/52=$143.47

Summary: For an end user with $2,000,000 in annual gross sales and an average transaction amount of $10,000, they would need to perform approximately 17 transactions per month, or about 1 transaction per working day. With monthly smart fees collected amounting to $6,667 and monthly service fees of $450, they would have a surplus of $6,217 per month. Annually, this surplus totals $74,604, allowing them to receive up to $7,460.40 in rewards, equivalent to $143.47 per week. If they leave the software before the full reward reduction is completed, they forfeit the remaining rewards.

Automatic Vendor Registration and Verification Process includes automatic verification to ensure vendors meet the necessary requirements to post products on the platform. This method leverages a robust vendor verification system with vendor verification requirements such as:

Established business for at least 2 years

Active status under their registered LLC, S Corp, or C Corp

Active EIN

The Verification Process includes

Data Submission: Vendors submit their business details during registration.

API Integration: The system connects with several APIs to verify the submitted data, ensuring the vendor is legitimate, active, and established such as:

Equifax API: Used for comprehensive business verification.

OpenCorporates API: Used for business status verification (excluding EIN checks).

The automatic vendor verification ensures that only qualified, verified vendors can list their products, maintaining the integrity and reliability of the platform.

This invention now will be described more fully hereinafter with reference to the accompanying drawings, in which exemplary embodiments are shown. Various embodiments are now described with reference to the drawings, wherein such as reference numerals are used to refer to such as elements throughout. In the following description, for purposes of explanation, numerous specific details are set forth in order to provide a thorough understanding of one or more embodiments. It may be evident, however, that such embodiment(s) may be practiced without these specific details. In other instances, well-known structures and devices are shown in block diagram form in order to facilitate describing one or more embodiments.

This system may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure). Thus, for example, it will be appreciated by those of ordinary skill in the art that the diagrams, schematics, illustrations, and the such as represent conceptual views or processes illustrating systems and methods embodying this invention. The functions of the various elements shown in the FIGS. may be provided through the use of dedicated hardware as well as hardware capable of executing associated software. Similarly, any switches shown in the FIGS. are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named manufacturer.

### Automatic Vendor Verification

Vendor Verification for the Vendor Store is detailed next. This process involves the registration, automatic verification and approval process of the vendor.

Automatic vendor verification connects with a plurality of online software platforms and verifies submitted data ensuring the vendor is a legitimate, active, established and registered business.

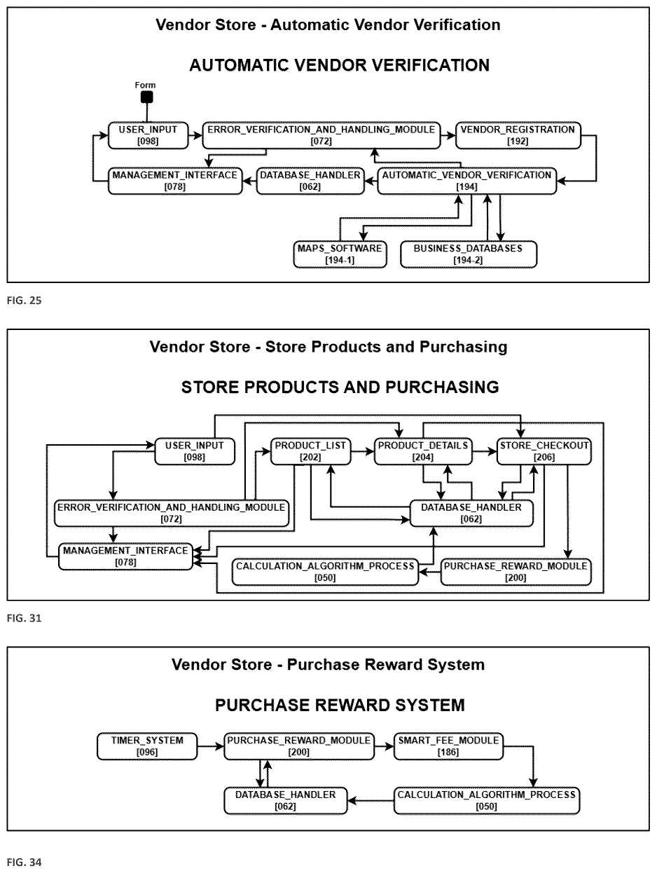

FIG. 25 delineates the process for automatic vendor verification. User Input [098] sends data to the Error Verification and Handling Module [072] which, after verification, sends data to Management Interface [078] or Vendor Registration [192]. Vendor registration sends data to Automatic Vendor Verification [194] which works with Maps Software [194-1] and Businesses Databases [194-2] for verification and sends data to Database Handler [062].

### Purchase Reward Module

The system determines if a product sold by a vendor qualifies for purchase rewards.

FIG. 31 displays a vendor store products and purchasing diagram. User Input [098] interacts with Error Verification and Handling Module [072] or Store Checkout [206]. The error verification and handling module interacts with the Management Interface [078], Product List [202] and Product Details [204]. The store checkout sends data to the Purchase Reward Module [200] which sends data to the Calculation Algorithm Process [050]. The Database Handler [062] interacts with a plurality of systems and modules within this diagram.

FIG. 34 illustrates a flowchart of interactions within an integrated software system with purchase rewards. The Timer System [096] sends data to the Purchase Reward Module [200] which then communicates with the Smart Fee Module [186] sending data to the Calculation Algorithm Process [050]. The Database Handler [062] communicates with both the purchase reward module and the calculation algorithm process.

### Purchase Reward System

The purchase reward system is integrated into the vendor store. End users require products. Vendors list products. End users purchase products. Each purchase may qualify for purchase rewards. Purchase rewards are used to reduce the total cost charged for integrated software services selected by the user. Smart Fee collections would be reduced allowing the user to maintain a portion of the smart fee collected funds as a reward for purchasing from the vendor store.

User purchase rewards based on the total gross amount of transactions processed through the software.

### Example

Estimating figures for each user such as:

Average transaction: $90

Reward Qualification percentage: 30%

Integrated service cost: $450.00

Smart Fees (static): 4%

Working days in a month: 22

All end user customer sales transactions must be processed through the software to count towards purchase rewards qualifications in the vendor store.

For Smart Fees to fully pay for integrated services and qualify for purchase rewards, requires around $15,840 in transactions per month, or 176 transactions, or 8 transactions per working day.

The rewards module completes an assessment and automatically increases or decreases the rewards available based on the accumulated gross sales from the end user customer's sales transactions processed through the software.

These features collectively make the Vendor Store a novel and comprehensive solution for vendors to efficiently register, verify, and sell their products, while providing a secure, user-friendly, and reward-based shopping experience for end users.

### Global Components and Modules

An Email Generator [064] is globally responsible for ensuring the proper formatting of all emails leaving the system. The email generator's job is to ensure that all requirements of an email are accurately combined to greatly increase the success of a delivered email.

An Email Module [066] works directly with digital communication. If an email form is required for a specific module, that module requests data from the email module and the email module will choose which template to use. It will send that information to the Management Interface [078] to appear in front of the user.

Equipment make and equipment type sections are global or individual areas. The entries within these areas can be shared with other users. If the user would like to receive and choose from global entries in the section, then they will also be required to share entries for which they provide. In this section, the end user can choose which entries will appear within their software when they are filling out the create appointment section. Items that would be within the equipment make area would be the manufacturers of equipment such that the categorical service type business would utilize. For example, a computer service business would use HP, Dell, Asus, Custom build, Apple, Sony and other manufacturers and desktop, laptop, tablet, custom build, apple, printer and other product type equipment. Users have the ability to delete or disable entries from their software only. Deleting or disabling entries will not affect other users on the platform.

### Common Messages

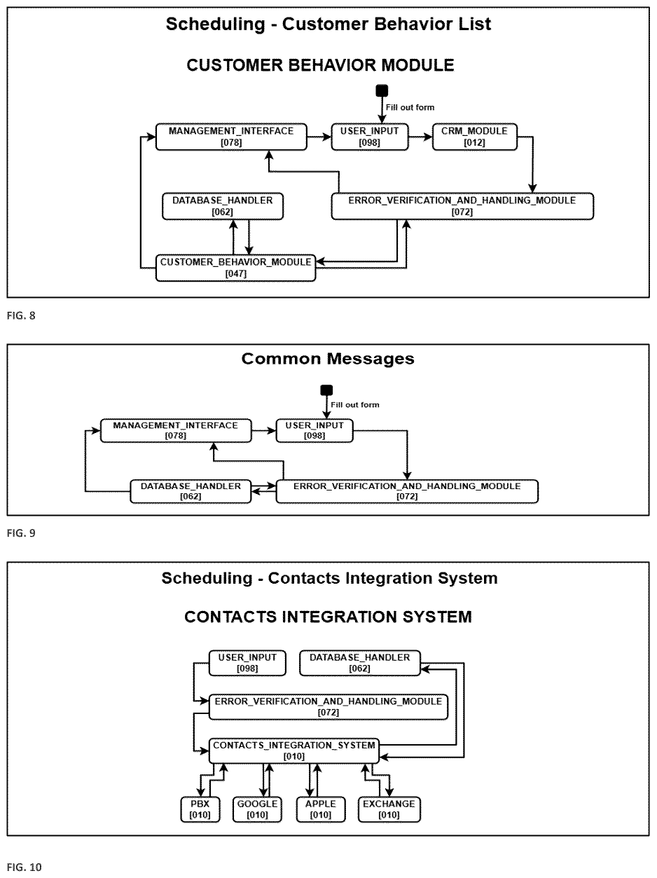

FIG. 9 depicts a process flow for handling common messages in the system. The process starts with the User Input [098], which collects data and interacts with the Management Interface [078]. This data is then processed and stored by the Database Handler [062]. The system also involves an Error Verification and Handling Module [072] to ensure data accuracy and address any issues that arise during the form submission process.

Common messages are a method to allow near full customization of the software for the end user. The common messages allow the end user to customize areas in the software shown on the screen to more user-friendly terminology.

### Customer Behavior

The customer behavior list introduces a comprehensive and innovative approach to managing undesirable customers within a service business software system. This system is characterized by several capabilities:

### Global Integration and Sharing

The customer behavior list is a globally integrated system designed to safeguard businesses by preventing the scheduling of appointments or the creation of contracts with customers deemed less reputable. This shared network of information enables businesses to make informed decisions by providing alerts about potentially problematic customers based on collective feedback and experiences from other users within the same software ecosystem.

Users can add their customer to a customer behavior list, also known as a bad customer list.

### Detection System

The system detection methods match entered customer information with the customer behavior list, ensuring accurate identification even when certain details, such as last name or phone number, have changed. By cross-referencing multiple data points, such as name, email address, physical address, and phone numbers, the system effectively identifies potential matches.

### User-Generated Comments and Alerts

Users have the ability to add comments when adding a customer to the customer behavior list, with the option to share these comments globally. When another business attempts to schedule an appointment with a customer identified on the list, they receive an alert displaying the shared comments and the number of businesses that have flagged that customer. This feature provides critical insights, enabling businesses to make informed decisions before engaging with the potential customer.

### Management and Security

The customer behavior management interface allows users to manage only the customers they have added to the list, ensuring control and security.

A verification method can be enabled to edit or remove submitted data from the customer behavior list.

### Expiration of Customer Entries

The customer behavior list retains entered information for a predetermined period of time or until the original submitter removes it from the list or discontinues use of the software. If a submitter discontinues use of the software, the information submitted is automatically marked as expired after a predetermined period of time.

### Prevention of Business Interaction

The system prevents the original business that added the customer to the customer behavior list from scheduling appointments or creating contracts with that customer until the information is removed from the list or an override is provided.

Other users of the system will receive an alert when a match is found.

### Customizable Alerts and Notifications

Users have the flexibility to disable alert messages for individual customers. This customization ensures that the alert system is tailored to the specific needs of each user.

These features collectively make the customer behavior list a novel and comprehensive solution for managing customer interactions, ensuring better business decisions, and enhancing overall operational efficiency. Different businesses share an optimized and singular customer behavior list instead of maintaining a separate customer behavior list. By utilizing this global approach, it provides faster search results through a common shared platform when a different business adds an individual to the customer behavior list. For example, instead of 100 businesses adding the same customer to their separately maintained customer behaviors lists, there is a singular globally maintained customer behavior list from which to dynamically query and obtain search results for all users.

FIG. 8 illustrates the flow and interaction of various modules within the integrated software system to manage accounts based on customer behavior. It shows a sequence of processes containing the Management Interface [078], User Input [098], CRM Module [012], Database Handler [062] and an Error Verification and Handling Module [072].

The customer behavior list prevents the end user from accepting a potential customer as an official client. The software determines if an end user's potential customer is the same individual or business that another end user of the software has placed on the customer behavior list, even if the individual or business has changed address information or the customer has the same name as another customer. If a match is determined, an alert is provided to the user via a global alert message system. This system allows the end user to make an informed decision before officially accepting that customer.

### Customer Behavior Management Interface

A customer behavior management interface allows the end user to manage only their customers for which they have added to the customer behavior list. They cannot manage customers that have been added to a list by another user.

### Calculation Algorithm Process

The Calculation Algorithm Process [050] is where all the complex coded calculations occur. Any module for which requires a calculative process calls upon the calculation algorithm process.

### Client Management

The client management interface provides the ability to edit or disable every user in the end users client list.

### Company List

The company list allows the end user to disable a company name within their client database.

### Contacts Integration

The contacts integration automatically creates new, updates or removes contacts from the end user's selected contact list. This contact list is designed to integrate with the end user's current preferred contact list allowing contacts to show up directly on their mobile phone contact list or an internal contact list. Contacts added through the software will be preceded with a configurable keyword phrase, for example “Client” or a custom name for personal contacts such as “Mom”. For example, if a business named Vandelay Enterprises is added to the software, this contact would be displayed automatically into the end user's preferred contact list as Client Vandelay Enterprises. Likewise, if a non-business client named John Smith is added to the software, the contact in the end user's preferred contact list would be displayed as Client John Smith.

FIG. 10 illustrates the contact integration system. The process starts with User Input [098] and the Database Handler [062]. Following this, the Error Verification and Handling Module [072] ensures data integrity and accuracy. The Contacts Integration System [010] is crucial for managing contacts, interfacing with various external systems such as PBX, Google, Apple, and Microsoft Exchange to name a few. These connections facilitate communication and data exchange between the integrated software system and these external platforms.

The SoloBoss software verifies the data matches between both systems. If the data does not match, it syncs the data between both the contact and SoloBoss systems deciphering which item to keep when conflicts occur. The contact software syncing flow chart displays how to synchronize contacts between various software platforms, including Google, iCloud, PBX and Exchange contacts.

### Credit Cards

The credit card interface allows the end user to add or remove credit cards for their customers without saving the credit card information to the software's internal databases.

UPDATING CREDIT CARD INFORMATION: The process for updating credit card information within the SoloBoss system involves entering and verifying the credit card details with an online payment processor. This ensures that the system maintains accurate and up-to-date payment information.

FIG. 11 illustrates credit card processing data flow. The Management Interface [078] is linked to the User Input [098] and Payment Verification and Processing Module [190]. Additionally, the database Handler [062] and Error Verification and Handling Module [072] interact with user input. The Customer Behavior Module [046] alerts the end user of customer behavior allowing the user to decide an acceptable payment method for that client. These modules work together to offer a comprehensive and streamlined approach ensuring that the integrated processes are managed efficiently and accurately.

### Database Handler

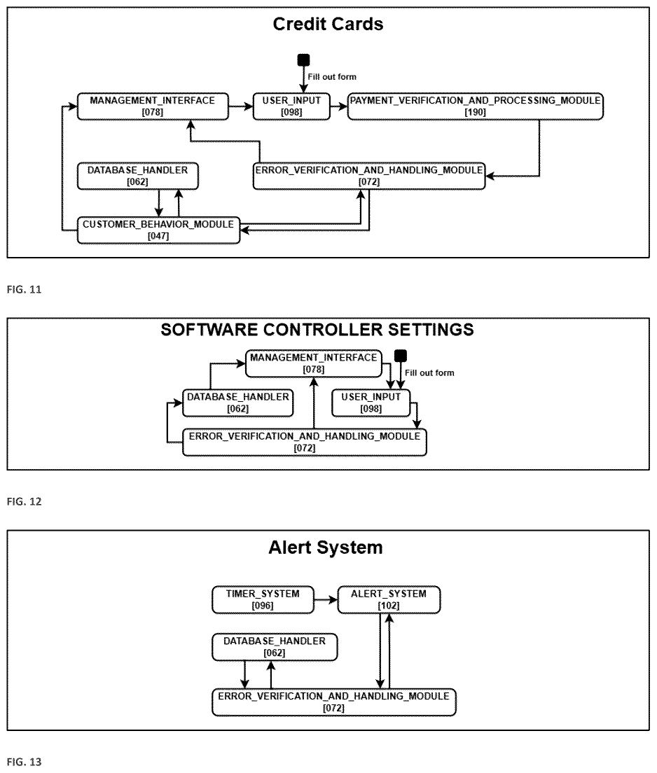

FIG. 12 depicts software controller settings. Data entry is completed through the Management Interface [078]. This interface is supported by three main subsystems: Database Handler [062], User Input [098], and Error Verification and Handling Module [072]. The database handler manages data storage and retrieval, while the user input processes the data entered by users. The error verification and handling module ensures the data integrity and error-free operation of the system.

### Template Edit Process

The Template Edit Process [092] is responsible for obtaining the correct template file from Template Storage [094] and sending the file and the data to replace the keyword phrases located within the file to the Editing Module [080]. This process retrieves the edited file and sends it to the PDF Conversion Module [086]. The PDF conversion module returns the PDF file back to this process and the process sends it to the Receipt Generator [176].

### Template Storage

The Template Storage [094] handles the file transition for storing end user's uploaded files. The template storage handles requests from the Template Edit Process [092] and processes those requests with the requested file. The template storage works with long-term internal storage on the server and API's for long-term end user cloud storage.

### Timer System

The Timer System [096] controls the scheduling of notifications, Alert System [102] and time sensitive matters. It is programmed to allow for segregated and unique timers for each end user. Each system that needs a timer system has unique requirements necessary to perform critical tasks for the end user. The timer system ensures these critical tasks are performed automatically.

### User Input

User Input [098] is the main interface between the end user and the web page. It allows for the submission of entered data to be distributed between all the systems, modules, processes, and subsystems. This data entry is facilitated through the Fill Out Form interface, where users input necessary information into predefined forms.

### User Profiles

The user profile section allows for adding, removing or editing the information for the users. This section allows for assigning roles to each user for limiting their capabilities within the software.

### Alert System

The Alert System [102] is a reminder system. Generates alerts based on specific triggers and conditions, ensuring users are promptly informed of any issues. An alert can be set, for example, as a uniquely colored banner kept at the top of the web page displaying the message with hyperlinks so the user can easily remember when a task needs to be accomplished.

FIG. 13 depicts Alert System [102] data flow. The system includes a Timer System [096], an alert system, a Database Handler [062], and an Error Verification and Handling Module [072], illustrating how these components interact to provide robust functionality by managing time, issuing alerts, handling database operations, and verifying and addressing errors.

FIG. 39 shows two Global System Software Components including the Subscription System and Common Messages. The subscription system includes the Management Interface [078], User Input [098], Error Verification and Handling Module [072], Database Handler [062], Subscription Module [091], Smart Fees [188].

The Common Messages includes Filling out a form, Management Interface [078], User Input [098], Error Verification and Handling Module [072], and Database Handler [062].

The subscription system manages and tracks the services or goods that users have subscribed to within the software. It facilitates the retrieval of pricing for these subscribed services, ensuring accurate and efficient billing. Subscriptions can be applied to both internal and external modules integrated within the software, offering flexibility and scalability.

Some examples of services managed by the subscription system include: Backup Billing, IT Support Contracts, Marketing URLs, PBX Systems, Online Accounting Integration, Payment Processing, Subtitle Translation, Text Translation.

This system ensures seamless management of subscriptions, providing a streamlined approach to service delivery and billing across multiple platforms.

Common messages are a method to allow near full customization of the software for the end user. The common messages allow the end user to customize areas in the software shown on the screen to more user-friendly terminology.

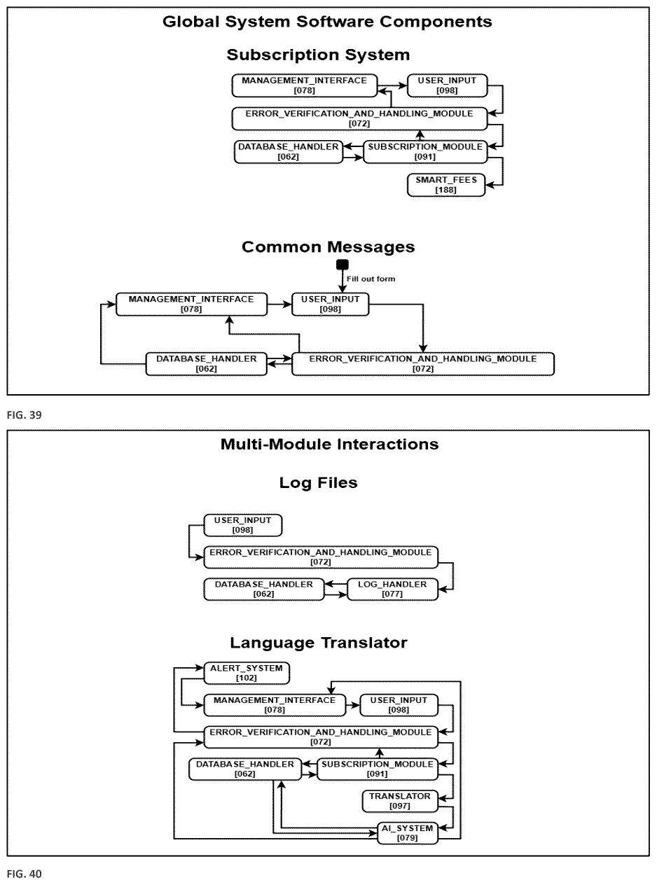

FIG. 40 displays a flow chart for two components involved with Multi-Module Interactions; the audit Log File and Language Translator interact with all required modules, subsystems and components within the software system. The log files provide a detailed overview of data transition and event logging happening within the system while the language translator provides detailed language interactions between the management interface and other components for which are shared between users.

The Log Files includes interactions between User Input [098], Error Verification and Handling Module [072], Log Handler [077] and Database Handler [062].

The Language Translator includes Alert System [102], Management Interface [078], User Input [098], Error Verification and Handling Module [072], Subscription Module [091], Translator [097], AI System [079] and the Database Handler [062].

### Other Modules

An Error Verification and Handling Module [072] has one of the most important jobs inside the software. This verifies all communication throughout the software is accurate and does not contain errors. It logs all errors that happen and notifies the software administrators of these errors. It verifies all requests are properly formatted for expedience and proper responses. This module has the responsibility to verify all requests are legitimate in nature before the database is contacted.

An Intelligent Data Creation Handler [078] is a key component to the automation software. This handler configures and stores data in a variety of locations in accordance with all of the limitations those locations have for data storage. Manually storing this data takes an absorbent amount of time and requires someone to know how to work each piece of software. The intelligent data creation handler is programmed with the limitations of each connected piece of software and knows exactly where to place the data within the constraints of each section. For example, one credit card processor might only allow 50 characters of data in their notes section while another credit card processor allows 75 characters. The formatting of one credit card processor's requirements may not be the same as another. The CRM needs to distinguish between a business customer, an employee of that business and the business owner so it knows where to automatically and properly put the notes and keep track of all the transactions. The intelligent data creation handler deciphers and sorts the transaction logs, notes, titles, and details to the correct place. For example, if an employee of a company is calling the service company for a personal home appointment and they are also the point of contact for a company, or it is a business owner working out of their house, a personal appointment at a business owners brick and mortar address, or even a business paid appointment at another location. As another example, Quickbooks Online has several places within its software for which to store notes, titles, sales items, service items, sales tax, and more. Each area within Quickbooks Online has its own limitation to how many characters are allowed within that specified area. The intelligent data creation handler automatically and properly communicates with the software and API's, stores all of the data within the character limitation and proper formatting of each section in all the connected or integrated software and ensures that all areas contain the proper information in a readable format.

The Management Interface [078] is the graphic user interface interaction between the user and the software. Its purpose is to allow the user to provide interactive input and receive responses to requests.

An Editing Module [080] supports the editing of .docx and .xlsx files from a website hosted on a Linux based server computer. Windows-based server computers natively support the opening and editing of those types of files via a programming language. Linux based servers do not know how to read those types of files and so they do not natively support the opening and editing of those files. It is possible to locate Linux based websites that can use a programming language to upload those types of files to their server, extract the text from those files, then convert text to a different file type, such as PDF, these websites do not support the editing of these files as that changes the composition and words within the file and then saving these files as the same file type. Those websites only allow converting the exact file to another file type when a website that is hosted on a Linux based server computer. The editing module allows for the opening, composition change or editing of those files and saving as the same file type prior to converting that file type to a PDF file.

A Payment Display Module [082] displays end user's client's payment methods on file and available within the payment processor's encrypted system. There is no direct payment information stored within the databases providing additional payment security for the end user's clients.

A Payment Processing Module [084] is in charge of communicating with the selected API for the payment processor. In the examples we provided, we have used the Square payment processor. However, any supported payment processor may be selected for the end user to process their payments. This module provides the automatic sending of payment details to the API for the selected payment processor for the associated credit card for the end user's customer's payment on file with the payment processor.

A PDF Conversion Module [086] is a global feature that enables the system to convert files to PDF format and temporarily store them on the server. This module includes a self-cleanup mechanism that automatically removes the PDF files from the server after they are no longer required, ensuring efficient use of storage resources. The self-cleanup portion of this software keeps the server from becoming overloaded with unnecessary PDF files.

A Pricing Controller [088] allows the end user to disable the Smart Fee that is charged to their clientele. The fees are still calculated and charged to the end user, but they are no longer passed to the end user's client or displayed on any of the transactional receipts.

A settings section is the front controller for the end users automatic archiving status, time zone, working hours, end of warranty if a warranty is provided to the end users customers, the company details, the online accounting software integration details, refund details whether refunds happen on shipping, discount deal details on whether hardware parts are also discounted or just services, down payment details for invoicing, the email reminder setting for how many days in between email reminders for invoices, the default state, sales tax reminder notification, invoice email notification date, the end user's fee settings if they charge any, unpaid appointment notifications, and the number of previous years shown for the income and expenses.

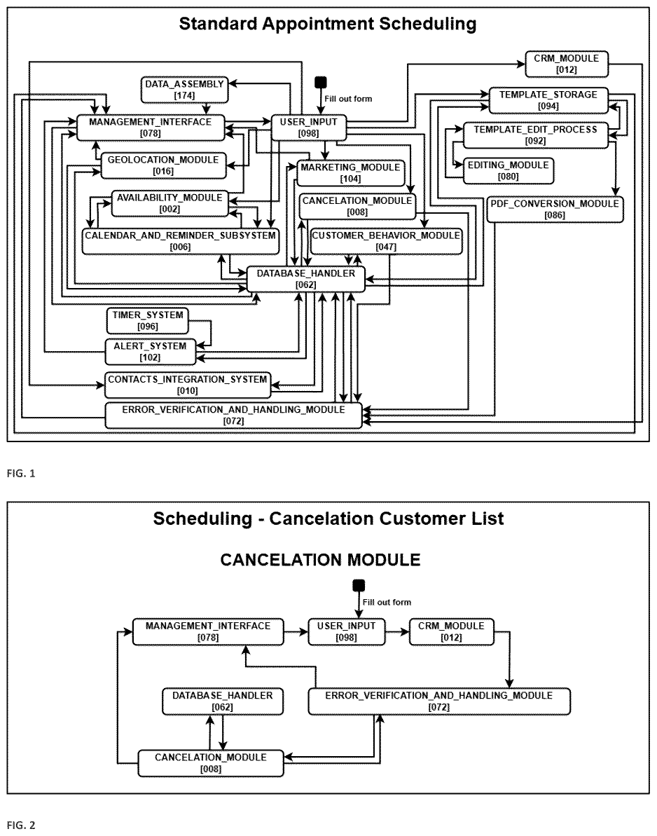

FIG. 2 illustrates an instance of the system's functional modules for scheduling and cancellation of appointments. This instance includes a Management Interface [078], User Input [098], and a Customer Relationship Management (CRM) Module [012] at the top. Below them, Database Handler [062] and Error Verification and Handling Module [072] are positioned centrally and in communication with a Cancelation Module [008].

The CRM (Customer Relationship Management) Module [012] serves as the central hub for all customer-related interactions and data management within the integrated software system for efficient resource management and appointment scheduling. This module is intricately designed to streamline communication with clients, maintain detailed records of client interactions, and optimize the customer relationship process, contributing to an enhanced user experience and improved outcomes. The CRM Module maintains a comprehensive database of client information, including contact details, communication history, transaction records, preferences, and notes from previous interactions. It systematically tracks all forms of communication, whether through emails, phone calls, or direct messaging, ensuring that all customer interactions are recorded and easily accessible for future reference. The CRM Module interfaces with the Appointment Scheduler [001], facilitating the scheduling, rescheduling, and cancellation of appointments. It automatically updates client profiles with upcoming appointment details and history. Integrated with the Marketing Module [104], the CRM Module supports targeted marketing campaigns by segmenting customers based on behavior, demographics, and purchase history, enabling personalized communication. The Database Handler [062] interfaces with the system's database to perform various functions necessary for efficient data management. The following are the core functionalities of the Database Handler [062]. The database handler facilitates the storage of all types of data entered through User Input [098], including appointment details, client information, payment records, and other relevant business operational data. It also retrieves this data upon request by other modules, such as the CRM Module [012] or the Appointment Scheduler [001]. By incorporating the Error Verification and Handling Module [072], the database handler ensures the integrity and consistency of the stored data. It checks for any discrepancies or anomalies in the data being entered or retrieved and handles them according to predefined protocols. The database handler can process complex queries from the Management Interface [078] or other subsystems like the reporting tools, ensuring quick and accurate access to the required information. As an integral part of the integrated software system, the database handler acts as a conduit for communication between different modules. For instance, it passes data from the Contacts Integration System [010] to the Calendar and Reminder Subsystem [006] for appointment scheduling and tracking. This improves the computer performance.

The Error Verification and Handling Module [072] functions as a subsystem designed to identify, verify, and resolve errors within the integrated software system. Its operations are pivotal for ensuring the reliability and stability of the entire apparatus, particularly when managing large volumes of data and interactions that could be prone to discrepancies or conflicts.

The Cancellation Module [008] is an integral part of the Integrated Software System for Efficient Resource Management and Appointment Scheduling. This module interacts with several components of the system to facilitate the cancellation of appointments and manage the associated ramifications within a business' scheduling and resource allocation framework. Operationally, the Cancellation Module [008] receives input from the Management Interface [078], which in turn may receive instructions directly from User Input [098] or through automated triggers defined by the CRM Module [012]. Upon receiving a request for appointment cancellation, the Cancellation Module [008] first verifies the legitimacy and validity of the request using the Error Verification and Handling Module [072] to prevent unauthorized or erroneous cancellations. Once validated, the Cancellation Module [008] proceeds to update the Availability Module [002] to reflect the change in the schedule, effectively freeing up the previously allocated time slot and making it available for new appointments. This action is synchronized across the integrated system, updating all relevant interfaces including the Calendar and Reminder Subsystem [006], ensuring the appropriate users are informed of the cancellation. In parallel, the Cancellation Module [008] communicates with the Database Handler [062] to log the cancellation details for record-keeping and future analysis. This data can be utilized by the analytics components of the system, such as the Data Assembly [174], to generate insights on cancellation trends, which can further aid in decision-making and operational adjustments.

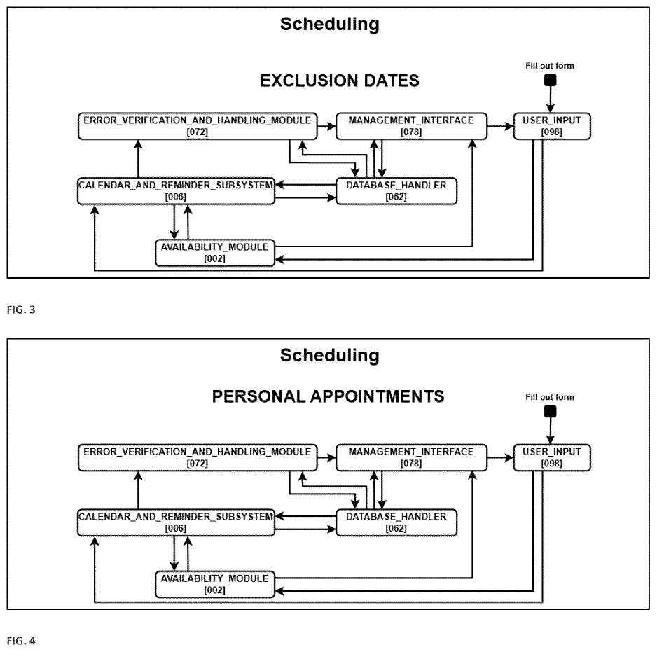

FIG. 4 uses the modules of FIG. 3 for scheduling personal appointments. At its core, the system includes an Error Verification and Handling Module [072], a Management Interface [078], and User Input [098]. Additionally, there is a Calendar and Reminder Subsystem [006] connected to both the Availability Module [002] and the Database Handler [062], emphasizing the interrelation of time management and data storage.

### Sales Tax Integration and Reporting

The sales tax reporting system is intended as a checks and balances system ensuring sales tax being reported by the sales tax agencies is accurate.

The report is created from all transactions processed by the end user through the software.

If reporting a payment method has been disabled, the Recording Controller [178] prevents payments using that payment method from appearing on the sales tax report.

The sales tax system integrates with an online Sales Tax Platform [184].

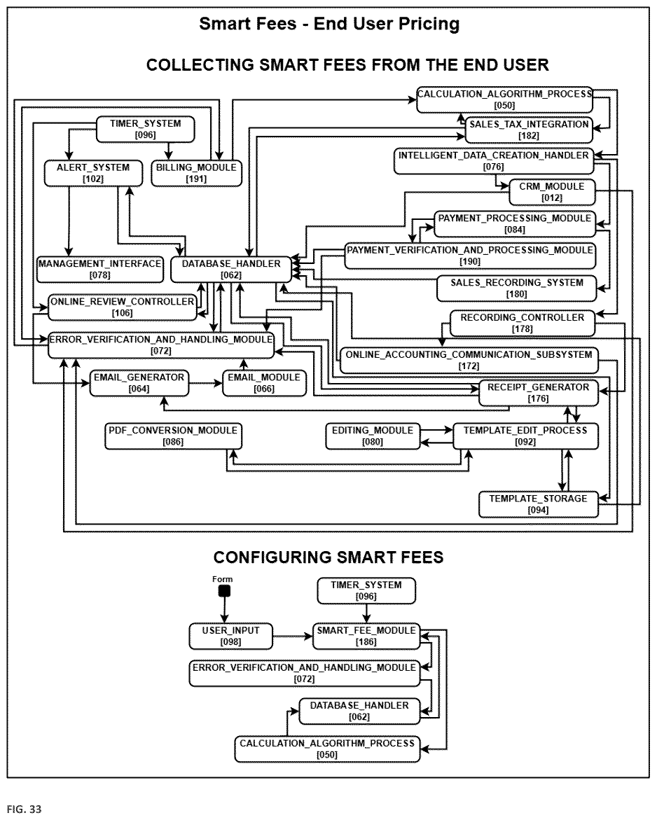

FIG. 32 illustrates an integrated software system for Sales Tax Reporting. Input is received from a “Form” and data is sent to User Input [098] which sends the data to be checked for validity in the Error Verification and Handling Module [072]. If any errors are detected, a response is sent to Management Interface [078]. The Management Interface sends data back to user input. If no errors are detected, data is sent to Sales Tax Integration [182], which interacts with the Sales Tax Platform [184] and sends the returned data to Database Handler [062]. The database handler sends data to Template Edit Process which sends data and receives data from Template Storage [094] and Editing Module [080] prior to sending data back to the management interface. The FIG. highlights the interconnected nature of the modules within the software system, emphasizing their roles in sales tax integration.

### Smart Fee Module

The Smart Fee Module [186] controls the fee for which the end user's customer is charged on a per transaction basis. Smart Fees [188] can be configured for a dynamic or static percentage. If the fee is set to dynamic, smart fees reviews a plurality of factors and works directly with the Calculation Algorithm Process [050] to determine if the fee must be increased or decreased.

Periodically, within a predetermined time, the Smart Fee Module [186] reviews the transactional data processed through the software for each user to determine the percentage fee.

### Smart Fees

Smart Fees [188] allows the end user to pay towards integrated services within the software without hindering their profit. This design is based on a percentage fee added to all transactions processed through the software.

This fee added to sales transactions processed through the software would be used to pay towards the integrated cost for all selected services such as accounting, sales tax, PBX system, IT support, the software and other integrated expenses.

Smart Fees [188] can be disabled by each end user. If disabled, the system will cease to add a fee to the end user's customer's transaction.

An example in determining Smart Fees [188]:

The example demonstrates a potential situation wherein a default based percentage of 4%, and in which the user does not process enough transactions through the software to fully pay the cost of the selected integrated services.

Ceiling and floor stop percentages are provided to limit dynamic percentage adjustments. For example, the system would not be allowed to add more than 5% as the ceiling and 2% as the floor.

### Example

End user is using $425.00 per month in selected integrated service costs.

End user processes 100 transactions for $100 each that month or $10,000 USD in transactions.

A 4% fee is added to each transaction or $400.00 in Smart Fees [188].

A $100.00 per week charge to the users credit card for collection of the accumulated fees is charged.

At the end of the month, a smart fee assessment is completed for that user.

End user did not process enough transactions to fully pay for the selected integrated services. An additional $25.00 is charged to the end user for that month.

The Smart Fee Module [186] determines the fee percentage is not enough to cover the costs associated with the user's selected integrated services and the income from the transactions processed through the software. The smart fee module determines a larger fee is necessary to cover the user's selected service costs and adjusts the smart fee to 4.25%. When the user processes enough transactions to cover the costs involved with software, the system will adjust the fee percentage accordingly.

Globally disabling dynamic Smart Fees [188] keeps the fee at a static percentage.

FIG. 33 depicts the interconnected modules of an integrated software system that supports collecting Smart Fees [188] from the end user and configuring smart fees in the software.

Collecting Smart Fees [188] displays components for Timer System [096] sending data to both the Billing Module [191] and Alert System [102]. The alert system sends data to Management Interface and the Database Handler [062] which can send to or receive data from a plurality of modules including the Online Review Controller [106], Error Verification and Handling Module [072], CRM Module [012], Sales Recording System [180], Online Accounting Communication Subsystem [172], Sales Tax Integration [182], Payment Verification and Processing Module [190], Receipt Generator [176], and Template Storage [094]. The billing module sends data to the Calculation Algorithm Process [050] which works directly with sales tax integration and the Intelligent Data Creation Handler [076]. The intelligent data creation handler works with a plurality of modules including the Payment Processing Module [064] and the Recording Controller [178]. The receipt generator works with the Template Edit Process [092], which speaks to the Editing Module [080] and PDF Conversion Module [086], and the Email Generator which talks to the Email Module [066] to facilitate receipt generation and communication.

Configuring Smart Fees [188] in the software displays a form for User Input [098] or a Timer System [096] both sending data or calling upon the Smart Fee Module [186] which sends data to either the Error Verification and Handling Module [072] or the Calculation Algorithm Process [050] which both can send data to the Database Handler [062].

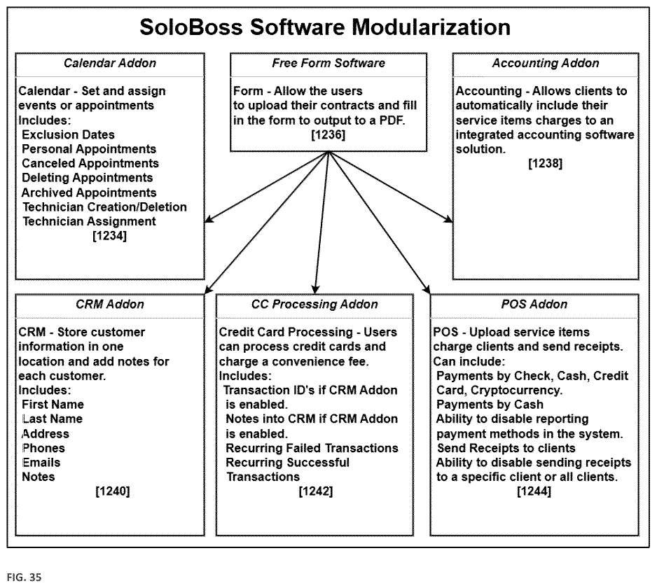

FIG. 35 displays an example of a modularization process of the software including the following:

Calendar Addon [1234]: This module allows users to set appointments for different customers and assign those appointments to technicians. It includes features such as exclusion dates, personal, canceled, deleting, and archived appointments as well as technician creation/deletion, and technician assignment.

Free Form Software [1236]: This module enables users to upload their contracts and fill in forms to output to a PDF. It serves as a versatile tool for managing and generating contract documents.

Accounting Addon [1238]: This module allows clients to automatically include their service items charges into an online integrated accounting software solution. It streamlines the accounting process by ensuring that charges are accurately recorded and managed.

CRM Addon [1240]: The Customer Relationship Management (CRM) module allows clients to store their customers' information in one location and add notes for each customer. It includes fields for the customer's last name, first name, address, phones, emails, and notes, facilitating comprehensive customer management.

CC Processing Addon [1242]: The Credit Card Processing module enables users to process credit cards quickly and easily, with the option to charge a convenience fee. It includes features such as transaction IDs and notes, recurring failed and successful transactions.

POS Addon [1244]: The Point of Sale (POS) module allows clients to upload their service items, charge clients, and send receipts. It includes payment options by check, cash, credit card and digital currencies with the ability to disable reporting of any payment type.

Each of these modules is designed to enhance the functionality and efficiency of the SoloBoss software, providing users with a comprehensive suite of tools for managing various aspects of their business operations.

REFUNDS: The protocols for full refunds, restocking, and return shipping outline the basic procedures for determining whether to refund shipping costs or charge a restocking fee. These protocols ensure clarity and consistency in handling returns and refunds.

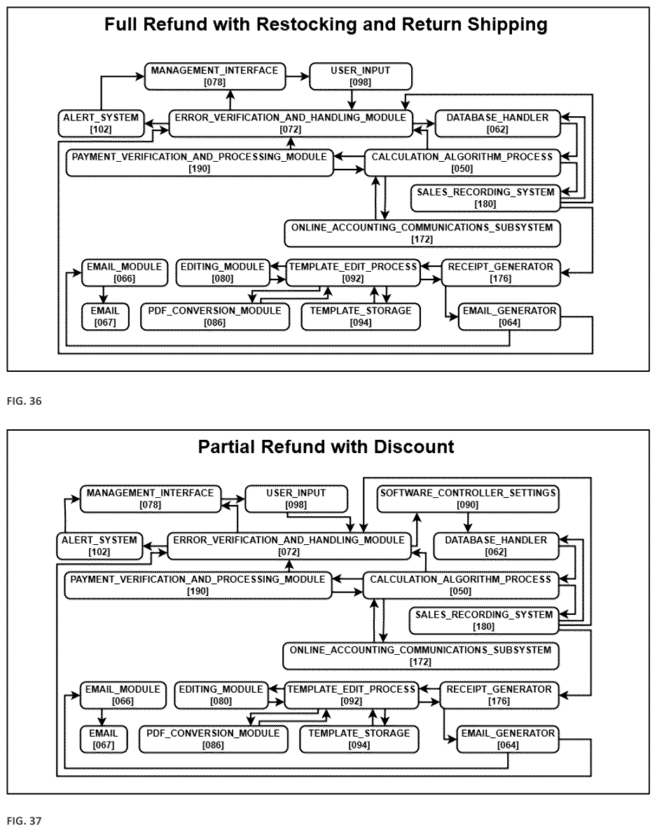

FIG. 36 illustrates the data flow for Full Refund Restocking and Return Shipping Protocols which includes User Input [098], Error Verification and Handling Module [072], Database Handler [062], Alert System [102], Management Interface [078], Database Handler, Calculation Algorithm Process [050], Payment Verification and Processing Module [190], Sales Recording [180], Online Accounting Communications Subsystem [172], Email [67], Email Module [066], Editing [080], Template Edit Process [092], Receipt Generator [176], Email Generator [064], Template Storage [094] and PDF Conversion Module [086].

The Full Refund Restocking and Return Shipping Protocol provides a systematic approach to manage full refunds efficiently. It begins by determining whether a part is listed on the sales receipt. If so, the process checks for return shipping and restocking fees. Depending on whether these fees are enabled by default, the protocol directs the user to enter preset amounts in administrative settings. For cases without listed parts or where fees are not enabled, the protocol bypasses unnecessary steps, ensuring a streamlined and efficient refund process. This structured workflow minimizes manual input and standardizes the handling of restocking and return shipping fees.

PARTIAL REFUNDS: The partial refunds protocol with discount outlines a straightforward method for providing customers with partial refunds and discounts. This protocol ensures that customers receive appropriate compensation while maintaining accurate financial records.

FIG. 37 displays data flow for Partial Refund with Discounts which includes User Input [098], Error Verification and Handling Module [072], Software Controller Settings [090], Database Handler [062], Alert System [102], Management Interface [078], Database Handler, Calculation Algorithm Process [050], Payment Verification and Processing Module [190], Sales Recording [180], Online Accounting Communications Subsystem [172], Email [67], Email Module [066], Editing [080], Template Edit Process [092], Receipt Generator [176], Email Generator [064], Template Storage [094] and PDF Conversion Module [086].

The Partial Refund Protocol with Discount provides a structured method for processing partial refunds that include discounts. It begins with the selection of a partial refund and the determination of whether the refund applies to a discount or an item. If a part is associated with the receipt, the protocol removes the item before recalculating the subtotal. The final step updates the receipt and communicates the calculated discount to the Online Accounting Integration (OAI) software. This workflow ensures consistent handling of partial refunds while integrating seamlessly with online accounting systems.

### Payment Processing

### Online Accounting Automatic Deposit Creator

The Online Accounting Automatic Deposit Creator stands out in the market by offering several innovative features that significantly enhance the efficiency, accuracy, and ease of use compared to other available solutions. The key novel aspects of the software include:

Advanced Automated Deposit Creation: Unlike existing solutions that often require manual intervention, third party integration or additional steps to reconcile accounting discrepancies due to immediate fee deductions from online payment processors, the SoloBoss system ensures comprehensive automation. It creates deposit entries in online accounting software that include all relevant transaction details and merchant service fees ensuring deposit creations match the bank record deposit, thus reducing user effort and minimizing errors without the use of third party integrated software.

Automatic Note Entries: One of the standout features of the Online Accounting Automatic Deposit Creator is its ability to automatically add notes to each deposit entry. These notes provide detailed contextual information about each transaction, such as fee breakdowns, transaction sources, and any applied discounts. This feature not only enhances the clarity and comprehensiveness of financial records but also aids in faster reconciliation and auditing processes, offering a significant improvement over other services.

Error Notification: The system includes a robust error notification mechanism that alerts users if any discrepancies or issues arise during transaction processing. This ensures that users can quickly address any problems without delaying the main transaction flow.

By focusing on these unique features of comprehensive automation, note entries, error notification, the Online Accounting Automatic Deposit Creator provides a superior solution for managing financial transactions within an online accounting software. These integrated innovations set the software apart from other individualized services, offering a level of performance and convenience that is not easily replicable by conventional methods.

This makes the Online Accounting Automatic Deposit Creator an essential tool for businesses seeking to optimize their financial management processes. The Online Accounting Automatic Deposit Creator employs streamlined data aggregation methods to efficiently combine multiple transaction records into a single deposit entry within an online accounting software. The system uses an efficient error handling mechanism that defers problematic transactions for later processing, flagging and storing them separately to allow the main processing flow to continue uninterrupted, and reprocessing these transactions during low-load periods to maintain system responsiveness and efficiency.

The Online Accounting Automatic Deposit Creator solves an issue with the interaction between an online payment processor and online accounting software when processing payments and reconciling accounts within the online accounting software. Online payment processors that deduct fees immediately prior to depositing the money into a bank account lead to discrepancies between the deposit amount and the sales receipt in the online accounting software. The flowchart provides a method for resolving these discrepancies to facilitate easier accounting reconciliation.

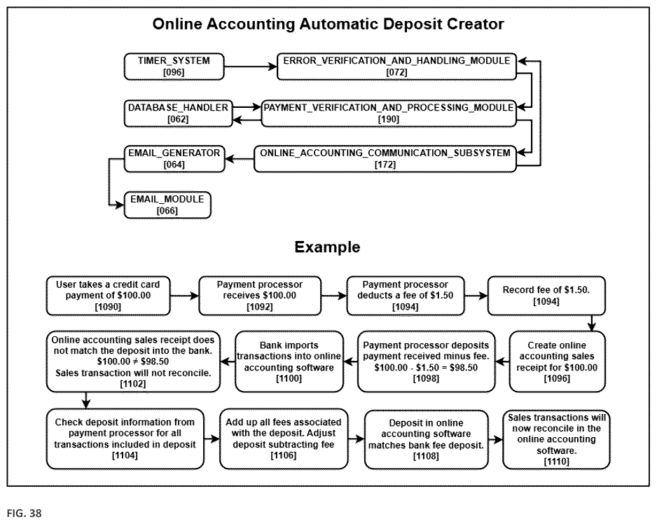

FIG. 38 displays data flow for the Online Accounting Automatic Deposit Creator including Timer System [096], Error Verification and Handling Module [072], Payment Verification and Processing Module [190], Online Accounting Communication Subsystem [172], Database Handler [062], Email Generator [064], and Email Module [066].

Typical companies have many transactions per day. This example shows a single transaction demonstrating the importance of this feature follows:

User takes a credit card payment of $100.00.

Payment processor receives $100.00.

Payment processor deducts a fee of $1.50.

Software records a fee of $1.50.

Create an online accounting sales receipt for $100.00.

Payment processor deposits payment received minus fee. $100.00−$1.50=$98.50.

Banks import transactions into online accounting software.

Online accounting sales receipt does not match the deposit into the bank. $100.00 does not equal $98.50. This sales transaction will not reconcile.

Check deposit information from the payment processor for all transactions included in the deposit.

Add up all fees associated with the deposit.

Adjust deposit subtracting fee.

Deposit in online accounting software matches the bank fee deposit.

Sales transactions will now reconcile in the online accounting software.

ONLINE ACCOUNTING SALES RECEIPTS: The online accounting receipts basics diagrams illustrate the process of creating sales receipts, refund receipts, and voiding sales receipts within the SoloBoss software, ensuring synchronization with the online accounting software. These diagrams help users understand the workflow and maintain accurate financial records.

PROFIT SHARING VIDEO PLATFORM: The SoloBoss Profit Sharing Video Platform ideology promotes video channel collaboration among video content providers. By working together on the SoloBoss video channels, content providers can grow their subscriber base collectively, benefiting from shared efforts and resources.

The Profit Sharing Video Platform introduces a method for content providers to collaborate on multiple shared video channels, maximizing their visibility and revenue potential. This system is characterized by several capabilities:

### Content Provider Collaboration

Allowing multiple content providers to upload their own videos to a shared video channel.

Enabling content providers to benefit from the collective success of the channel without direct collaboration with each other.

### Profit Sharing

Implements an automated profit-sharing mechanism to distribute earnings amongst content providers based on their contribution to the channel's overall success.

Provides transparency in earnings distribution through detailed reporting and analytics.

### Automated Revenue Distribution

Automatically calculates and distributes revenue among content providers based on a predefined percentage.

Ensures timely and accurate payments to all participating content providers.

### Content Management and Monetization

Allows content providers to manage videos they have uploaded, playlists they have created, and other content independently within the shared channel.

Integration with a video distribution platform to manage content and monitor performance.

Tools for optimizing video content to maximize revenue potential.

### Analytics and Reporting

Comprehensive analytics dashboard providing insights into video performance and revenue generation.

Reports to track key metrics such as earnings and viewership statistics.

### Multi-Language Support

Provides support for multiple languages, enabling global reach and inclusivity.

Features automatic subtitle generation and translation services to enhance accessibility and viewer engagement.

These features collectively make the Profit Sharing Video Platform a novel and comprehensive solution for maximizing revenue potential and visibility for content providers through a unique collaborative channel structure.

Utilizing periodic caching techniques allows data to be retrieved from the video distribution platform into the local system, reducing the frequency of calls, ensuring faster data access and improved system responsiveness. Using time-based or event-driven strategies to determine when to refresh cached data, prevents quota exhaustion. Using data compression can reduce the size of data before transmission, which decreases bandwidth usage and accelerates transfer speeds. The platform generates subtitles, translations, and metadata, minimizing repeated database queries and reducing server load. These processes handle complex tasks locally ensuring faster data processing and consistent optimization. Automating data submission reduces manual input and server demand, streamlining operations and ensuring accuracy. By combining efficient data caching, data compression, and content management, the platform achieves a level of responsiveness and resource management that can surpass conventional systems.

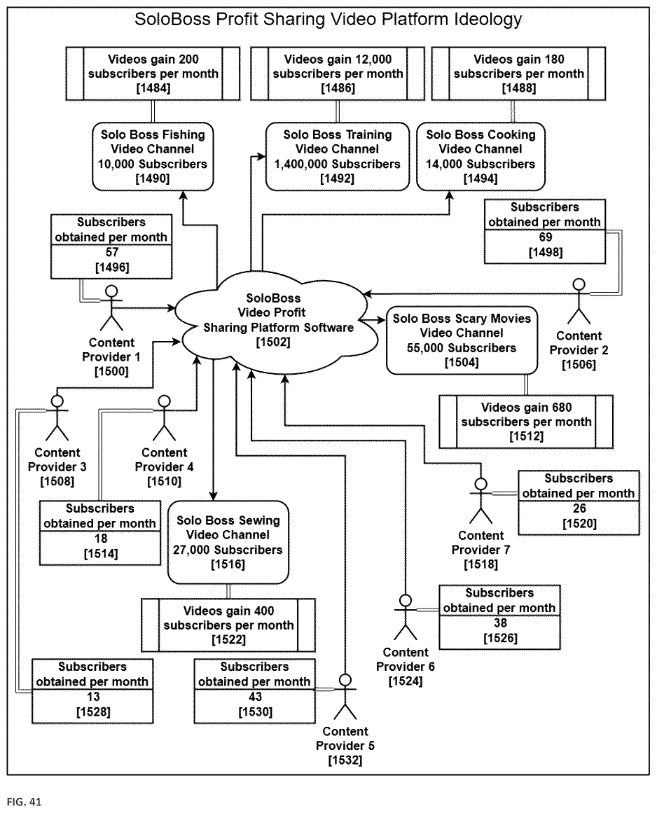

FIG. 41, Profit Sharing Video Platform Ideology, details how separate content providers working individually, in a software platform, build similar content video channels together with little to no communication with one another, in accordance with the SoloBoss Content Provider Ideology. The SoloBoss Profit Sharing Video Platform Software [1502] connects a plurality of SoloBoss video channels.

Each channel gains a specific number of subscribers per month: SoloBoss Fishing video Channel with 10,000 subscribers [1490] gains 200 subscribers per month [1484]. SoloBoss Training video Channel with 1,400,000 subscribers [1492] gains 12,000 subscribers per month [1486]; SoloBoss Cooking video Channel with 14,000 subscribers [1494] gains 180 subscribers per month [1488]; SoloBoss Scary Movies video Channel with 55,000 subscribers [1504] gains 680 subscribers per month [1512]; SoloBoss Sewing video Channel with 27,000 subscribers [1516] gains 400 subscribers per month [1522].

Various content providers are associated with these channels, each obtaining a specific number of subscribers per month: Content Provider 1 [1500] obtains 57 subscribers per month [1496]. Content Provider 2 [1506] obtains 69 subscribers per month [1498]. Content Provider 3 [1508] obtains 13 subscribers per month [1528]. Content Provider 4 [1510] obtains 18 subscribers per month [1514]. Content Provider 5 [1532] obtains 43 subscribers per month [1530]. Content Provider 6 [1524] obtains 38 subscribers per month [1526]. Content Provider 7 [1518] obtains 26 subscribers per month [1520].

When a content provider uploads video content to the SoloBoss software, the video is uploaded to the appropriate video channel. The content supplied by the content provider is not joined with other content provider videos on the same channel. Each content provider's video upload gains more viewers and additional subscribers, growing the channel together. If the content provider were to upload the video to a single channel, they would rely upon their own effort to grow that video channel. By uploading the video to the SoloBoss profit sharing video platform, the content providers rely upon the efforts of one another to grow the video channel.

This ideology allows for individual content providers to work together with other content providers to build and grow a video channel, gain more subscribers, earn more revenue, with little to no communication with each other.

### Marketing URLS

The marketing URLs, or uniform resource locators, more commonly known as website addresses, are a key component to higher ranking in the search engine result pages.

Search engines spiders look for hyperlinks to a website to help rank them higher in the search engines. How these hyperlinks are written and where they point is extremely important to search engine ranking of a website because it determines where and how search engine points, called page rank, are passed to the hyperlinked website.

A very basic introduction to search engines would be looking at the url. Typical static website address appears like:
https://www.scrfix.com←domain name
https://www.scrfix.com/managed-service-provider.php←Webpage on the domain

Search engines review these addresses by removing the https://www and these addresses now become:
scrfix.com
scrfix.com/managed-service-provider.php

The search engines review the domain name of scrfix.com on that hyperlink and see that this is the domain associated with that hyperlink.

They look to see if there is anything past the domain. If they do not find anything past the domain, they give page rank to the domain name. If there is then they give page rank to the final page in the hyperlink. In our example, the following places would receive page rank from a hyperlink.
scrfix.com←Main domain receives page rank.
scrfix.com/managed-service-provider.php←managed-service-provider.php receives the page rank.

Typical dynamic hyperlinks for which search engines do not pass page rank in the same manner may appear like:
https://www.scrfix.com/?keyword=search%20engines%20do%20not%20like%20this%20type%20of%20hyperlink

The search engines perform the same steps with these types of hyperlinks, but they ignore everything from the ? and beyond. The hyperlink is seen as https://www.scrfix.com. Then the normal process of passing page rank happens.

Controlling how and if page rank is passed is very important. The next steps are a deeper understanding of passing page rank when forwarding web pages to another webpage using a 301 redirect whereas a 302 redirect does not pass page rank.

Relationship codes used in the anchor tag tell the search engines to not pass page ranks through linked URLs.
Basic Marketing URL:https://www.soloboss.net?title=unique_username-my-great-video

Keeps page rank with the domain.

Redirects the user to the video when clicked.

User shares a link to a video and the domain receives page rank.

Professional Marketing URL:
https://www.soloboss.net/unique_username-my-great-video

Passes page rank to the video.

Redirects the user to the video platform's video when clicked.

User shares a link to a video and the video receives page rank.

A marketing URL is created for every video submission.

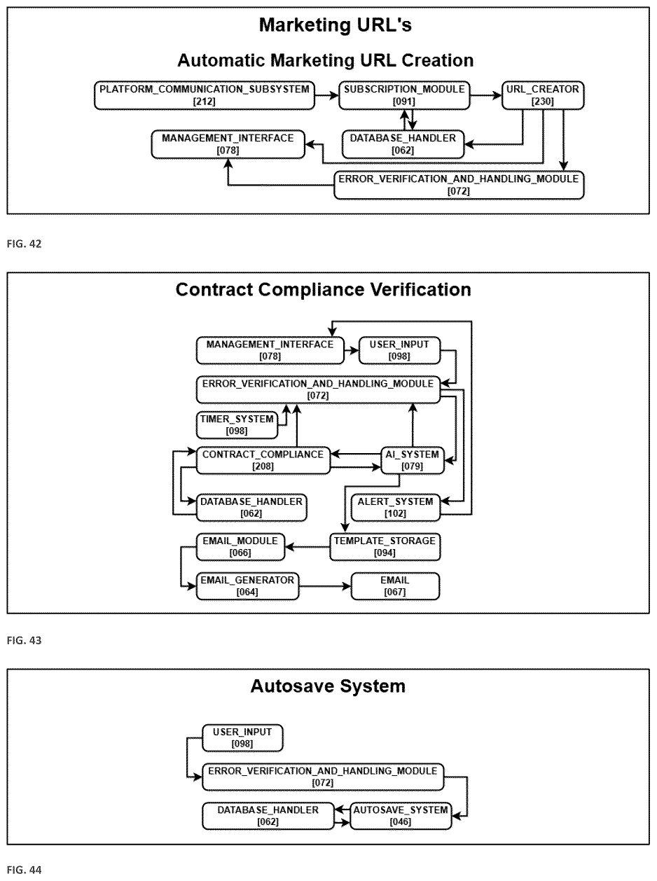

FIG. 42 displays automatic marketing URL creation begins with the Platform Communication Subsystem [212] sending data to the Subscription Module [091]. The subscription module sends queries to and receives data from the Database Handler [062] and the URL Creator [230]. The URL creator sends data to the database handler, Management Interface [078] and the Error Verification and Handling Module [072]. The error verification and handling module sends data to the management interface.

CONTRACT REGULATIONS: The flowchart for ensuring contract regulations compliance by content providers ensures that submitted videos meet specified standards and guidelines.

FIG. 43 shows the flow for verification of contract compliance. Starting with the Management Interface [078] sending data to User Input [098] which sends data to the Error Verification and Handling Module [072]. The error verification and handling module also receives data from the Timer System and sends data to the AI System [079] or the Alert System [102]. The AI system sends data to and receives data from Contract Compliance [208], which sends data to and receives data from the Database Handler [062]. The AI system also sends data to Template Storage [094], which sends data to the Email Module [066]. The email module sends data to the Email Generator [064] which sends data to Email [067].

AUTOSAVE: The autosave capability flowchart illustrates how the autosave feature works, saving the work of all users on the server at either an individual or global level. This ensures that work is not lost.

FIG. 44 displays a flowchart beginning User Input [098] sending data to the Error Verification and Handling Module [072] which sends data to the Autosave System [046]. The autosave system sends data to and receives data from the Database Handler [062].

The Viewing Notifications Queueing System is designed for minimizing video channel subscriber loss due to excessive notifications. It demonstrates how to manage notifications from multiple content providers on the same channel. This helps retain subscribers by reducing notification fatigue.

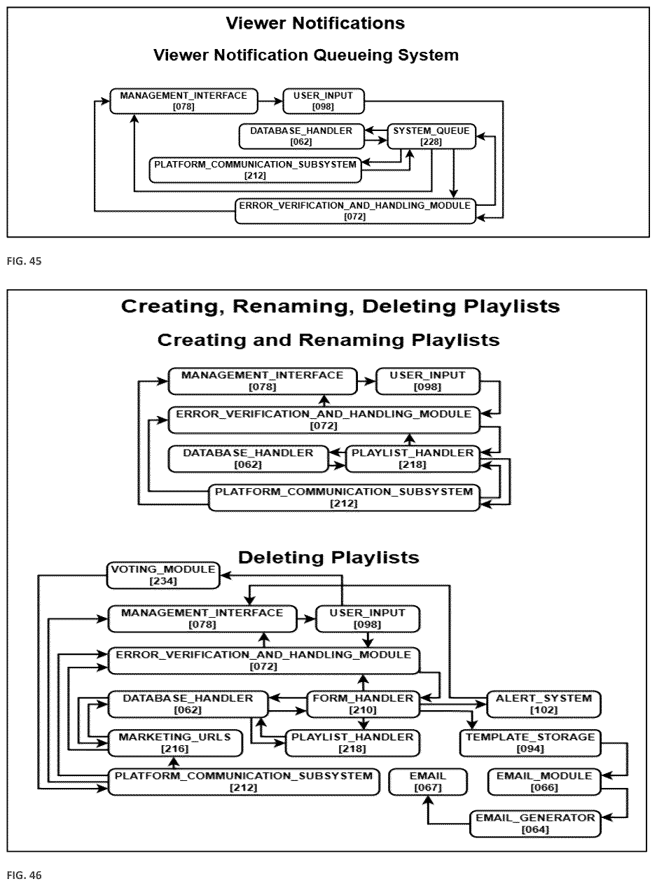

FIG. 45 details the process for handling video upload Viewer Notifications within a queuing system. User Input [098] sends data to the Error Verification and Handling Module [072] which sends valid data to the System Queue [228] or to the Management Interface [078]. The system queue sends data to the and receives data from the Database Handler [062] and Platform Communication Subsystem and also sends data back to the error verification and handling module.

For example, It starts with the content provider submitting a video. The system checks if the “send notifications to viewers” option is selected. The video is queued for submission with viewer notifications. Queueing happens at predetermined timed intervals.

PLAYLISTS: Playlists directly on video channels is an issue. Some video channel websites allow users added to an account to create playlists, but do not provide the permission to rename or delete those playlists and leave it only to a single administrator account to rename or delete these playlists. This causes a bottleneck in efficiency and causes a security risk with the administrator account credentials.

FIG. 46 Creating and Renaming Playlists consists of multiple modules and subsystemsaLERT working in tandem. The Management Interface [078] User Input [098], Error Verification and Handling Module [072], Playlist Handler [218], Database Handler [062], Platform Communication Subsystem [212] work together to allow a seamless flow for creating and renaming playlists within a video software platform.

FIG. 46 Deleting Playlists consists of the Voting Module [234], Management Interface [078], User Input [098], Error Verification and Handling Module [072], Database Handler [062], Playlist Handler [218], Form Handler [210], Marketing URLs [216], Alert System [102], Platform Communication Subsystem [212], Template Storage [094], Email Module [066], Email Generator [064], Email [067] working together.

By providing a voting module for deleting playlists, the software allows for playlists to be requested to be deleted but also minimizes broken Internet Marketing URLs that have been placed around the Internet by not automatically deleting the playlist. When a playlist is removed, the marketing URL will automatically be redirected to the default playlist for that user, which cannot be deleted.

TRANSCRIPTION SUBTITLE SUBSYSTEM: The Transcription Subtitle Subsystem flow chart outlines the process for obtaining transcripts for uploaded videos automatically. The transcription of the video is required for subtitles and the video descriptions. This method streamlines the transcription process and ensures that video content is accessible.

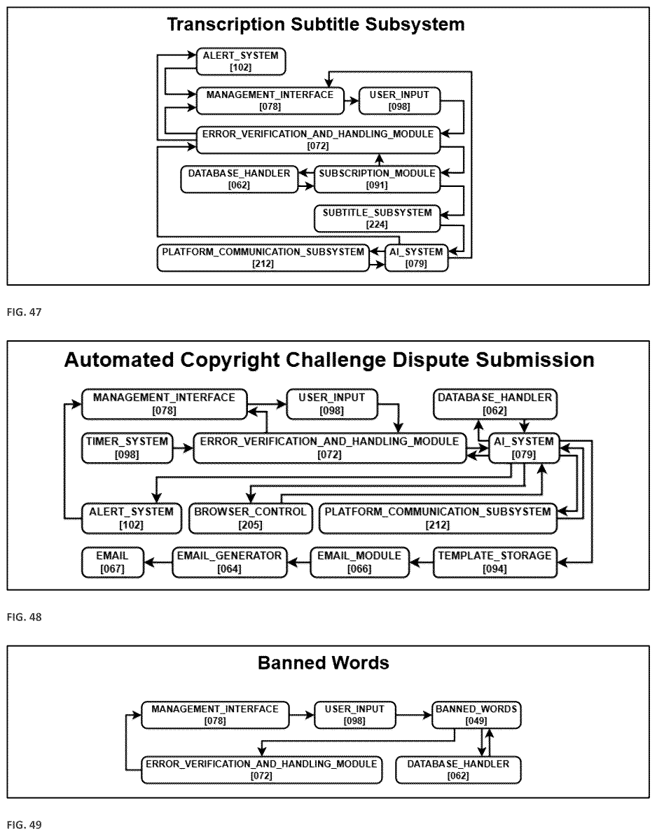

FIG. 47 describes the Transcription Subtitle Subsystem. The software uses the Alert System [102], Management Interface [078], User Input [098], Error Verification and Handling Module [072], Subscription Module [091], Database Handler [062], Subtitle Subsystem [224], AI System [079] and a Platform Communication Subsystem [212] to extract audio, convert it to text and use it as a subtitle for the video being uploaded.

AUTOMATED COPYRIGHT INFRINGEMENT CHALLENGING: Video submission websites allow for copyright challenges from any user and oftentimes this challenge is automated. For example, when a video is uploaded to a video submission website, within a few seconds, a copyright strike symbol is added next to the video showing this video submission is accused of copyright infringement. This copyright challenge functionality is called a copyright strike and is abused by the music industry by challenging almost every sound automatically. The same video submission websites do not provide an automatic method of challenging these copyright strikes and the administrator user account must wait until an official notification is sent, log into the video submission platform's website interface for every copyright strike infringement. They must navigate through to the correct video and submit a copyright challenge after typing why they believe this copyright challenge is incorrect. If a copyright strike is not challenged it will hinder monetization of that video. The flow chart for challenging copyright infringement shows how to automatically challenge copyright strikes.

FIG. 48 outlines the procedure for handling automatic copyright challenges. The process uses the Management Interface [078], User Input [098], Error Verification and Handling Module [072], Database Handler [062], Timer System [098], AI System [079], Alert System [102], Browser Control [205], Platform Communication Subsystem [212], Template Storage [094], Email Module [066], Email Generator [064], and Email [067] to submit copyright strike challenges for the video submissions.

For this example, we will specifically mention YouTube. When a user submits a video, the system sets up and sends information to YouTube's Content ID Match. The system then checks if the Content ID Match is successful. If the Content ID Match is successful, the system checks if push notifications for copyright infringement can be set up. If possible, these notifications are configured; otherwise, the video is sent to YouTube.

When notified of a copyright strike, the system allows the AI System [079] or uses browser control software to handle interactions with Browser Control [205] to automatically log into the video platform account and respond to the copyright strike notifications.

BANNED WORDS FILTERING: The flowchart for filtering out banned content explains how to manage and approve content to ensure compliance with platform guidelines. This helps maintain the integrity of the content and avoids issues with banned words or phrases.

FIG. 49 outlines the process for handling banned words in video submissions. Banned words functionality works with the Management Interface [078], User Input [098], Banned Words [049], Database Handler [062] and, Error Verification and Handling Module [072]. Video submissions with banned words are prevented from uploading to the video submission platform.

The process starts when a content provider submits a video. The system checks the video filename, title, description, audio converted text, and text converted from optical character recognition for banned words.

CONTENT PROVIDER UPLOAD, EDIT AND DELETION PROCESS: These flow charts display the process for data flow which allows content providers to upload, edit and request deletion of content they've uploaded. The flow charts explain how the data travels through each module or subsystem providing the functionality necessary to complete the tasks.

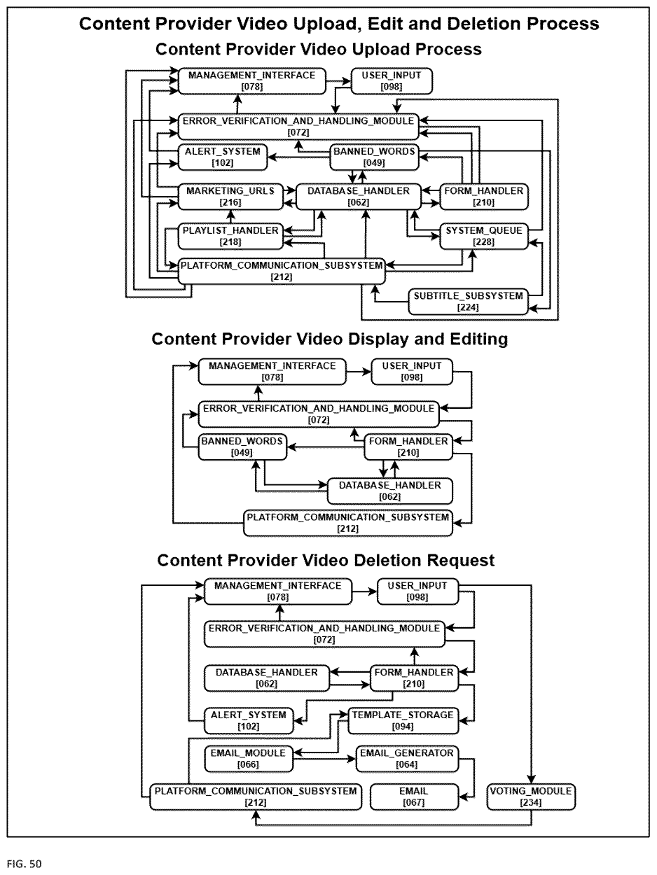

FIG. 50 displays a flow chart for Content Provider Upload Process using the Management Interface [078], User Input [098], Error Verification and Handling Module [072], Alert System [102], Banned Words [049], Marketing URLs [216], Database Handler [062], Form Handler [210], Playlist Handler [218], System Queue [228], Platform Communication Subsystem [212], and Subtitle Subsystem [224].

FIG. 50 displays a flow chart for Content Provider Video Display and Editing using the Management Interface [078], User Input [098], Error Verification and Handling Module [072], Banned Words [049], Form Handler [210], Database Handler [062], and Platform Communication Subsystem [212].

FIG. 50 displays a flow chart for Content Provider Deletion Request using the Management Interface [078], User Input [098], Error Verification and Handling Module [072], Database Handler [062], Form Handler [210], Alert System [102], Template Storage [094], Email Module [066], Email Generator [064], Email [067], Voting Module [234], and Platform Communication Subsystem [212].

### Multi-Faceted System

The SoloBoss software system revolutionizes the management of business operations by integrating advanced automation, innovative features, and unique enhancements into a single cohesive platform. This software streamlines a wide range of tasks, providing capabilities that are exclusive to SoloBoss. By automating and improving processes in unprecedented ways. Features that distinguish SoloBoss include:

Comprehensive Automation: SoloBoss semi or fully automates a wide range of time-laden tasks, including appointment scheduling, identifying potential customer behavior, data entry, invoicing, customer management, payment processing, online review controls, note-taking, error handling, marketing decisions, managing vendor store operations, and handling reward systems. By integrating these functions into a single cohesive platform, SoloBoss significantly reduces manual effort, enhances accuracy, and ensures consistency across business operations. This comprehensive automation allows users to focus on strategic business growth rather than administrative tasks, offering a uniquely integrated solution that addresses the multi-faceted challenges faced by businesses.

Unique Integrations: SoloBoss features a proprietary integration framework that enables communication and data exchange between various internal components and external services. For example, the system's built-in billing module interacts with payment processors that deduct fees immediately, which causes accounting reconciliation errors when a deposit of a sale into a bank account does not exactly match the sales receipt, such as Square. This interaction automatically calculates and deducts transaction fees from the deposit creation in the online accounting software, streamlining the accounting process. This framework ensures that integrations are deeply embedded and optimized for SoloBoss, enhancing overall system performance and user experience.

Enhanced Customer Management: The software tracks customer behavior across all customers data entered into the system, enabling all users to identify potential customer behavior based on collective data. This feature helps users make informed decisions about potential clients prior to acceptance as an official client, reducing the risk of bad debts.

Automated Review Process: SoloBoss automates an online review process by guiding the user's customers through various platforms and enabling the user to provide multiple prewritten reviews tailored to specific jobs. This approach allows customers to select and submit online reviews that best represent their experience, significantly enhancing the online visibility and reputation of the business. This feature provides a unique level of customization and efficiency.

Modular Flexibility: SoloBoss features a modular architecture that allows users to customize and extend functionalities to suit their unique business needs. This flexibility enables users to easily enable or disable various features within the software and choose whether to share data globally with other users. The modular design ensures that the software remains adaptable and scalable, providing a tailored experience for each user while maintaining overall system integrity and performance.

Automatic Note-Taking: SoloBoss offers automatic note-taking, strategically placing notes across connected systems to ensure consistency and ease of access. This reduces the manual effort involved in maintaining detailed records, a critical feature for users who manage multiple tasks simultaneously.

Advanced Error Handling: SoloBoss features an advanced error management system that combines user-facing and behind-the-scenes processes. It provides detailed, user-friendly error messages, allowing users to resolve issues independently. The system automatically retries failed API calls and notifies the programming team. An extensive activity log tracks all interactions, enabling comprehensive monitoring and troubleshooting. This comprehensive approach enhances the overall reliability and user experience of the software, allowing users to maintain smooth business operations with minimal disruption.

Sales Tax Compliance: SoloBoss enhances sales tax compliance by integrating with external tax calculation software. By continuously synchronizing data and automating the workflow, the software minimizes errors. SoloBoss provides users with detailed internally created sales tax reports to compare against the automatically synchronized data, allowing them to verify accuracy before submitting sales tax. This approach ensures reliability and compliance.

Marketing Platform: SoloBoss includes a unique marketing platform that enables users to collaborate and share marketing results on a global scale. This platform allows users to automatically share their marketing efforts and benefit from the collective efforts of other users. By providing a centralized repository of marketing results, SoloBoss fosters a collaborative environment that enhances the marketing efforts of each user. This innovative approach to marketing support offers users a valuable resource for improving their marketing outcomes.

Customizable Multi-Payment Invoicing: SoloBoss allows for the creation of multi-payment invoicing options with customizable payment terms and interest rates, providing flexibility for both users and their clients to manage large payments over time. Unlike traditional invoicing systems with rigid structures, SoloBoss enables users to tailor payment terms and interest rates to fit specific needs, dynamically adjusting payment schedules and terms based on user-defined criteria. This adaptability simplifies the management of diverse financial arrangements, catering to individual client agreements and offering a unique solution for handling complex payment scenarios efficiently.

Enhanced Refund Processing: The software handles refunds efficiently, accommodating various scenarios such as partial refunds, line-item specific refunds, full refunds, and reallocation of charges. This automation saves users time and effort in managing refunds manually. By automating complex refund processes, the software not only saves time but also reduces errors and inconsistencies. Additionally, it communicates with multiple software systems to synchronize information, ensuring accurate and consistent data across platforms. This flexibility to dynamically manage different refund situations provides a unique advantage over traditional manual refund systems, making it particularly beneficial for users managing numerous and diverse transactions.

Predictive Income and Expense Reporting: The innovative aspect of this feature lies in its advanced predictions capabilities that analyze historical data and individualized business conditions to generate estimated financial forecasts. Unlike traditional static reporting tools, SoloBoss dynamically adjusts its predictions based on data inputs and changes in business conditions. This adaptive forecasting provides users with a proactive financial planning tool that highlights potential future financial states and offers actionable insights to optimize cash flow and manage expenses. The integration of a plurality of data sources and the continuous learning capability of the software ensure that the forecasts remain relevant and precise, giving users a significant edge in financial management.

Overview: By combining these features, SoloBoss offers a holistic and innovative solution that addresses the multi-faceted challenges faced by users, setting it apart from other business management software.

Structure and Design: The SoloBoss software system is designed with an emphasis on data efficiency, ensuring database structures, code, and the communication between both are optimized for maximum performance. The following unique strategies and methodologies highlight the system's efficiency:

Optimized Database Design: The SoloBoss system employs a meticulously optimized database design that ensures quick and efficient data retrieval. This includes the use of indexing strategies such as B-trees and hash indexes to accelerate query execution times, particularly for high-frequency operations.

Efficient Query Execution: Advanced query optimization techniques, including query rewriting and execution plans, are applied to ensure efficient data retrieval and manipulation.

Modular Code Architecture: SoloBoss adopts a modular code architecture that allows individual components to be updated or scaled independently. This modularity not only enhances maintainability but also ensures that performance optimizations can be applied to specific modules without affecting the entire system.

Intelligent Cache Invalidation: By using intelligent cache invalidation strategies the software can ensure that cached data remains fresh and consistent with the database, improving system performance.

Asynchronous Processing for Non-Blocking Operations: Asynchronous processing for non-blocking operations allows the system to handle multiple tasks concurrently, enhancing user experience during peak times.

Data Synchronization Techniques: The software uses continuous data synchronization methods to maintain data consistency across a plurality of external software platforms. Techniques such as data replication minimize data transfer volumes and ensure up-to-date information across all systems.

Comprehensive Error Handling and Logging: Comprehensive error handling and logging mechanisms are in place to provide an audit trail for all activities. This ensures data integrity and facilitates troubleshooting by providing detailed logs of all operations.

Appointment Scheduling System: Asynchronous processing for appointment scheduling requests improves responsiveness and reduces server load. Leveraging in-memory caching for frequently accessed data, such as available appointment slots and user details, can reduce the number of direct database queries.

Multi-payment Invoicing System: Composite indexing on frequently queried columns can accelerate search operations. Using batch processing to aggregate multiple payment transactions into batch operations, can minimize the number of database transactions and computational overhead. This approach will improve system scalability and performance during high transaction volumes.

Profit Sharing Video Platform: Implements a local cache storage mechanism that periodically updates with data from the video platform. Utilizing data compression will reduce the amount of data sent over the network.

Dynamic Contract Creation: Asynchronous task queues for processes like email notifications, contract generation, and PDF creation distributes server load evenly allowing smoother software operations.

Sales Processing System: Using data access patterns to minimize the number of database joins and optimize query performance allows for faster communication and transaction processing.

Multithreading allows for processing multiple payment transactions simultaneously. Data synchronization ensures consistency across distributed systems.

Online Review Controller: Stores keyword phrases associated with products or services in a dedicated, indexed table to support rapid insertion and retrieval of keywords. By using data compression for transmitted data between the application and the database, this technique can allow for faster communication between the software and the database.

Online Accounting Automatic Deposit Creator: Streamlining data aggregation methods to combine multiple transaction records into a single deposit entry allows for more efficient communication to an external online accounting software. Using efficient error handling mechanisms defer problematic transactions for later processing.

Overview: By integrating these strategies, the SoloBoss software system ensures superior data efficiency, setting a new standard for business management software. These optimizations make the system more efficient and robust compared to conventional solutions, offering users a reliable and high-performing platform to manage their business operations.

### System Optimization and Advantages

### Optimized Memory Usage for Enhanced Performance

Efficient memory management is crucial for maintaining system performance and stability in resource-intensive applications. The system minimizes memory consumption by reducing redundancy and streamlining data processing across multiple functions.

By consolidating essential functions-such as customer relationship management (CRM), payment processing, and data handling-the system can eliminate the need for multiple applications that require separate memory allocations, buffers, and caches. This approach reduces duplication, freeing up computer memory for other tasks and improving overall system responsiveness.

A centralized data management framework further optimizes resource allocation by reducing redundant data caches and buffers across applications. This streamlined approach can lower the overall memory footprint, decrease disk I/O operations, and enhance processing efficiency. Additionally, resource-efficient integrations eliminate the need for running multiple instances of similar software tools, ensuring that memory is allocated to critical tasks, thereby improving performance and system stability.

By leveraging these memory optimization strategies, the system can enhance operational efficiency, reduce hardware strain, and maintain a high level of performance even when handling complex operations.

### Optimized Resource Management and Data Efficiency

The system is designed to maximize resource efficiency by optimizing memory usage, CPU scheduling, and I/O operations. Eliminating redundant processes and consolidating critical functions ensures that system resources are allocated dynamically based on workload demands, preventing bottlenecks and maintaining high performance.

Native multi-platform support reduces the need for compatibility layers and emulation, which often introduce additional processing overhead.

By integrating key functionalities such as CRM, payment processing, and system-wide resource monitoring, the system eliminates redundant data caches and processes. This minimizes overall resource consumption, ensuring that CPU cycles, memory, and I/O bandwidth are allocated precisely where needed. As a result, the system enhances operational efficiency, reduces processing delays, and maintains peak performance even during high transaction volumes.

This streamlined resource management strategy ensures that the system operates efficiently across different environments without requiring separate applications for each platform, reducing redundancy and improving overall system stability.

### Optimized Power Efficiency

The system can reduce power consumption by consolidating essential functions into a unified platform, minimizing the need for multiple applications running simultaneously. This optimization lowers CPU and memory usage, reducing overall energy demands while enhancing system efficiency.

By centralizing payment processing and data management, the system can decrease the number of active processes, lowers disk access frequency, and streamlines data transfers. These reductions not only conserve energy but also reduce thermal stress and power cycles, extending the lifespan of hardware components.

Through efficient resource allocation and workload management, the system operates with minimal power overhead, ensuring long-term energy savings while maintaining high performance and stability.

### Optimized CPU Utilization

The system can reduce CPU overhead by minimizing context switching, inter-process communication, and redundant data processing. Running multiple applications simultaneously increases the CPU's workload due to frequent task switching and process management. By consolidating core functions—such as CRM, payment processing, and data management—into a single platform, the system reduces the number of active processes competing for CPU resources.

Context switching, which occurs when the CPU saves and restores different process states, is a significant source of performance overhead. By centralizing key operations, the system can reduce the frequency of these switches, allowing tasks to be processed more efficiently. This optimization decreases the time the CPU spends managing tasks and increases the time available for executing essential computations.

Additionally, direct integration with external platforms, such as online accounting software and payment processors, reduces the need for redundant background processes that consume CPU cycles. Instead of multiple applications handling separate tasks, the system can streamline data flow, lowering computational complexity and improving processing speed.

By reducing unnecessary CPU-intensive operations, the system can enhance overall performance, maintain low latency, and ensure seamless task execution, even under heavy workloads.

### Optimized Network Efficiency

The system can reduce network load by minimizing redundant data transfers, streamlining synchronization, and optimizing data flow across integrated functions. By consolidating key operations-such as CRM, payment processing, and data management-within a single platform, the need for frequent data exchanges between separate applications is significantly reduced.

Efficient data synchronization can ensure that only necessary information is transferred, reducing the number of network packets sent and lowering congestion. This optimization can improve data transfer speeds, decrease latency, and enhance the performance of network-dependent tasks.

By managing data within a centralized system, the need for continuous synchronization between multiple applications can be eliminated. This can not only reduce bandwidth usage but also minimize the risk of data inconsistencies, ensuring a more reliable and efficient data exchange process.

### Optimized System Efficiency through a Unified Architecture

The system can improve performance by utilizing a unified codebase, centralizing data management, and streamlining transaction handling. A unified codebase ensures that enhancements and optimizations apply across all supported platforms, reducing the time and resources required for maintaining multiple code versions while providing consistent performance improvements.

By using a single data source, the system can minimize redundancy and optimize data handling. Centralized data management enhances efficiency by reducing the number of I/O operations required for data retrieval, improving read and write speeds, and lowering disk access times. This optimization results in faster data processing and reduced latency.

A unified approach to payment processing can further streamline operations by consolidating various payment methods and gateways into a single platform. This centralization reduces computational overhead and improves transaction handling, ensuring smoother processing and better resource utilization.

These optimizations can allow the system to achieve higher performance, enhanced reliability, and reduced maintenance complexity, creating a more efficient computing environment.

### Streamlined Maintenance, Security, and Data Optimization

The system can enhance efficiency by consolidating functions, simplifying maintenance, and improving security. A unified platform reduces the complexity of updates, ensuring that performance improvements, bug fixes, and security patches are applied consistently across all components. This approach minimizes downtime and eliminates dependency conflicts that often arise when managing multiple applications.

By integrating multiple functions into a single platform, the system can improve security by reducing the attack surface for potential vulnerabilities. A consolidated security model enforces consistent authentication, authorization, and encryption policies, reducing the risk of security breaches while simplifying security monitoring and management.

A centralized Customer Relationship Management (CRM) system can further optimize system performance by streamlining data management. Managing customer data within a single platform improves database performance through optimized query execution and indexing strategies, reducing disk I/O operations and enhancing data retrieval speeds.

Streamlined data processing also improves efficiency by reducing the need for batch processing and manual data entry. Financial transactions, customer interactions, and other critical data operations are processed efficiently, minimizing I/O operations and accelerating data access.

Additionally, resource-efficient integrations enhance system performance by minimizing redundancy and optimizing data handling. By incorporating external tools and services within a single platform, the system can reduce unnecessary processing overhead, leading to improved stability and responsiveness.

### Exemplary Pseudo-Code Example for Depicted Figures are Displayed as

[ACCOUNT VERIFICATION SYSTEM] Receive data from the ERROR VERIFICATION AND HANDLING MODULE. Receive data from a call to data backup service company API. Receive data from the COMMUNICATION AND VERIFICATION SUBSYSTEM. Send data to the DATA STORAGE MODULE.
[ALERT SYSTEM] Send Data to the Management Interface.
[APPOINTMENT SCHEDULER] sends data to the MARKETING MODULE.
[AUTOMATIC AGGREGATE DATA UPDATER] Receives data from the TIMER SYSTEM. Sends API requests. Receives data from the API request. Sends and receives data from the DATA CONVERSION SYSTEM. Sends data to the DATABASE HANDLER. Sends data to the ACCOUNT VERIFICATION SYSTEM.
[AUTOMATIC BILLING CONVERTER MODULE] Receives requests from the TIMER SYSTEM. Sends data to the PAYMENT PROCESSING MODULE.
[AUTOSET SUBSYSTEM] sends data to PAYMENT DISPLAY.
[AVAILABILITY MODULE] Receives data from USER INPUT. Sends data to the CALENDAR AND REMINDER SUBSYSTEM. Receives response from the CALENDAR AND REMINDER SUBSYSTEM and compares the response from the database to the USER INPUT. Sends response to MANAGEMENT INTERFACE.
[BANNED CUSTOMERS] sends data to the ERROR VERIFICATION AND HANDLING MODULE.
[BILLING MODULE] sends queries to and receives responses from the DATABASE HANDLER and sends data to the CALCULATION ALGORITHM PROCESS.
[CALCULATION ALGORITHM PROCESS] sends data and receives responses from the SALES TAX INTEGRATION and sends data to the INTELLIGENT DATA CREATION HANDLER.
[CALENDAR AND REMINDER SUBSYSTEM] Receives data from USER INPUT. Sends data to the DATABASE HANDLER. Queries the database, via the DATABASE HANDLER. Sends API requests to the appropriately selected calendar API.
[CANCELATION MODULE] sends a query to and receives data from the DATABASE HANDLER, sends data to the MANAGEMENT INTERFACE.
[COMMUNICATION AND VERIFICATION SUBSYSTEM] Receives data from the EXCLUSION CONTROLLER. Sends data to the ERROR VERIFICATION AND HANDLING MODULE. If a valid and verified response is received, send data to the ACCOUNT VERIFICATION SYSTEM.
[CONTACTS INTEGRATION SYSTEM] Receives data from USER INPUT. queries the DATABASE HANDLER. Receives a response from the DATABASE HANDLER.
[CONTRACT MODULE] sends data to the ERROR VERIFICATION AND HANDLING MODULE.
[CRM MODULE] Receives data from the USER INPUT. Sends data to the ERROR VERIFICATION AND HANDLING MODULE.
[CUSTOMER BEHAVIOR MODULE] sends queries to and receives the data from the DATABASE HANDLER, sends data to the MANAGEMENT INTERFACE.
[DATA ASSEMBLY] Sends Data to the Filter.
[DATABASE HANDLER] sends data to the ERROR VERIFICATION AND HANDLING MODULE or the MANAGEMENT INTERFACE.
[DATA CONVERSION SYSTEM] Receive data from the ACCOUNT VERIFICATION SYSTEM. Convert the non-usable usage data to a usable format. Example: The data backup service company data storage usage for each user returns a non-usable number similar to 95834020495, which does not relate to any type of usable data file size storage for user billing calculations. This returned number requires a data conversion process to convert the number to a usable mathematical number to use in billing calculations for the end user data storage service. Sends data to the LISTING MODULE.
[EDITING MODULE] Receives files from the TEMPLATE EDIT PROCESS. Edits the file associated with the request. Sends modified files to the TEMPLATE EDIT PROCESS.
[EMAIL] contains several hyperlinks that lead to three different web pages.
[EMAIL GENERATOR] sends data to the EMAIL MODULE.
[EMAIL MODULE] sends out the [EMAIL].
[ERROR VERIFICATION AND HANDLING MODULE] sends data to the DATABASE HANDLER or the MANAGEMENT INTERFACE.
[EXCLUSION CONTROLLER] Receives data from the FILTER SYSTEM. Retrieves data from the DATABASE HANDLER for backup accounts that are excluded from being charged. Combines data list from the FILTER SYSTEM. Sends data to the COMMUNICATION AND VERIFICATION SUBSYSTEM.
[FILE HANDLER] sends data to the MANAGEMENT INTERFACE.
[FILTER] sends data to the MANAGEMENT INTERFACE.
[FILTER SYSTEM] Receives data via Ajax from the USER INPUT. Retrieves data from the DATABASE HANDLER for backup accounts already associated with a billing account in the local database. Sends data to the EXCLUSION CONTROLLER.
[GEOLOCATION MODULE] Receives data from USER INPUT. Queries local database, via the DATABASE HANDLER to obtain default office location coordinates and on-site fee information. Dynamically queries an Geocoding API to gain coordinates for the users' clients location. Converts and calculates the distance between the two locations and selects the correct on-site fee based on that distance. Calculates and displays the estimated travel time between the two locations. Sends data to MANAGEMENT INTERFACE.
[HYPERLINK 1] leads to the FEEDBACK WEB PAGE.
[HYPERLINK 2] leads to the REVIEW PROCESS.
[HYPERLINK 3] leads to the UNSUBSCRIBE WEB PAGE.
[INTELLIGENT DATA CREATION HANDLER] sends data to the CRM MODULE, the PAYMENT PROCESSING MODULE, and the RECORDING CONTROLLER.
[INVOICE VERIFICATION SYSTEM] Receives data from USER INPUT. Sends data to MANAGEMENT INTERFACE.
[LISTING MODULE] Receives data from the DATA CONVERSION SYSTEM. Sends an HTML Table form containing a filtered listing of selectable and available options for which to associate the users backup billing information to the USER INPUT.
[MAINTENANCE INTERFACE] Sends Data to User Input.
[MARKETING MODULE] sends data to the MANAGEMENT INTERFACE and sends queries to and receives data from the DATABASE HANDLER.
[ONLINE ACCOUNTING COMMUNICATION SUBSYSTEM] sends data to the ERROR VERIFICATION AND HANDLING MODULE and to the DATABASE HANDLER.
[ONLINE REVIEW CONTROLLER] sends queries to and receives responses from the DATABASE HANDLER and sends data to the EMAIL GENERATOR.
[PAYMENT DISPLAY] Receives data from USER INPUT. Queries DATABASE HANDLER. Receives response from DATABASE HANDLER. Sends data to MANAGEMENT INTERFACE.
[PAYMENT PROCESSING MODULE] sends data to and receives data from the PAYMENT VERIFICATION AND PROCESSING MODULE and sends data to the SALES RECORDING SYSTEM.
[PAYMENT TERMS MANAGEMENT] sends queries to and receives responses from the DATABASE HANDLER and sends data to the CALCULATION ALGORITHM PROCESS.
[PDF CONVERSION MODULE] Receives files from the EDITING MODULE. Determines if a multi-format combination and conversion is necessary. Converts the file(s) to a pdf format and returns them back to their respective module, subsystem or process.
[PRODUCT DETAILS] sends data to STORE CHECKOUT, to the MANAGEMENT INTERFACE and sends queries to and receives responses from the DATABASE HANDLER.
[PRODUCT LIST] sends data to the MANAGEMENT INTERFACE, sends queries to and receives responses from the DATABASE HANDLER, and sends data to PRODUCT DETAILS.
[RECEIPT GENERATOR] sends queries to and receives data from the DATABASE HANDLER, sends data to and receives a file from the TEMPLATE EDIT PROCESS, sends data and a file to the EMAIL MODULE, sends data to the ERROR VERIFICATION AND HANDLING MODULE, sends data to the MANAGEMENT INTERFACE and sends data to the EMAIL GENERATOR.
[RECORDING CONTROLLER] sends data to the ONLINE ACCOUNTING COMMUNICATION SUBSYSTEM and the RECEIPT GENERATOR.
[REVIEW CONTROLLER] sends data to the EMAIL GENERATOR.
[REWARD MODULE] sends data to the CALCULATION ALGORITHM PROCESS.
[SALES RECORDING SYSTEM] sends data to the DATABASE HANDLER and to the RECEIPT GENERATOR.
[SALES TAX INTEGRATION] sends queries to and receives responses from the DATABASE HANDLER.
[SMART FEE MODULE] sends data to the CALCULATION ALGORITHM PROCESS.
[PAYMENT VERIFICATION AND HANDLING MODULE] sends data to the DATABASE HANDLER or the ERROR VERIFICATION AND HANDLING MODULE.
[STORE CHECKOUT] sends queries to and receives responses from the DATABASE HANDLER, sends data to the REWARD MODULE, and sends data to the MANAGEMENT INTERFACE.
[TEMPLATE EDIT PROCESS] sends data to the DATABASE HANDLER or to the EMAIL GENERATOR.
[TEMPLATE STORAGE] sends queries to and receives responses from the DATABASE HANDLER.
[TIMER SYSTEM] sends timed requests to the BILLING MODULE, the ONLINE REVIEW CONTROLLER and the ALERT SYSTEM.
[TRANSITION STATE MODULE] sends data to the MANAGEMENT INTERFACE.
[USER INPUT] sends data to the APPOINTMENT SCHEDULER or to the SALES RECORDING SYSTEM.
[USER MANAGEMENT SUBSYSTEM] Data received from USER INPUT. Queries database to verify matching data, sort and store all data backup and user information into the local database. Sends data information to CALCULATION ALGORITHM PROCESS.
[VENDOR VERIFICATION] contacts the appropriate API's to retrieve the data for business verification. VENDOR VERIFICATION sends data to either the ERROR VERIFICATION AND HANDLING MODULE or the DATABASE HANDLER.

What is claimed is:

1. A method for integrating and managing multiple software components in a unified platform, comprising:
connecting a plurality of software components to an integrated communication framework;
establishing data synchronization channels between the connected software components;
continuously monitoring data exchanges across the connected software components;
verifying data consistency and accuracy across all connected software components;
performing automated error checks and corrections on transferred data; and
executing automated tasks across multiple software components.

2. The method of claim 1, wherein establishing data synchronization channels between the connected software components comprises:
facilitating transient data communication within the integrated communication framework;
managing the flow of temporary data between software components;
initiating automated error-checking routines for transient data during synchronization;
performing validation of transient data consistency between components; and
updating each software component with transient data changes instantaneously upon receipt.

3. The method of claim 1, wherein continuously monitoring data exchanges across the connected software components comprises:
tracking the flow of transient data to identify inconsistencies or errors;
logging data transactions between components for audit and verification purposes;
detecting changes in data states and triggering automated responses;
alerting users or system administrators to potential synchronization issues; and
verifying the successful transmission of data packets between components.

4. The method of claim 1, wherein verifying data consistency and accuracy across all connected software components comprises:
performing automated validation checks on data formats and structures; and
generating error reports for any inconsistencies detected during verification.

5. The method of claim 1, further comprising performing multi-tenant automatic backup billing by:
automatic verification of matching data entered into a form against an external database;
retrieving a billing exclusion list from the internal database for one or more electronic devices to skip billing;
retrieving encoded daily backup usage from the external backup provider database for a plurality of user accounts kept in an internal database for a multi-tenant software environment;
decoding and converting the retrieved backup usage data into a billing-compatible format; and
automatically determining usage fees for each user account not in the billing exclusion list.

6. The method of claim 1, further comprising performing shared customer behavior management in a multi-tenant software as a service service system comprises:
receiving data entered into the form for a prospect as part of an order or scheduling an appointment;
determining if the data entered exists in a database based on a multi-factor inexact search for the prospect; and
if the prospect is in the database, automatically displaying a message to a user entering the data.

7. The method of claim 1, further comprising managing marketing lead sources for a user in a service business software system by:
collecting marketing performance data from a plurality of users;
segmenting the plurality users into one or more predetermined user groups;
matching the user into one of the predetermined groups or subgroups;
retrieving and rendering marketing data from the matched predetermined group;
an opt-in or opt-out of data sharing for marketing details;
allowing end users to select and deselect the alerts they receive;
provides an interface for users to search or enter data or select a marketing campaign type;
allows users to expand search criteria to include non-industry-specific results;
ability to filter one or more of: industry, location, other predetermined criteria; and
ability to sort and organize search results by a plurality of metrics.

8. The method of claim 1, further comprising scheduling an appointment by:
receiving data entered into the form for a prospect as part of an order or scheduling an appointment;
determine if the data entered into the form matches a multi-factor inexact search of data within a database for a globally shared customer behavior list and/or a globally shared cancellation list; and
if a match is found with multiple points of data in either list, automatically display a message to the end user entering the data.
receiving data entry for a street address;
retrieving a GPS coordinate for the street address; and
dynamically determining distance and travel time from a predetermined office location to street address.

9. The method of claim 1, further comprising scheduling multiple payments for an invoice with an amount by:
providing one of two payment options: 1) full payment, and 2) a selected payment term;
if the invoice recipient does not pay in full or select a payment term within a predetermined time, automatically configure and schedule one or more recurring payments over a period of time;
automatically selecting a predetermined periodic payment for which the customer qualifies based on periodic payment parameters configured by the end user;
periodically processing a payment in satisfaction of the invoice;
end user interface for configuring invoice settings, email notifications, managing payment terms, managing invoices, minimum down payments, interest rates and/or late fees;
allowing entry for the minimal recurring payment amount an end user is willing to accept;
ability for end users to upload their own custom templates or use provided templates;
allowing end users to disable multi-payment invoicing and/or the automatic payment scheduling feature for all invoices;
interface for viewing and editing customer information, receiving or editing invoice data;
storing finalized invoice data in the system's database;
sending initial emails with one of more of: invoice and payment details, payment hyperlink, automatic payment scheduling details;
automatic alerts for users if a customer lacks credit card information on file with a credit card processor, has a history of unpaid invoices, and/or if there are any discrepancies or missing information in invoices;
online guest and private end user system;
guest checkout can process payments using credit card and/or cryptocurrency;
end user checkout system can process payments using check, cash, credit card and/or cryptocurrency;
process one time payment in full through an online payment processor;
ability to add or remove credit cards and set a default card for multiple payments;
add a down payment when scheduling multi-payment processing;
automatically determine a minimum and maximum down payment amount allowed when scheduling multi-payment processing;
automatically adjust the payment term length and amount based on down payment entered;
select processing recurring payments on specified dates (ie. 1st or 15th of the month); and
select payment term length from qualified payment terms to schedule payments.

10. The method of claim 9 wherein automatically selecting a predetermined periodic payment for which the customer qualifies based on periodic payment parameters configured by the end user comprises:
determining if an invoice recipient qualifies for multi-payment terms based on configured minimum recurring payment parameters and credit card expiration date;
calculating amounts due for each payment in the payment schedule;
automatically create a payment plan if the invoice recipient does not create a multi-payment schedule by the predetermined date;
automatically schedules recurring payments of the lowest payment with the highest interest rate for the longest term length for which the invoice recipient qualifies;
generating a multi-payment schedule including the interest charges;
sending a notification to an invoice recipient if the automatic payment scheduler is invoked;
allowing end users to adjust their interest rate settings for payment term schedules;
receiving invoice data including a total amount and a payment term;
applying different interest rates based on the length of the payment term;
automatically calculates interest for each installment, from predetermined values, based on the total amount and the payment term;
automatically adjusting interest rates for early payments or late payments; and
recalculating the payment schedule when a customer makes an early or partial payment.

11. The method of claim 1, further comprising generating content for a plurality of channels on a shared video platform by:
for each channel, receiving content from each content provider independently creating content as part of a community for the channel;
promoting the community output to get more views than possible with content from each content provider stand-alone on the shared platform;
collectively obtaining channel subscribers for each content provider and collectively increasing views for the content;
rewarding a content provider for their combined contributions based on a plurality of engagement metrics for each revenue eligible content within the channels;
providing a registration interface allowing a user to fill out a content provider application and upload or link to a video to apply to become a content provider;
providing a voting interface that allows other content providers to vote on the content provider application; and
providing a content provider approval interface for final approval or dismissal of the application, wherein the final content provider application approval or dismissal is decided by a moderator.

12. The method of claim 1, further comprising preparing and editing a new file responsive to a document requirement by:
receiving a templated file with one or more keyword phrases and templated content;
receiving data expressed in one or more file types and extracting text data from the received file types; and
dynamically generating custom text by replacing keyword phrases with the extracted text data and placing the custom text within the templated content;
recommending changes based on the document requirements;
dynamically generating the new file by replacing keyword phrases in a data file with data derived from a form submission on the Internet, data within a database or other data sources; and
integrating into the global customer behavior list determining if the data entered exists in a database based on a multi-factor inexact search for the prospect includes one or more of:
company name, personal name, address, city, state, zip code, email, and telephone number(s).

13. The method of claim 1, further comprising billing generation by:
defining a matrix specifying price data per contract term, contract length and category;
applying one or more payment parameters to index into the matrix to determine a price;
displaying a banner for unpaid scheduled appointments, after a customizable time thresholds, with a clickable hyperlink to access a checkout process for an unpaid appointment; and
disabling a checkout reminder notification when creating an appointment or in an alert system for unpaid scheduled appointments.

14. The method of claim 1, further comprising annotating customer data by:
capturing repetitive data from a repetitive task generated when a computer data form is entered;
capturing a custom note for an event;
adding the custom note to the repetitive data;
summing up all repetitive data and custom notes in sequential order; and
providing a report on customer interactions.

15. The method of claim 1, further comprising providing a purchase reward system by:
assessing purchase reward eligibility for a product purchase;
determining an individual reward amount based on the user's total gross sales transactions from their customers processed through a sales system;
automatically adjusting the purchase reward over a predetermined period based on accumulated gross sales transactions;
providing feedback on a reward status change;
assessing product reward eligibility;
setting a purchase reward percentage;
tracking the total amount spent by each user on qualifying purchases;
calculating the purchase reward amount based on the tracked spending and set percentage;
associating the calculated purchase reward amount in a customer account; and
providing a user interface for customers to view their accumulated purchase reward.

16. The method of claim 1, further comprising managing online customer reviews by:
associating keyword phrases with the product or service, wherein the keyword phrases are stored in an indexed table;
generating reviews based on the keyword phrases;
requesting a customer review upon or after the purchase of a product or a service;
predetermining a customer review rating;
if the rating is less than a specified threshold, send customer to a feedback webpage;
if the rating meets or is greater than a specified threshold, send customer to a website review instructional guide;
if the customer feedback is below a predetermined rating threshold, automatically placing customer information in banned review list; and
managing a list of banned review customers.

17. The method of claim 1, further comprising managing sales transactions by:
creating line items for services or products;
establishing a connection with an online accounting software, a sales tax calculation software, and an online credit card processor;
extracting one or more keyword phrases in a document file and generating a sales receipt by replacing data in lieu of the keyword phrases in the document file;
enabling and disabling the recording of transactions into the accounting software for individual payment methods;
handling failed transactions;
synchronizing sales and accounting data to a plurality of online software systems;
selecting specific line items for inclusion in the transaction;
collecting initial data from a database to pre-fill necessary information for a sales checkout process; and
associating a fixed or dynamic fee based on one or more of: individual transaction amount, purchases, totality of processed transactions, and predefined parameters.

18. The method of claim 17, wherein associating a fixed or dynamic fee based on one or more of:
individual transaction amount, purchases, totality of processed transactions, and predefined parameters, further comprises:
when the dynamic fee is not configured as a fixed fee, the dynamic fee automatically adjusts in response to changes in the specified factors;
applying a minimum and maximum threshold to control the dynamic fee range;
periodically reviewing accumulated transaction data to update the dynamic fee for future transactions.

19. The method of claim 1, further comprising a method for dynamically managing transaction fees in a financial processing system by:
initializing a default base fee percentage for transactions;
processing a plurality of transactions for an end user, wherein each transaction includes applying the current fee percentage to the transaction amount;
accumulating fee revenue from the processed transactions over a predetermined time period;
calculating total business service costs for the end user over the predetermined time period;
comparing the accumulated fee revenue to the total business service costs;
adjusting the fee percentage for a subsequent time period based on the comparison, wherein the adjustment is constrained by a predefined ceiling and floor percentage;
locking the adjusted fee percentage for the subsequent time period; and
applying the locked fee percentage to transactions in the subsequent time period.

20. The method of claim 1, further comprising accounting for a payment associated with a transaction by:
processing the payment via a first vendor, wherein the first vendor takes a deduction from an amount sent to a second vendor;
identifying the amount sent to the second vendor and aggregating the deposit and the deduction to create a net payment;
indicating the net payment as a deposit receipt in an online accounting software; and
automatic description note entries relating to the deposit.
